(19) United States
(12) Patent Application Publication
(10) Pub. No.: US 2025/0246095 A1
(43) Pub. Date: Jul. 31, 2025

(54) Methods and Systems to Help Language Learners Using Data Analytics and Artificial Intelligence

(71) Applicant: Christopher Persaud, Winnetka, CA (US)

(72) Inventor: Christopher Persaud, Winnetka, CA (US)

(21) Appl. No.: 18/964,398

(22) Filed: Nov. 30, 2024

Related U.S. Application Data
(63) Continuation-in-part of application No. 17/355,155, filed on Jun. 22, 2021, now abandoned.
(60) Provisional application No. 63/042,097, filed on Jun. 22, 2020.

(51) Int. Cl. G09B 19/06; G06N 3/02; G09B 5/02; H04L 9/00

(52) U.S. Cl. CPC G09B 19/06; G06N 3/02; G09B 5/02; H04L 9/50

(57) ABSTRACT

The invention gathers data about individual users and analyzes how each individual user best learns each language that the user seeks to learn, and informs the user so that the user can find that user's best way to learn each language. The invention also detects differences, if any, between the ways that different user groups learn the same foreign language, helping educational personnel to know when to modify their methods for different user groups. The invention uses preattentive attributes, visual techniques, and visual effects that a user can associate with specific grammatical forms, words, or word patterns to help users learn and remember parts of the languages they are learning. The invention tracks the number of words which the user has been taught, in a language, and factors governing how often the user learns new words, so that the user can learn new words more quickly.

### DESCRIPTION OF THE RELATED ART

This patent application claims priority to U.S. patent application Ser. No. 17/355,155, filed Jun. 21, 2021, invented by Christopher Persaud, which claims priority to U.S. Provisional Patent Application 63/042,097 filed Jun. 22, 2020, invented by Christopher Persaud.

These terms apply for this patent application: “Foreign language”: A language that is not a student's native language. For example, English is a “foreign” language to a person whose native language is Spanish. Spanish is a “foreign” language to a person whose native language is English. “Student”: A person learning a language. “Instructor”: A person teaching a language.

“Facilitator”: A person leading an informal group studying a language (For example, New York University (NYU) and Harvard University seem to sponsor informal student groups who spend an hour conversing in a language to improve their practice in that language). “Curator”: A person who examines individuals' submissions regarding a specific language, and “curates” the submissions to make sure that they are correct before they are offered to the general public. Curators are especially, but not only, important regarding languages spoken by very few people, or to help monitor change in a language, such as new words being added to the language. The same person can be an “instructor” and a “student”, or a “curator” or a “facilitator”, or fulfill three or four of these roles, regarding different languages, or at different times. For example, the person might be a student in a language for several years, earn an M.A. or Ph.D. in that language, and then become an instructor in that language. A person could theoretically be an instructor and student in the same language, by teaching the language and also doing problems to practice the language.

“Cohort”: A group of specific individual users. Generally, users in a cohort will have at least one common characteristic, in addition to the common characteristic of being in the cohort, but they do not need to have any common characteristics besides all being in the cohort. Some potential cohorts are a group of students in one class, a group of students in one institution, a group of students in a certain geographic area, the students who enrolled in a class in a certain time period, or a group of students that have another characteristic in common, or who have a specific combination of defined common characteristics. In some embodiments, users can also be added to a cohort after the cohort's creation. A cohort can also be created at any time from some of the users in a larger cohort (These users will then be part of both cohorts), or from a group of users who previously were not part of any common cohort. A users can be added to a cohort by any method known in the prior art, including, but not limited to, the users scanning a QR code or using the Iforms invention of U.S. Pat. No. 10,019,430 by Rossi et. al.'s methodology to add themselves to a cohort. A person authorized to do so can add a user to a cohort of which the user was not originally part, or take a user out of a cohort of which they were part, and a user can belong to multiple cohorts at the same time. Cohorts as a concept are useful for statistical analysis, so instructors, and others can understand how well the users in the cohort are learning a study language, and other information about how the cohort members learn, and try to find whether outside events affect the users' efforts.

“Institution”: School, college, or another entity where classes are offered. High schools and universities are examples of types of institutions. “Class”: A course of study over a defined time period, which a student can undertake, with A. A desired outcome concerning what the student should learn from the course of study, and B. The student's success in the course of study's desired outcome being measured in some way, either directly or by proxy measurement.

Something “presented” to a user, is presented to the user using a display device (2).

A language module's (16) projected words, used in some embodiments, are words in the study language that is the language module's subject, and that the user is expected to have learned by the time the user completes the language module, and are divided into “current projected words” and “prior projected words”. “Current projected words” are projected words that a user is not expected to have known before the user started the language module, but which the user is expected to have learned by the time the user completes the language module. “Prior projected words” are projected words that a user is expected to have known before the user started the language module, and one language module's “prior projected words”, in some embodiments, may be another language module's “current projected words”.

“In-person” class: A class where, to attend the class, a student must physically visit a location where the class's instructor(s) is teaching. “Remote” class: Class where the lessons are broadcast to the student, by radio, telephone, the internet, or another method, and so the student can attend the class without being in the same location as the instructor(s).

“Active time”: Time spent actively using a language module to increase the user's language skills. In some embodiments, “active time” is limited to time spent actively using the user's individual interface (1). “Completion time” for a language module: Active time amount the user spent on the user's individual interface (1), using the language module, between the point in time when the user started and the point in time when the user completed the language module. “CTOT”: Total time length, including both active time, and time spent doing other things, between the point when the user started the language module and the point when the user completed the language module. A user's active time amount spent on a language module can be greater than the user's completion time or CTOT for the language module, because the user may choose to spend additional practice time, which is part of active time, on practicing the language module's material more, to learn the material better. The inventor recommends that instructors offer no disincentive for increasing active time. A user's active time for a language module (16) can also be less than the user's completion time for the language module (16) if the user has not completed the language module (16). Likewise, “active time” can be less than CTOT because a user might do other things, like working, eating, sleeping, and spending time with family, between the points when a user starts and completes a language module.

“Practice time”: (active time−completion time) for a language module a user completed. A user can have “active time” but not “completion time”, “practice time”, or CTOT for a language module the user has not yet completed.

“Word”: What are normally considered words, and also “pictoral” symbols and “kanji” in languages like Chinese and Japanese that use such symbols. A “word-type” is a kind of word, such as a noun, verb, etc. in English. Other languages may have other word-types.

“Study language”: A language a student is trying to learn. “Base language”: The language in which the student wants to receive information from language modules (16) about the study language and its structure. For example, if a student selects Portuguese as her study language and English as her base language, then when language modules show the student the first explanations of grammatical rules, they will show the student the explanations, in English.

The base language will be the language in which the student will be shown some explanatory material, and in which the student will be shown descriptive statistics about the student, such as the student's monitored measurements (unless the student specifically requests otherwise, in some embodiments). Most students will likely select their native language as their base language. For example, if the student's native language is English, and the student is trying to learn Swedish, the student may select English as the base language for the student's Swedish language modules, and the invention will then show the student explanatory material and descriptive statistics for those language modules in English.

A user “acquires” a word in a study language when the user, for the first time, sees the word in explanatory material (described later) or a problem, or a language module (16) has shown or otherwise communicated the word to the user, or the user uses the word for the first time in response to a problem, whichever happens first. In some embodiments when the user can manually add words to the user's word record, the word is also considered “acquired” when the user adds the word to the user's word record for the study language. In most embodiments, when calculating when a user acquires a word, whether the user knew any words in the study language before the user started the user's first language module (16) in that study language is not considered. If the user used the word in response to a problem or adds it to the word record, the user can be presumed to have learned the word from elsewhere, which is why the word is considered “acquired” then—The word was introduced to the student from some other source. A user acquires a word when the user is known to have been aware of that word.

“Problem”: A question, related to a study language, that a user is asked to solve.

“Priority equations”: Equations within the problem generator (14) that govern the probability of certain events happening. In some embodiments, the user can modify some of the probabilities within the priority equations, to change the chances of certain events happening, such as the chances of certain words types being used in problems presented to the user.

2 priority equations that can be used in embodiments are 1. The equation governing the percentage of a study language's words, not previously acquired by the user, in problems presented to the user. 2. The equation governing the category(s) to which certain words in a study language, not previously acquired by the user, and used in problems presented to the user, belong. Ordinarily, a word's word category will not affect the probability that the word is in a problem, but in some embodiments the user will be able to make this category a factor, and choose the percentages of the words belonging to different word category(s) that appear in certain word-places in problems.

“Background material”: Everything that is not explanatory material or problems, that the individual interface (1) presents using a display device and/or one of the language modules (16) sends to the individual interface (1).

“Review test”: A test of the percentages of words, previously acquired by the user at different times, the user recalls how to use. Review tests are not part of any language module (16), and the user causes the problem generator to create review tests.

“Word attribute”: A kind of descriptive data point distinguishing a word from the word's “base” form when the word appears in a specific place. For example, “dogs” is “dog” with the word attribute “plural”. “Plural” is a word attribute. Words can have zero or more word attributes. The same word, in two different sentences, could theoretically have different word attribute combinations.

“Example passage”: A group of multiple words in a study language that a language module transmits to the individual interface, for the individual interface to show to a user as an example concerning the study language. “Example word”: A word in any language a language module shows to a user as an example concerning a study language. The invention can create example words and passages, or take them from a source document. Example passages and words are part of explanatory material.

“Mistakes” or “errors” are wrong answers to problems. A “type of error”, “e-type”, “type of mistake”, or “mistake type” is a category of answers that were wrong in at least one way that is common to the answers. E-type Examples include A. Answers where at least one word is misspelled. B. Answers where no words are misspelled but at least one word is grammatically wrong. C. (In some languages) Answers including words where the wrong tense for at least one word is used. D. Answers where the wrong word is used to identify an object. Other e-types are possible. The e-types possible for each study language would depend on the study language's features and could be different for some study languages versus others.

The invention reduces issues resulting from disparate language teaching philosophies which might not produce good outcomes for all students, or which might work in some environments but not others. The invention monitors each student's actions to find the language learning method(s) that work best for each student learning each study language, and informs the student about which method(s) work best for the student, so that the student can use them more. Essentially, if a student has an instructor, the instructor can use the language teaching method they think is best, and each individual student can complement this by finding the language learning method(s) that best helps the student. The instructor can also learn which language teaching method best helps each student in the class, and tailor the class appropriately.

Individuals have needed to learn foreign languages for travel, commerce, and other reasons for thousands of years. The need to learn foreign languages increased as international business became more common. Language learning is also important to the U.S. because many of its citizens need to be aware of, and understand, other cultures and countries. Today, U.S. citizens need to learn new languages to engage in commerce with many other nations, and may need to learn these languages quickly, and learn them without the ability to attend an institution to learn them. U.S. citizens may also need to learn dialects, or regional languages, which may not be available through regular institutions.

Other countries' citizens also need to learn foreign languages, for the same reasons as U.S. citizens. Many other countries' education systems emphasize learning languages much more than the U.S. education system. Many citizens of India can speak multiple languages, and many European countries' education systems make stronger attempts to teach their citizens English than the U.S. system. When the inventor herein was walking down a well-kept street in Shanghai, China, a beggar asked him for money in perfect English, suggesting that the Chinese educational system teaches English very effectively. The inventor also personally knows of a large Chinese company that hires U.S. teachers to teach English, one-on-one, to millions of Chinese children using videoconferencing.

Greater language-teaching skill may help a country to capture foreign markets more easily. For example, if the Chinese education system is proficient in teaching English, this may translate into proficiency in teaching Portuguese, which might help Chinese companies to capture Brazilian markets that U.S. companies presently serve.

Learning a language through enrolling in, and completing, in-person classes has historically been a common way of learning a language, and is an effective way of learning a language under ideal conditions, but conditions are not always ideal, and this approach, when implemented in practice, suffers from deficiencies, including:

### Economic Problems

An in-person class usually involves a fixed schedule and fixed set of assignments and exams, and some students cannot undertake this schedule because of other factors in their lives. For example, a student may not be able to attend the class, may lack reliable transportation to the class, or the student may need to work, and only have the time to complete some, but not all, the class's assignments, in the time allotted.

A student may also desire to expand his or her understanding of a language, but not to progress at the in-person class's specific schedule. The present invention is more flexible than use of in-person classes because the present invention allows a student to complete language modules and engage in “active time” at the pace at which the student is able, and, so that the student can monitor their progress, the invention also tracks how many study language words the student acquired, while using the invention, tracks when the student acquired those words, and tracks how well the student remembers these words as a function of time, and makes this information available to the student. The student can figure out how much progress they have made, learning a study language, and the student can find out whether they have “regressed” in their knowledge of a language if they stopped having “active time” for a long period.

Colleges and universities have a problem with students dropping out of classes to varying degrees. At all colleges and universities where a city, state, or federal government subsidizes classes in some way, including indirect subsidies through student loans, if a student drops out of a language class, this usually represents wasted energy for the student (who does not receive academic credit) and wasted money for a state or federal government (that subsidized the class). Governments subsidize almost all U.S. colleges and universities to some degree. The invention helps the problem of students dropping out by showing students multiple methods of learning the study language and finding which of these methods help the student to learn the study language most and least efficiently. Therefore, a student who uses the invention and takes a language class at the same time is more able to detect which areas regarding the study language, the student is “weak” and “strong” in, and to find the ways of learning the study language that are most efficient for that particular student, so the student can use those ways of learning the study language more often. The student is then less likely to drop out of any class in the study language where the student is enrolled. Lowering dropout rates will save millions or billions of dollars over the long term, because of the number of students enrolled in language classes. Increasing student retention in language classes will also lead to greater return on investment (ROI) for government bodies that subsidize those language classes.

If a student lives in poverty, this affects the student's ability to learn a new language, because the student will be distracted and less able to focus on learning the language. A small but significant percentage of Los Angeles County Community College students (Totaling thousands of students, because LACC enrollment is large) for example, are homeless, or experience food insecurity.

Jill Biden, U.S. First Lady, wrote her Ed.D. thesis on “Student Retention at the Community College”, showing the vital concern many professors, administrators, and state officials have for student retention in community colleges, and showing the need to help community college students to complete their language learning by making language learning opportunities flexible, so that a student can use the opportunities that work best for them, and that they most need. The present invention achieves this goal in multiple ways, and one way is through organizing language learning in limited-sized language modules. First Lady Biden also noted that community college students may face many social, economic, and other obstacles, in completing classes (including language classes) due to other factors in the students' lives. This shows a need for a flexible alternative to in-person language classes, that allows students to learn at their own pace, or to augment in-person language classes. The present invention can also be used to augment language classes through the student doing active time for language modules that correlate to the material the student's class covers. The student's scores on problems of different problem types, or “pr-types”, will tell the student what they need to work on more, regarding a language class, and help the student understand how they learn the study language, so they can use this knowledge. The student's review tests will help the student to tell what words in the study language they remember and how often they need to review, regarding a study language. This helps to augment the student's in-person language classes and/or to help the student improve their performance regarding a study language at their own pace.

Linda McMahon, nominated to be U.S. Secretary of Education, says that the U.S. should move away from “one size fits all” models in other educational contexts. The present invention helps to move away from “one size fits all” models in language learning, and helps each student to find how they learn a language best, and learn the language that way.

Recently, concerns have increased in the U.S. that past and/or present social problems may cause certain ethnic groups' members to be disadvantaged in the educational system. There is also concern about gender equality in education, in the U.S. and other countries. Any influence a person's gender has on their learning style would be incorporated into the person's individual learning style. The present invention helps reduce race-based or gender-based disadvantages by providing more information about individual students of all races and genders' learning styles so that a language class can be somewhat tailored to the class's individual students' learning styles. One way the class can be tailored to the individual members' learning styles is through the class's instructor examining the class members' monitored measurements, and cohort computations (defined later) of a cohort comprising the class's students, and finding which methods of learning the study language work best for the class's particular members.

The invention will also help high school students who wish to take Advanced Placement (AP) exams to practice and study for them. This is especially important for students who may not have access to teachers and AP classes, but who still want to take AP exams. Schools in poorer areas and smaller high schools tend to have access to fewer AP classes than schools in wealthy areas and larger high schools, respectively.

The invention will also help high school students to study (and hopefully master) languages not available for study in their high schools. This is also true of students in high schools in poorer areas, and smaller high schools. Hebrew and Latin are among the languages available for study at Stuyvesant, one of New York City's most prestigious high schools, but are available for study at very few high schools. The invention will help these two languages, and others, to be available for study to students at more institutions, and can make the relevant components available for a user and give the user feedback, so that the user can learn a study language even if no class is available wherever the user is located. Students at smaller high schools and high schools in poorer areas can access the invention's relevant parts and study languages, like students at larger high schools and high schools in richer areas.

### Problems Connected to Language Teaching Styles

One problem with present language teaching is that students have different language learning styles, and instructors have different teaching styles and philosophies. The language teaching style an instructor uses in an in-person class may not be the most effective style for helping all students in that class to learn the language. An instructor's accent may also impede some students' comprehension, or students may not understand the instructor for other reasons.

Numerous theories exist, among language teachers, concerning the “right”, or “most effective”, way to teach students a new language. Some of these theories have empirical support, but are most effective within specific contexts. For example, they might be most effective with students who study 10 hours per week, but be disproportionately less effective with students who study less. This means that some language teaching methods may be more effective at certain educational institutions, rather than others. A language teaching method which is most effective with students who study a language for 10 hour per week will tend to be more effective when executed at an institution where most of the students have at least 10 hours per week available to devote to language study. An instructor must consider such idiosyncrasies, when determining the right language teaching method(s) to use. If an instructor relies on empirical studies to determine whether a language teaching method is effective, the instructor must examine the context where the studies took place, to determine whether the studies' conclusions apply to an institution where the instructor teaches. Some of these theories are also more effective with some languages than others, because of different languages' different characteristics (For example, some theories might be more effective for English speakers learning French vs. English speakers learning Arabic, because French uses the same alphabet as English, while Arabic does not). Other theories concerning language teaching lack empirical support.

The reality is that not all students learn languages the same way. One of the invention's goals is to help a student find and focus on their most effective language-learning style(s) for each study language the student wants to learn.

The present invention is designed to accommodate different language teaching styles and philosophies among language teachers, and also designed to be adaptable to any new language teaching styles and philosophies likely to emerge. The invention records what helps a user to learn more words, in a study language, and when the user makes the most errors, and other factors relating to each individual user, and how these factors change as the active time amount the user spent using the invention to learn a study language changes. Whatever language teaching philosophy is being used, the records the invention creates can be used to determine how each individual user is responding to that philosophy and whether, and how much, each individual user is learning about a study language. This eliminates or reduces debates about which language teaching philosophy is “better” overall, because the invention can be used to find which language learning methods are most efficient (a reasonable proxy for “better”) for each individual student, for each study language.

### Institutions' Logistical Problems

U.S. institutions often face problems such as budget cuts, which might force them to stop offering language classes, and related services, that they previously offered. An educational institution may not have (or may never have had) enough of a budget to offer all the language classes, or all the support systems related to languages learning, that it wants to offer. The present invention helps institutions to overcome these problems for the reasons discussed above, and also by having an instructor(s) and/or facilitator(s) available to help students using the invention, which will allow the same number of instructors or facilitators to help more students, and help them in more languages, than might have been the case otherwise.

Institutions may also be subjected to government directives, that have good intentions but are counterproductive or perverse in practice, or administrators at the institutions may try to implement these directives in counterproductive ways. The present invention can help an institution to monitor students' actions, in learning a study language, outside of class, and monitor how distributions of monitored measurements of large groups of students change, through cohort computations for cohorts comprising these groups. If the institution has this information, it can quickly find whether a policy change correlates to a negative or positive change in one or more students' monitored measurements, and which students' monitored measurements seem to be negatively or positively affected. Then the institution can create remedial measures or reverse policies with negative effects on students' learning study languages, or further expand policies with positive effects on students' learning study languages.

Furthermore, educational institutions, must often need to focus their in-person class offerings on the most “in-demand” languages, which tend to be languages with the most speakers. If an institution wishes to offer a class in a less in-demand language, students' demand for that class, might be insufficient for the institution to justify offering that class. Few U.S. educational institutions will offer in-person classes in more than thirty languages, and very few institutions can offer classes in some languages that are relatively uncommon in the U.S., but have millions of speakers, like Dutch and Swahili. The present invention will help students at all institutions to learn such languages, if they wish, by providing all users with potential access to the invention's components oriented towards those languages. The invention will also help users who want to learn the same such language to find each other and create a “critical mass” of people who want to learn the same such language, and practice the language together, even if the users are student(s) at institution(s) that do not offer classes in that language.

The COVID-19 crisis, which began in 2020, created new waves of problems related to language learning, and education generally. Many universities, school districts, and other institutions were forced to shift all their classes to an “online” format, which caused numerous problems with student achievement and retention, some of which still have effects today.

The COVID-19 crisis seems to be diminishing in the U.S. Other countries continue to experience COVID-19-related crises, and it is also possible that new COVID-19 strains, or a new disease will cause future national or regional crises. Institutions should be more resilient, to protect student achievement and retention when such crises happen. Institutions in specific geographic areas, in the U.S. and elsewhere, may be periodically forced to switch classes to completely remote formats temporarily because of regional disease outbreaks, and then return to in-person schedules after these outbreaks end.

In fact, schools in many U.S. areas were forced to cancel classes temporarily for weeks at a time during polio outbreaks, before polio vaccines were introduced in the 1950's. For example, schools in City A may have been forced to close for a few weeks during a polio outbreak, while schools in City B continued operating because there was no outbreak in City B. Then schools in City A would resume because the outbreak in City A had ended, while at the same time schools in City B would be forced to close for weeks during an outbreak in City B. Similar crises, but related to COVID strains or a new disease, might happen in the future. If an institution is located in an area affected by a disease-related crisis, or damaged by a disaster, like an earthquake or hurricane, the institution should be able to temporarily switch to remote classes, and to quantifiably assess how much students learned during the remote classes, and how much their learning suffered during the disaster, after the disaster ends. Institutions will then have much better knowledge of the amount and type of learning their students “lost” during the crisis, and be able to create remedial measures designed for the actual problem—Not for what they imprecisely perceive the problem to be. The present invention will help educational institutions to become more resilient, in the field of language teaching, and to deal with crises that temporarily force institutions to close, while protecting student outcomes.

Some schools and colleges also offer online classes, but these suffer from some of the same deficiencies noted above as in-person classes, though often to a reduced degree. Some online classes also suffer from other issues—Some colleges and universities have created online classes with very large student numbers per class (1000 or more) which results in less individual attention per student, and higher dropout rates.

“Massive Online Open Courses” (MOOCs) are online courses open to large numbers of students, who can listen to lectures, and access other course materials. Some MOOCs allow students to participate in blog posts, or email the instructor and/or students. Students often get insufficient language practice, in languages MOOCs. MOOCs generally have low completion rates. According to some studies, MOOCs' completion rates are at most 15%. The present invention can complement or replace language MOOCs. If used to complement a language MOOC, the invention can increase the percentage of students finishing the MOOC.

These factors show the need for a method of helping users to learn languages that can function well while students are forced to experience rapid shifts in priorities, such as a shift in priorities caused by a natural disaster or personal crisis, or students who are enrolled in a class which is forced to switch from an in-person format to a remote format. The method should also be able to offer the students individualized feedback.

### Prior Art Inventions and their Differences from the Present Invention

The following prior art was found, which was believed to be relevant, and which should be mentioned in an information disclosure statement:

Spaventa's U.S. Pat. No. 7,104,798 is a method of teaching students a language utilizing a coded medium through verbal and nonverbal communication.

U.S. Pat. No. 7,052,278 by Johnson, et. al. provides a system and method for language teaching that involves training to an automatic level a set of core vocabulary items, and then presenting learned items in combination as a means of implicitly teaching grammar.

U.S. Pat. No. 6,866,510 by Polanyi et. al. describes a technique for teaching second language writing skills, which provides for analyzing a user text.

U.S. Pat. No. 6,438,515 by Crawford, et. al. describes a method and apparatus for displaying dual texts in a manner to facilitate language learning, by presenting a highly visible “study text,” divided into individual units of thought, or “chunks of meaning”. The method and apparatus clearly relate the study text and the teach text, allow computer programs to access these relations and automatically produce bitextual, preferably bifocal, presentations.

Kristen Sosulski's book “Data Visualization Made Simple” describes various data visualization methods, and ways that some of these methods can be used to enhance a viewer's comprehension of course material. Sosulski does not attempt to apply these methods specifically to language learning/teaching.

“Canvas” is a system for offering courses on the internet through an institution. Canvas allows instructors to create “modules”, each of which can contain tests and explanations of material. Each instructor must create the modules themselves, though. No two instructors will necessarily create identical modules, which makes effectively comparing student performance between classes more difficult. No standards exist regarding Canvas modules' required content.

Canvas includes a display of “course analytics”, which are based on the assignments and exams a specific instructor creates, for a specific course. Canvas has no attempt to compare performance and other information across sections, or across courses, or institutions, and indeed such a comparison would probably be impractical, because the comparison would involve comparing different groups of students' performance on different assessments that may have assessed different material, or comparing groups of students who are not part of the same cohort.

Duolingo is a program that seeks to teach people languages. The present invention includes multiple features that Duolingo does not have. For example, the present invention uses preattentive attributes to help users learn, and includes the ability for a user to statistically analyze various aspects of their own use of the invention, and to become a part of a cohort and statistically analyze aspects of the cohort members' use of the invention. These capabilities help users to use the invention more effectively, and learn study languages more effectively.

Most tests of a person's language skills are achievement tests or more general aptitude tests. Nothing is wrong with achievement tests or general aptitude tests, but there is no method presently of finding out how each individual learns a language, with little cost to that individual, so that the individual can make use of their own thinking patterns to learn the language more efficiently and effectively. If Person A finished a language-related achievement and Person B didn't finish the same achievement, an observer might ask why Person A finished the achievement and Person B did not. If Person B learned more about how their mental processes worked when learning the language, Person B would better understand what they needed to do, to complete the achievement, and have a better chance of completing it. Accuracy in language-learning is a goal for the present invention. Another goal is for students to understand how they learn a foreign language and then use that understanding to learn that language more effectively.

### SUMMARY OF THE INVENTION

This application was partly inspired by conversations over many years with Loknath Persaud and Arabella Persaud, and is dedicated to Loknath Persaud and Arabella Persaud. Loknath Persaud taught at Pasadena City College, in Pasadena, CA, but recently retired, and Arabella Persaud taught for many years at Los Angeles Southwest College, and recently retired. She also wrote a book entitled “Domine el Espanol”, which included many kinds of exercises in Spanish. Christopher Persaud, the inventor herein, was also influenced by his experiences as a student at California State University Los Angeles, University of Miami, Ave Maria Law School, and New York University's Stern School of Business.

The inventor would also like to thank Nicole Lerman, who first showed him how the “Duolingo” program helped users.

The present invention is also useful for addressing and accommodating changes within an institution's class schedule. For example, if an institution is forced to move a class to a time which is inconvenient for some students, or cut the number of times it offers a specific class in a term, the invention will help the institution detect and alleviate resulting negative effects.

The present invention is also not intended to, and probably cannot, replace language instruction at institutions, or language teachers, in their current roles. In addition to their current roles, language teachers can act as curators, or submit words for inclusion in words databases for different languages, and can otherwise help expand the invention's potential. Furthermore, language teachers can help students to correct mistakes that they might make, using the invention, and to guide the students, while the students learn the study language. Instructors can also be helpful to students because an instructor will likely have experience helping students with multiple learning styles, and the instructor can use this experience to help a student, who uses the invention, once the instructor has more information about an individual student's learning style (from examining the student's monitored measurements). Use of the invention together with language instruction will probably be more effective at helping students to learn a study language than use of the invention without language instruction.

Users' data, including, but not limited to, information in user's ICRs, can be protected using every method known in the prior art, and, when such data is shared with a second user, the first user can control the sharing using every method known in the prior art. Use of all such methods to protect data and control sharing is explicitly part of the present invention.

### Long-Felt but Unsolved Need

A user can use the present invention to learn a language when the user is not enrolled in any class, but for best results, the user should enroll in a class in a study language, while the user is using the invention to learn that study language.

There is a long-felt but unsolved need for a computerized system that helps people to learn languages but which accommodates differences in learning style(s), and social changes. The present invention fills this need by finding a learning style for each student that is more effective, informing the student of that learning style, and adapting to that learning style.

The present invention tries to engage the user in different kinds of thinking, on the theory that this will help the user to retain information about a study language better.

Recently, COVID-19 forced many instructors to build or expand websites or microsites for courses that they teach. The present invention can help make these sites more effective.

### Some of the Principles Behind the Invention

Some principles behind the invention are 1. Preattentive attributes can be utilized to help students learn. 2. If a person receives the same lesson in multiple formats, the person is more likely to appreciate at least one of the formats. 3. Humans' eyes are drawn to patterns we already know, and patterns that a person already knows can be utilized to improve retention. 4. Instructors, and educational administrators, can give better advice to students and student groups if they know how much the students are studying, how the students are studying, and what areas in which the students might be having trouble, and how the students' studying relates to the students' assimilating knowledge. 5. Visualizations work best when they display information in familiar and easy to spot patterns, as Stephen Fry said, in 2009. 6. Students learn better when they connect knowledge to information that they already have. 7. Data graphics can sometimes be used to communicate information more easily to people who don't speak a language. 8. Some scholars have argued that the rate at which information is lost after being learned is basically a function of how the information is learned. See Anderson, 2000, p. 174, as Sosulski cited. 9. Putting information in practice immediately after it is learned is important, and helps with retention, and people tend to remember information that is immediately useful. For example, the inventor's mother, Arabella Persaud, used Fluffy, their cat, to illustrate the names, in Spanish, of body parts such as eyes and ears. This helped the inventor to remember the Spanish terms for these body parts. 10. Students will learn languages more effectively if each student selects the method of language learning that works best for that student. Alternatively, if the student does not want to, or cannot, select the best method themselves, the student can ask an instructor or facilitator to select the best method for the student, and the instructor or facilitator should select based on detailed data. 11. If a student thinks that the language learning method that works best for the student has changed, the student should be able to find out if the best method has in fact changed, and should have clear data available to decide whether the best method for the student has changed or not. 12. Hammerly said: for students to communicate, four things are necessary: motivation, a supportive teacher and classroom atmosphere, control of needed structures and expressions, and a variety of communicative activities. 13. Individuals can learn visually. 14. A difference between interaction and animation is that interaction data output is changed depending on what user wants. 15. Multimedia learning theory, which concerns the way people construct knowledge from words and pictures, says that people usually learn more effectively from multiple channels at once, such as audio and visual at the same time. 16. As a general rule, if a group of people spends more time learning something, on average, they will have more knowledge of that thing, on average. 17. Knowledge of words, the words' meaning, and how to use the words, in a study language, is correlated to knowledge of that study language. 18. People tend to remember information connected to unique or memorable situations.

### Term Numbers

These term numbers apply to the invention's components. (1) Individual interface. (2) Display device. (3) Grammar engine. (4) Grammar network map. (5) Individual tracking module. (6) Individual Complete Record. (7) Exporting module. (8) Interpersonal matching module. (9) Word record. (10) Charting module. (11) Words database. (12) Grammar Rules Module. (13) Word-form module. (14) Problem generator. (15) Identifier. (16) Language module, or “l-module”. (17) Language-to-language dictionary (L2L dictionary). (18) Cohort statistical engine. (19) Cohort achievement display. (20) Speaking module. (21) Interactive multimedia module. (22) Projection module. (23) Potential words database. (24) Group leader module. (25) Individual statistical module. (26) Non-fungible token. (27) Blockchain network. (28) Visual effect database.

If an instructor requires students to use the invention, as part of a class, the instructor should not grade in a way that encourages students to distort their characteristics the invention measures. This subverts the invention's goals of creating a customized learning experience for each student that works well for the student, and understanding how each student learns.

For example, requiring students to complete certain l-modules (16), as part of a class, would not subvert the invention's goals. Requiring the students to score 100% on the problems the l-modules present without using visual effects from the visual effects database would probably subvert the invention's goals, because part of the visual effects database's point is to find visual effects that help the students to learn, and so preventing students from using the visual effects database reduces their ability to find these visual effects. Likewise, any grading method that directly or indirectly discourages students from spending more active time on l-modules should be avoided. Part of the point of students spending more active time on l-modules is for students to gain more data about how they learn a study language most efficiently.

In the present invention, proxies for a user's “effort” can be the user's time spent using l-modules (16), number of page views, number of page views over a certain size, active time, or other things. Some embodiments use active time as a proxy for effort. The invention seeks to numerically describe the relationships between each user's language learning performance and language learning efforts, while helping each user find the best method(s), for the user, of learning each study language that the user wishes to learn.

Each user can be assigned an identifier (15) which will be used to identify the user and identify when the user is using the individual interface (1) or other components. The identifier indirectly helps to track the user's time spent on all the l-modules, and all the user's monitored measurements listed herein, related to all the study languages, that the user has started, because the identifier helps the individual tracking module to recognize which person is using the invention while the user is performing many of the actions that underly monitored measurements. The identifier can also be used to track the user. For example, if the user switches institutions the user's ICR will still be available and the records therein can be used to help the user's experience at the new institution.

The user should protect the identifier, through password protection, two-factor authentication, and/or any other methods known in the prior art. Many versions of the invention will utilize such protection for the identifier.

The identifier can be a username, a user number, a social security number, a QR code, or any of the other types of identifications for individual records present in the art. The identifier can also have multiple components, such as a combination user ID and password.

The identifier will identify the student's individual complete record (6). The individual complete record (ICR) is a record of the efforts that the student has made to learn study languages through the invention, and will be updated as the user continues to use the invention. At minimum, the ICR will include a record of all the language modules, in every study language, that the user has ever attempted to complete. To be more effective, the ICR should include more information, such as the student's monitored measurements.

When a student starts the student's first attempt to use an l-module (16), or, in some embodiments, when the student starts their first attempt to use the individual interface (1), the student should be required to use the student's identifier to create the student's ICR, and the identifier will be then be associated with the student's ICR. The student will be able to use their identifier to access the individual interface, and through it, the student's ICR, in the future, or in some embodiments the student can use the identifier to access the student's ICR directly.

The student can (And should, but need not be required to) include demographic information relating to the student in the ICR. This information is saved in the ICR and will enable analysis of the student's performance and actions later, which is important to the student when analyzing the student's monitored measurements, and important to instructors and educational administrators or others trying to tailor lessons in a language to the student's proficiency level in that language, or to assess characteristics of groups that include the student.

In some embodiments, this demographic information, will include, but not be limited to, some or all of. The student's age, location, name, gender, ethnicity, any disability information, and any institution(s) which the student has attended or is attending, and any course(s) at those institutions that the student has enrolled in, is presently enrolling in, or has completed, especially courses in the languages the student is trying to learn. The student can also fill out information about his or her goals for using the invention. This way, more “casual” language learners can be distinguished from students who have a more immediate need for the invention, such as those who are using the invention to get practice for classes where they are presently enrolled.

In some embodiments, the student should also include the student's native language(s), and any other languages the student knows, as part of the student's demographic information, and the ICR will include the ability to save this information. This is very important, for analyzing whether and how a student's proficiency in one language can help the student learn another language later. In some embodiments l-modules will also present explanatory material in one of the student's native languages if the student does not select a base language.

In most embodiments of the invention, the student will be able to add to, and change, the student's demographic information after the student first gets an opportunity to enter the student's demographic information when starting the ICR.

The active time amount the student spent on each l-module (16), and the number of new words the student acquires, in each l-module, are important because, among other reasons, the student can use this information to track how many new study language words they learned when they completed problems of each pr-type.

The student's ICR is important, because, among other reasons, the student will use the ICR to develop a record of the student's completion of l-modules in each study language and the student's monitored measurements over time. The student will also be able to use the data in the ICR and the charting module to make decisions about which pr-types the student can use to most efficiently learn each study language, and to find other important information about the student's learning the study language. For example, if lower CTOT or higher CTOT correlates to the student acquiring more words, per unit of active time, in a study language, the student may wish to alter their schedule to take advantage of this. Instructors will also be able to examine their students' past completion of l-modules, to determine how much each of their students has already learned about a language, and to customize a class to the exposure level that the class's students previously had in the language, and to how those students learned. The instructor can also get a better understanding of the e-types that the specific class's students tend to make, and customize the class appropriately. A student can also make more well-supported arguments about whether the student deserves “advanced” placement by showing the student's ICR, with records of completed l-modules and of the active time the user spent on those l-modules, to the relevant instructor(s) or administrator(s).

The ICR, in most embodiments, will include the user's word record (9) for each language for which the user has started any l-modules (16). The user's word record for the languages for which the user has started l-modules (16) can also be separate from the ICR in some embodiments, or can send information about words in the languages the user is studying, has seen in problems or used in responses to problems to the ICR in some embodiments.

“Monitored measurements” are measurements of various quantities pertaining to a user's use of the invention. The ICR will also include records of some or, preferably, all the following monitored measurements, for the user, with each monitored measurement calculated separately for each study language where the user has started at least one l-module: A. Active time amount, the user spent on each l-module (16) the user started. B. Active time amount, the user spent on each l-module the user completed. C. Practice time amount for each l-module the user completed. D. The user's completion time amount for each l-module the user completed. E. The user's CTOT amount for each l-module the user completed. F. For each l-module (16) the user started, a list of e-types the user made so far, in the order of how commonly the user made these types of errors (F1), and measurements of the percentage of problems, based on each l-module, on which the user made an error of each error type (“e-type”) (F2 for each l-module). This monitored measurement can be further divided into a monitored measurement for each e-type, a.k.a. Monitored measurement F1.1 and F2.1 for one e-type, monitored measurement F2.1 and F2.2 for another e-type, etc. G. The absolute number of the user's errors of each e-type recorded in monitored measurement F for each l-module (16) per active time period using that l-module (16). H. The total number of errors the user has made concerning the problems based on all l-modules (16) the user started for each study language. I. The number of the user's errors of each e-type recorded in monitored measurement F for each l-module (16) per practice time period using that l-module (16). The practice time periods can each be 1 minute, 1 hour, 24 hours, etc. J. If possible, the percentage correct the user scored, in problems of each pr-type that the user answered based on each l-module (16) the user completed. K. If possible, the number of times (Monitored measurement K1), that the user examined each written or other visual “explanatory material group”, the number of times the user was shown each auditory “explanatory material group” (Monitored measurement K2), the total time amount (Monitored measurement K3), the user examined each written “explanatory material group”, and the total time amount (Monitored measurement K4) the user examined each auditory “explanatory material group” that is part of each l-module (16) the user started, and averages for the number of times, and total time length, per l-module (16) that the user examined each of these four categories of explanatory material groups for that l-module, and combined averages for the number of times, and total time length, per l-module (16) that the user examined all explanatory material groups for that l-module. L. The number of new words in each study language the user acquired in each l-module (16) the user started, and the mean thereof. M. How many l-modules (Monitored measurement M1), and which l-modules (Monitored measurement M2), the user started and completed. N. The ranges, at different times, of percentage of the words in the problems, presented to the user, that comprised new words the user acquired. Note that monitored measurement N can be expressed in terms of its value during one time period, with the time period indicated, then in a second time period, with the time period indicated, etc. in some situations, such as a situation when the priority equation governing the percentage of words the user has not previously acquired, that are in problems presented to the user, changed over time. An example would be if, for a user, monitored measurement N had one value for one day with a specific date, and another value for the next day, etc. O. The percentage of words the user previously acquired that the user correctly recalls on review tests (monitored measurement O1) and/or problems where the user must recall a previously acquired word (monitored measurement O2), including the percentage of words correctly recalled on each individual review test and the user's mean score on such review tests that the user has taken. P. The range of time that the user used each visual effect from the visual effect database. Monitored measurement P can be subdivided into a time range for each visual effect (Such as P1 for the first visual effect, P2 for the second visual effect, etc.). Q. (Where mean advancement level is available and words are given advancement levels) For each l-module (16) the user started, the mean advancement level of the words the user acquired while the user was using that language module. R. Total number of words in the study language the user acquired. S. Total number of problems of each pr-type the user answered based on each l-module (monitored measurement S1), and an average thereof, and the total number of problems of each pr-type the user answered (monitored measurement S2). T. Trends over time in some or all of monitored measurements A-S, such as the number of l-modules the user completed in one time period versus another time period, and the student's error rates for different e-types in one time period versus another time period. Monitored measurement T can be further subdivided into monitored measurements T1, T2, etc. where T1 is a trend in one monitored measurement, T2 is a trend in a second monitored measurement, and T3, etc. are trends in other monitored measurements or subdivisions of monitored measurements. The information in monitored measurements A-T will be recorded in the user's ICR as the user completes problems, review tests, and l-modules using the individual interface. In some embodiments, the individual tracking module (5) will track the data from which the monitored measurements are calculated, including monitored measurements A-T, and include the data in monitored measurements A-T in the user's ICR. Monitored measurements F-J may be divided into more monitored measurements in some embodiments, depending on whether the l-modules (16), in those embodiments, allow a user to try again to answer a problem that the user answered wrong, and how many times the user is allowed to try to answer the problem. For example, if the user is allowed to answer the problem twice, the most common errors on each attempt would be listed under monitored measurement F, (Such as F1.1 for making the most common error on the first try, F2.2 for making it on the second try, etc.) and how often the user made mistakes of each type listed in monitored measurement F on the first try, and on the second try, during active time spent on each pr-type for each l-module would be listed in monitored measurement G (Such as G1 for making the most common error on the first try, G2 for making it on the second try, etc.).

The letter designations of the monitored measurements herein are for explanatory purposes. Each monitored measurement could be designated differently.

Other monitored measurements that can be included in some embodiments are the time amount the user spent viewing the L2L dictionary (17), time amount the user spent viewing the viewable information in the word-form module, and time amount the user spent viewing the viewable information in the grammar rules database. These quantities can each be subdivided further, into more monitored measurements like time spent per period (day, month, etc.), and time spent while the user is using each l-module (16). Other monitored measurements are possible in some embodiments.

The “monitored measurements” are monitored so that the user, and others who view the monitored measurements can learn more from the monitored measurements about how the user learns a study language, so that the user can learn it more effectively in the future. The user, and others, can also hopefully gain more information about what combinations of conditions (Conditions include, but are not limited to, pr-types presented to the user, number of times the user viewed the explanatory material for l-modules, percentage of the words in problems presented to the user that are new words the user acquired, and relationships between monitored measurements) are most related to the user learning the study language better. The user and others can also learn what e-types the user tends to make, how often the user makes errors of each e-type, and whether they are making progress on reducing their errors.

Some nonexclusive examples of relationships between monitored measurements that the user might examine are: 1. Finding when the number of acquired words per time period is highest. 2. Finding the number of acquired words that were acquired during problems of each pr-type or other place per active time period x (1-error rate) for those words on review tests. 3. Finding whether the user's ability to recall words on review tests acquired in a time period was related to the amount of the user's active time during that time period. 4. Finding the relationship, if any between the decrease rate of the user's ability to recall an acquired word, on review tests, per defined time period since that word was acquired (Such as per month, etc.) and the pr-type of the problem, or other source from which the user acquired the word. 5. Finding whether the user's ratio of words acquired to active time gets bigger or smaller as the user's CTOT for language modules gets bigger.

A list of e-types, into which different kinds of errors fall, for each study language, will be part of the problem generator in most embodiments. Errors' e-types are recorded so that the user and others can know about the types of errors the user tends to make. In some embodiments, if the user makes errors of multiple e-type in an answer, the e-types of all the errors will be recorded in the ICR, so that when the user later views charts and other records of the errors the user tends to make, each error the user made in the answer will be included in the measurement for that error's e-type.

The individual tracking module will, in most embodiments, track the monitored measurements, and will be able to identify the user after the user has inputted the user's identifier. The individual tracking module will monitor the relevant events needed for calculating each monitored measurement as these events happen, make the needed calculations and updates to previously calculated numbers, and store the results in the user's ICR. For example, the individual tracking module will monitor the user's completion of problems and the errors the user made while completing them. All methods of monitoring these relevant events, making the needed calculations and updates to previously calculated numbers, and storing the results in the ICR, that are part of the prior art, are part of the invention herein.

The present invention will use analytics concerning the user's monitored measurements to find where a user has the most “trouble” learning a language, by recording and charting the e-types the user makes most often. For example, some monitored measurements track what pr-types the user gets wrong most often, and the types of grammatical errors the user makes most while writing compositions. This information is stored in the user's ICR. Other components, such as the charting module, can then create charts concerning the monitored measurements, and perform calculations on the user's monitored measurements to help the user understand areas where the user made the greatest numbers of errors. Some embodiments will then seek to help the user reduce these errors, by informing the user of the e-types he or she is making most often, and some embodiments include a priority equation that the user can modify, so that the problem generator will give the user more problems of the pr-type(s) the user desires (which may be the pr-type(s) where the user is making the most errors). For example, if the user is studying Spanish, and the l-module that covers “ser” and “estar”, and the user makes the largest number of errors in using “ser” when he or she should be using “estar”, or vice versa, then the invention can give the user more problems where he or she is supposed to choose between “ser” and “estar”.

More Information about Other Components

Grammar network maps (4) of study languages are used in some embodiments of the invention. A study language's grammar network map (4) is a computer-generated network diagram of as many words in the study language as can be added to the grammar network map, with the eventual goal being to include all the study language's words in the grammar network map (4). An edge will go from each word in the grammar network map to as many as possible of the words (preferably every other word) which could grammatically follow the first word under the study language's grammar. A user can view part of the grammar network map (4) and observe and follow the edges going to and from different words, and can “scroll through” the grammar network map (4) and view different parts of the grammar network map (4) and see the edges going to and from words in those parts of the grammar network map (4). This will help users to understand how a study language's words work together, and how some study languages use some words often than others. Students and other users who use the grammar network map will learn better because they will see connections between study language words, thus hopefully connecting knowledge of how study language words work together to knowledge of the study language words themselves, which the users already have.

In some of these embodiments, the words the user previously acquired in l-modules will be highlighted or otherwise emphasized on the grammar network map, along with edges leading from those words, when the user views the grammar network map on a display device (2).

In some embodiments, when a user views each word in the grammar network map, moving the cursor over that word will activate a direct link to the word's definition in the L2L dictionary (17) in the base language, and/or a direct link to the word's entry in the word-form module (13), and/or a direct link to the word's entry in the words database.

In some embodiments, the user will not have to view all the edges going to, and coming from, each word on the grammar network map. Instead, the edges will be broken into categories, and the user will be able to select which category of edges coming from, or going to, a word the user wishes to view. For example, in languages using the same alphabet as English, the edges from a word might be broken down into categories based on the first letter of the word to which they lead, and the user would be able to view one of these categories at a time. The edges leading to a word beginning with “A” would then form one category, the edges leading to a word beginning with “B” would form another category, etc.

In some embodiments, the font size of each word in the grammar network map (4), when displayed, depends on the number of edges to and from that word. In some embodiments, projected words for the l-modules the user has started or completed will be shown on the grammar network map in larger font than, or a different color from, other words.

A display device (2) is a computing device of any kind known in the prior art that is capable of connecting to the internet and running the individual interface (1), including any necessary connections to the invention's other software components the user wants to use.

The individual interface, or “i-interface” (1) is a program module through which an individual user, such as a student, can perform language learning activities using l-modules (16) which will connect to the individual interface (1). The user can also view the user's ICR (6) through the individual interface (1). The user, in some embodiments, can also use the individual interface to view the user's word record (9), the words database (11) grammar rules module (12) and word-form module (13) for the study languages the user is learning, and the user can use the charting module, in embodiments where the charting module is present. The user can also view and use other components, using the individual interface, in some embodiments.

In some embodiments, a user can input the user's identifier (15) into the display device to access the individual interface (1) when desired.

The user can use the i-interface (1) to choose a study language, and also choose a base language, from the base languages then available to use together with the chosen study language. The number of base languages available for some study languages may be increased over time.

In some embodiments, the base language is also the language in which the individual interface presents to the user background material that the individual interface received from the individual tracking module (5), ICR (6), exporting module (7), interpersonal matching module (8), and charting module (10), and other components that create or include background material. For example, axis labels on charts the charting module (10) creates are a form of background material that the individual interface will present in the base language.

The user, in some embodiments, will have the option to change the user's base language for the study language the user is trying to learn when the user starts a new l-module (16) for that study language. In some embodiments, the user will have this option while the user is completing an l-module (16) for the study language. The individual tracking module (5) will save the identity of the base language the user selected for the study language in the user's ICR.

The user uses the individual interface (1) to choose which of the l-modules (16) available for the study language, to further connect with. In some embodiments, the user will have needed to input the identifier (15), to access the individual interface (1) and the individual tracking module (5) will be monitoring the individual interface (1), and will match the user's actions, using the individual interface, with the identity of the user performing those actions.

Some of the explanatory material the l-modules (16) for the study language each transmit to the i-interface (1) for presenting, will be comprised of words in the base language, and the rest of the words thus transmitted should preferably be comprised of words in the study language.

In some embodiments, the individual interface will include a list of l-modules, for the study language, to which the individual interface (1) can connect. One way, but not the only way, for the individual interface to include this list is for each l-module, for the study language, to transmit to the individual interface that the l-module is ready for use. The individual interface will include in the list those l-modules (16) that fulfill the user's requirements for being instructed about the study language using the chosen base language. The list will be viewable by the user in some embodiments, so the user can choose the l-module (16) the user wants to use more easily. The user should be able to select the l-module (16) that the user desires from the list. The individual interface (1) will then be able to receive and present explanatory material from any l-modules the user selected, as well as problems based on that l-module. Other methods of presenting the l-modules to the user, with which the i-interface can connect, that are part of the prior art, are also explicitly part of this invention.

In some embodiments, l-modules (16) will each be designed to instruct a speaker of a specific base language in a specific study language, and some or all of the explanatory material and background material in each l-module will be expressed in a specific base language, so, for example, some or all of the written explanatory material will be written in that specific base language. The individual interface will place only those l-modules designed to teach a speaker of the selected base language about the selected study language in the list presented to the user.

In some embodiments each l-module (16) includes explanatory material expressed in as many base languages as possible. After the user selects the base language and study language, the l-modules will transmit explanatory material and background material in the selected base language, but not other base languages, to the i-interface, which will present the explanatory material and background material, expressed in the selected base language, to the user.

The l-modules can be designed so that when an l-module transmits to the individual interface explanatory or background material that is supposed to appear on the display device's screen in the base language, the transmission can include an indication that the explanatory or background material should be translated into the base language. Every method of making sure that the explanatory material or background material sent from the l-modules to the individual interface appears on the display device's screen appears in the user's selected base language, known in the prior art, is part of the present invention.

Likewise, every method of making sure that background material sent from another component to the i-interface appears in the user's selected base language, known in the prior art, is part of the present invention. These methods include having multiple versions of the component that each include and/or produce background material in the user's selected base language, of which only the version of the component that includes and/or produces background material in the selected base language will transmit background material to the individual interface for presenting. These methods also include using one version of the component, that includes and/or produces a version of all background material in every base language, that the component transmits to the individual interface. The component would then receive the identity of the user's selected base language from the individual interface, and would only transmit the background material, expressed in the base language, to the individual interface. These methods also include the background material being translated into the base language by the i-interface, when the background material is transmitted to the i-interface.

Once the user selects the l-module the user wants to use, the individual interface (1) transmits the selection to this l-module (16) and the individual tracking module (5) records the selection in the user's ICR. The l-module (16) then transmits to the individual interface (1) the options of which of the l-module (16)'s topics the user wishes to practice/study, and the individual interface displays the options (Or if there is only one option the individual interface may skip allowing the user to select the topic). The user selects the topic, using the individual interface (1), and the individual interface (1) transmits the selection to the l-module (16). The l-module (16) then either sends explanatory material about the topic to the individual interface (1), gives the user the option about whether to view the explanatory material, or interacts with the problem generator to create a problem for the user to solve. The individual interface presents the explanatory material or problem, and if a problem is presented the user can solve the problem.

The individual tracking module (5) monitors a) The l-module selected, b) Whether or not the user views explanatory material, and c) Whether or not a problem is presented to the user, and saves this information in the user's ICR.

In many embodiments, the individual interface (1) will also connect to, and allow the user to access, the L2L dictionary (17), the grammar rules module and the word-form module, including accessing them while using an l-module (16). The user can then use these components as reference sources while completing problems, if desired, and as reference sources to learn more about the study language.

In many embodiments, the individual interface (1) will also connect to, and allow the user to view, parts of the user's ICR (6) including locations where the user can view the user's monitored measurements and demographic information. In some embodiments, the individual interface will also allow the user to access the charting module, so the user can use the charting module to make charts concerning their own monitored measurements.

In many embodiments, the individual interface will connect to the problem generator (14), so the user can access the problem generator and view and change the user's priority equations if desired.

In many embodiments, of the individual interface (1), the user will also be able to give permission for other specific users to view parts of the user's demographic information or some or all of the user's monitored measurements, and permission for other specific users to use the cohort statistical engine to include some or all of the user's demographic information and/or monitored measurements in the cohort computations for cohort(s). These capabilities can be used, for example, for a user to give permission for an instructor to use the user's monitored measurements in the cohort computations for a cohort, which comprises the students in a class in which the user has enrolled. Permission for a second user to view information that is part of a first user's demographic information or monitored measurements is different from permission for the second user to use the same information in cohort computations. If a second user uses a first user's demographic information or monitored measurements along with those of other first users, in cohort computations, the second user will not know the actual value of any of the first user's demographic information or monitored measurements, only the results of cohort computations utilizing some or all of the first user's demographic information and/or monitored measurements and those of other users. This lowers the chances of users being “stereotyped”, or subjected to preconceived notions based on their demographic information and/or monitored measurements.

A “word-form” in a study language means both the basic or infinitive version of a word (if any) and any version of the word that has been altered in accord with the study language's rules to reflect specific circumstances, such as the past tense version of the word. Some embodiments will include a word-form module for each study language. In other embodiments, a single word-form module will contain the words and their word-forms for multiple study languages, with the words and their word-forms for each study language designated as belonging to that study language. The word-form module (13) for a study language has a list of words in the study language, the word-forms of each of the words, in the study language, and labels for each word-form, saying which form of the word that word-form is. The label for each word-form will be a piece of data, and an attribute(s), pertaining to that word-form. A word's word-forms should include, at minimum, all the tenses of the word, and any plural forms of the word, that exist in the study language. A word's word-forms should also preferably include every other form of the word existing in the study language. An “attribute” is a way in which a word-form is different from the basic form of the same word, or a way in which a word-form of a word fits into a subgroup of words of that word's word-type. The word-form module (13) should ideally include the forms of every word in a study language that is in the words database for the study language. If a word-form module is designed to cover multiple study languages, the word-form module will include the above information for each of the study languages. The user will be able to access the word-form module and view each word and the word-forms of each word, in the user's selected study language.

The grammar rules module (12) for a study language will include grammar rules for the study language, and should include all the study language's grammar rules. Some of the grammar rules will each express how a word must be modified to be grammatically correct in a certain, defined, context. For example, the grammar rules module for Spanish will include grammar rules modifying a Spanish verb for each Spanish verb tense. Some grammar rules will specify what types of words must be placed in certain sequences, in specific situations like specific kinds of sentences. Each study language or dialect could have its own grammar rules module, or the same grammar rules module could include the grammar rules for multiple study languages, with each study language's grammar rules designated as belonging to that study language. The user will be able to access the grammar rules module and view grammar rules in the user's selected study language. In most embodiments, the grammar rules in the grammar rules database will include grammar rules about which word-form of a word to use in a certain context.

The charting module (10) is a software module that a user can use to create charts and graphs based on information in the user's ICR. One of the charting module's goals is for the individual user, using the charting module (10), to discover information about how the user learns languages, or learns a specific language, and about the relationships between the user's monitored measurements. This helps the user to learn visually and to allocate their efforts better when learning the study language. The charting module (10), at a minimum, should be able to graph any of the user's monitored measurements being used in the same embodiment as the charting module, as the Y-axis on a graph, with any of the other monitored measurements being used, as the X-axis on the graph. The charting module should also be able to plot the trends in any of the monitored measurements being used (such as monitored measurement T, if used in the same embodiment as the charting module). The charting module (10) should also be able to plot one of the monitored measurements on the Y-axis, on a graph, against time as the X-axis. In some embodiments, the charting module (10) will also be able to plot 3 monitored measurements against each other, on the X, Y, and Z axes, or plot 2 monitored measurements against each other, with time on the third axis. In some embodiments, the charting module (10) will be able to plot more than 3 monitored measurements against each other, or plot 3 or more monitored measurements on different axes, with time as an axis, in a “graph” which cannot be viewed, but where the coordinates of different points on the “graph” can be found, and shown to the user, and the slopes of different parts of the “graph” can be calculated and shown to the user.

For every monitored measurement that is expressed as a number, per language module, for a subset of the user's use of language modules, the charting module (10) should also be able to show the total measurement of the relationship between that quantity, and the total of all the user's use of language modules.

The charting module (10) also can find the total number of new words the user acquired, for each of multiple time periods, by examining the user's word record (9) and finding the number of new entries in the user's word record (9) during each of these time periods. Then the charting module (10) can create a graph of the number of new words the user acquired in each of the time periods.

In some embodiments, the charting module (10) can multiply one monitored measurement by another one or more of the monitored measurements, and graph the product against time or against any monitored measurement. The user can use this capability to discover more information about how their learning and recall of a study language changes in conjunction with other factors. This capability can be useful, for example, if the user wants to multiply the percentage correct the user received, by the number of words the user acquired, for each l-module (16) that the user has started, and graph the product on the Y-axis, with the l-modules the user started on the X-axis.

In some embodiments, the charting module can also create other graphs of the user's monitored measurements, including density plots of the data underlying some monitored measurements.

These capabilities of the charting module will also help each user to find the combinations of explanatory material types and pr-types, presented to the user, that works best to help that user to learn each study language most efficiently, or learn that study language according to the user's goals. A specific user can find how that specific user's monitored measurements, concerning a specific study language correlate to each other, and to products of multiplied monitored measurements. Then, the user can use the user's knowledge about the correlations to decide how that user should use the invention to learn each specific study language, and coordinate other factors to gain a specific desired level of results. The user can also better decide how to allocate the user's time spent on learning the study language.

The user can, for example, use the charting module to more easily examine the relationship (if any) between the amounts of time, per l-module, that the user examined the “explanatory” material that is part of each l-module (16) the user started, and the user's completion time for the l-module (16).

Another kind of graph the charting module (10) can make, in most embodiments, is a “bubble graph” for the word categories of the words the user acquired. The bubble's size for each word category will be directly proportional to the number of words the user acquired in the word category. The user will be able to easily tell the number of words in one word category the user acquired, versus the number of words in another word category the user acquired, by looking at the bubbles' sizes. In some embodiments, each “bubble” showing the number of words in a word category the user acquired will be surrounded by a second bubble showing the category's total number of words in the words database (11), or L2L dictionary (17) (which one depends on the embodiment being used).

“Word Category”, or “W-Category” means a sphere to which the study language word relates. For example, “science” could be one w-category, “business” another w-category, and “travel” and “food” would be third and fourth word categories. There would be other word categories. More specific word categories that define more specific spheres are possible.

The charting module (10) should also be able to create isopleth graphs, in which the number of words in a study language the user acquired is plotted for multiple word categories. In the isopleth graph, a field, such as a square, represents each category of words, and the field's color represents the percentage of words in the words database (11) or L2L dictionary (17) (which one depends on the embodiment) this particular user acquired.

One reason for the isopleth and bubble graphs is for the user to understand how many words they have learned in a w-category, and how much they know about the w-category, versus the number of words in the w-category. Then, if the user wants to know more words in a specific w-category, the user can alter the problem generator's priority equations to give the user more problems related to the w-category. As the user does more of the problems, the user will learn more words in the w-category.

The charting module (10), in some embodiments, can create bullet graphs of the actual number of words the user acquired, vs. the projected numbers of words the user acquired, in defined time periods, or while the user is using one or more specific l-modules (16). The charting module would get the actual numbers of words the user acquired, in the relevant time periods, or while the user was spending time on the relevant modules, from the user's word record, and the charting module (10) would get the projected numbers of words the user acquired by examining the current projected words for all of the l-modules in question. The projected words for a time period would be the current projected words for the l-modules that the user spent active time on during the time period.

In some embodiments, the charting module will use different colors to represent different levels of various quantities, such as different estimated proficiency levels, different percentage of words learned in a w-category, and different numbers of words learned in a time period, on bar graphs and other types of graphs besides isopleth and bubble graphs.

The charting module (10) will also be able to send any graph the charting module (10) creates to the i-interface, which will present the graph on the display device (2)'s screen, except for possibly “graphs” of quantities in more than 3 dimensions. The charting module will be able to send other information about a graph of more than 3 dimensions to the i-interface, which will present the graph on the display device (2)'s screen.

In some embodiments, the charting module and the cohort achievement display can use shades of grey, in place of colors, in charts and/or graphs.

The word record (9) is a record of all the words the user acquired, in a study language for which the user has started at least one l-module. The word record, in most embodiments, (9) also includes a record of any l-module which the user was using when the user acquired each word, and the date and time the user acquired each word. In some embodiments, the user can also add words to the word record (9) themselves, in addition to the invention's computer program components placing words in the word record.

The cohort statistical engine (18) is a software module that creates cohorts from individual users and user groups, stores cohorts' identities and keeps track of which users are members of a cohort, adds users to cohorts and subtracts them from cohorts, and performs statistical analysis concerning cohorts. Users can be added together to create a cohort at any time, including retroactively.

The statistical calculations that the cohort statistical engine can make can include calculations of the mean, mode, and standard deviation, of monitored measurements, including monitored measurements A-S, and the same trends described in monitored measurement T, for the users in the cohort, and also calculations of the distribution of each of monitored measurement for the users in the cohort. The cohort statistical engine can also make a graph of the cohort members' distribution of a monitored measurement, and can divide the cohort into multiple equal groups, and find the means, modes, and standard deviations of monitored measurements for the members of each of these groups. The statistical calculations can also include calculations of percentiles of monitored measurements for the cohort members.

The cohort statistical engine can get the cohort members' monitored measurement data, and any demographic information, which is needed for statistical calculations concerning a cohort, from the cohort members' ICRs.

In some embodiments, the cohort statistical engine will be able to create graphs, including density plots, of the cohort members' monitored measurements.

In some embodiments, the cohort statistical engine will also be able to calculate some or all of the following “cohort computations” regarding a cohort.

A. For each l-module at least one cohort member started, mean active time amount, that cohort members who started that l-module spent on that l-module. B. For each l-module at least one cohort member completed, mean active time amount, that cohort members who completed that l-module spent on that l-module. C. For each l-module at least one cohort member completed, mean practice time amount, the cohort members who completed that l-module spent on that l-module. D. Cohort members' mean completion time for each l-module, for cohort members who completed that l-module. E. The cohort members who completed each l-module's mean CTOT for that l-module. F. A list of e-types the cohort members made, concerning problems based on each l-module at least one cohort member started, with the list ordered by how commonly the cohort members made errors of each of these e-types during active time for that l-module (F1, F2, etc.). G. The cohort members' mean number of errors of each e-type in cohort computation F per active time period (G1, G2, etc.). H. The total number of mistakes that the cohort members made related to all l-modules the cohort members started for each study language, and the mean number of mistakes per cohort member. I. If possible, how often, on average, the cohort members made mistakes of each e-type listed in cohort computation F during completion time spent on each pr-type for each l-module (I1, I2, etc.). J. For each l-module at least one cohort member completed, the mean percentage correct cohort members who completed the l-module scored, in problems of each pr-type, concerning that l-module, that these cohort members answered. K. If possible, the number of times (K1), and the total amount of time (K2), the cohort members who started an l-module examined the “explanatory” material that is part of that l-module. L. Mean number of new words in each study language each cohort member acquired in each l-module that this cohort member started. M. Mean number of l-modules, cohort members started and completed for each study language (cohort computation M1), and the percent of cohort members who completed each l-module that at least one cohort member completed (cohort computation M2). N. The averages of the upper bounds (N1), and averages of the lower bounds (N2), of the range(s) of text percentage in problems presented to each cohort member that comprised not previously acquired words to that cohort member. O. The mean percentage of words each cohort member previously acquired that this cohort member correctly recalls on review tests (O1) and/or problems (O2) that directly ask about a word that cohort member previously acquired. P. Summaries of the time range that each cohort member used each visual effects from the visual effect database that any cohort member used, and of how many cohort members were using each visual effect at each point in time. The summary may take the form of a heat map, Gantt chart, tree diagram, or any of the forms known in the prior art. R. For each l-module any cohort member started, mean advancement level of the words in cohort computation L the cohort members who started each l-module acquired. S. Mean active time amount for cohort members per time period (Cohort computation S can be divided further between time period types). T. Mean combined completion time for all l-modules for cohort members per time period period (Cohort computation T can be divided further between time period types). U. Mean combined practice time for all l-modules for cohort members per time period. V. Trends in some or all of cohort computations A-U, such as the number of l-modules the cohort members completed in one time period versus another time period, and the cohort members' error rates for different e-types in one time period versus another time period.

In some embodiments, the cohort statistical engine will only allow a user to incorporate data, such as monitored measurements or demographic information, into statistical calculations about a cohort when the individual user to whom the data pertained gave permission for that user to incorporate this data into the statistical calculations. In some embodiments, the user to whom the data pertains will have to give this permission via that user's ICR (For example, by inputting it into the ICR), and in other embodiments, via another component.

In some embodiments, certain users will be granted permission to use the cohort statistical engine, but not other users.

The cohort achievement display (19) is a software display module that is used to show cohort computation results and the results of other statistical calculations that a user has requested the cohort statistical engine to perform on a cohort(s), and the graphs the cohort statistical engine creates. The cohort achievement display, in some embodiments, can present other information, like charts concerning the cohort's cohort computation results. The information the cohort statistical engine (18) sends the cohort achievement display (19) for presenting can also include the averages and standard deviations of the cohort members' monitored measurements and density plots of their monitored measurements. The cohort statistical engine (18) sends the results of calculations to the cohort achievement display, which shows them to the user. In some embodiments, these results will be shown to the user through being sent to the user's individual interface, and the individual interface will present the results on a display device's screen. In some embodiments, after the results are presented, a user can also use the cohort achievement display (19) to command the cohort statistical engine (18) to make additional calculations, the cohort achievement display (19) will transmit the commands to the cohort statistical engine, the cohort statistical engine will make the calculations and transmit the results back to the cohort achievement display, and the cohort achievement display will show the results. The cohort statistical engine (18) will send the results of calculations the cohort statistical engine (18) made, at a user's request, to that user's cohort achievement display (19), for that user to view.

A dashboard is a type of graphical user interface which often provides at-a-glance views of key performance indicators (KPIs) relevant to a particular objective or business process.

The cohort achievement display (19) can present dashboards with important information about a cohort's use of l-modules, and other information about the cohort, such as results of the cohort's cohort computations, and statistical information concerning the cohort members' monitored measurements.

An l-module is a program module that seeks to teach a user about a part of a study language or subject(s) related to a study language, with the goal of helping the user to speak, read, write, and use the study language better. It is anticipated that the amount of material covered by a 1-semester class on a study language will equal the amount of material covered by multiple l-modules on that study language.

Some l-modules (16) for the same study language will be sequential, in that a user will not be able to start some l-modules until the user has completed other specific l-modules. Some l-modules (16) for the same study language are not sequential.

Some reasons that l-modules are designed to each cover less material than a semester-long or quarter-long class are A. For the user's flexibility. It is easier for the user to fit more, individually smaller modules into the user's schedule than fewer, individually larger modules that each cover more material, and, combined, cover the same amount of material; and B. For a user enrolled in a language class to, if needed, be able to find the l-modules covering the same material as the language class, and focus on those l-modules (16). The study of each language, using the invention, is broken into a large number of individually small l-modules related to each study language. Actual classes in many languages will cover varying topics, that vary depending on the institution or even on the individual instructor. For example, a class entitled “German 1” at Institution A may cover topics 1, 2, 3, 4, and 5, and “German 2” at Institution A may cover topics 6, 7, 8, 9, and 10, while a class entitled “German 1” at Institution B may cover topics 1, 2, 3, 4, and 6, and “German 2” at Institution B may cover topics 5, 7, 8, 9, and 10. Each user, and the instructors at each institution, will be to pick the l-modules, using the invention, that most apply to that user's or instructor's needs. The chances of each user learning a study language finding a combination of l-modules, that fits that user's specific needs, is higher if there are more l-modules that each cover a smaller area of the study language. A user can use l-modules to help the user learn the class material, in a class where the user is enrolled, that covers the same material as those l-modules, and to help the user learn what the user's strengths and weaknesses are, when learning the study language.

Many l-modules (16) will each focus on one or a few specific subjects concerning a study language. For example, the first embodiment should have an l-module (16) for Spanish, devoted to the Spanish future tense, how the Spanish future tense is applied to words, and how a word's spelling and pronunciation are changed when the future tense is applied to that word. An l-module's subjects can be divided into more, more narrowly focused, topics.

An l-module will include explanatory material about the aspect(s) of the study language that the l-module is trying to teach. “Explanatory material” is material explaining something about a study language, such as how to correctly say or write something in a study language. If the individual interface communicates explanatory material to the user by showing explanatory material on a display device's screen or through another way, such as through the display device making sounds, is a form of “presenting” the explanatory material to the user. An “explanatory material group” is either A or B below, or a combination thereof. A. A group of one of more pieces of explanatory material that, during active time, the individual interface (1) causes to appear at the same time on the display device's screen, if any one of these explanatory material pieces appears on the screen during active time. In some embodiments, the l-module will ensure this by transmitting to the individual interface all the pieces of explanatory material in the explanatory material group, and a command that all the pieces of explanatory material in the explanatory material group should appear on the display device's screen at the same time. B. A group of one or more sounds that the l-module either plays using the display device's capabilities or makes available for the user to access (via sound files or any other method known in the prior art) during the user's active time using that l-module.

A nonexclusive example of explanatory material that an l-module will include is that an l-module about French that discusses the future tense in French will include explanatory material about what the future tense in French is, how French verbs are modified when expressed in the future tense, forms of the future tense, and when use of the future tense, in French, is appropriate. The explanatory material for most l-modules (16) will include written statements and descriptions about one of the study language's aspects that is one of the l-module's subject(s). For example, if one of the l-module's topics is some important words in the study language, the explanatory information might include definitions of such words, examples of how to use the words, example passages, and examples of what grammatical rules affect the words. The explanatory material might also include recordings of a voice speaking, such as, for example, a voice speaking words in the study language that the user acquired, or explaining something about the study language, or explaining words in the base language and their translations in the study language, or vice versa. The explanatory material might also include other sounds. The explanatory material might also include information about the number of edges that go to, and/or from, words in the grammar network map, and information about the frequency of each of the words in a corpus. If one of the l-module's topics is a grammatical rule in the study language, the explanatory material may include descriptions of how the grammar rule works and examples of how it is used. If one of the l-module's topics is a category of nouns, such as a category of food, or a category of motor vehicles, the explanatory material might include pictures of the nouns in the category, such as pictures of types of food or motor vehicles in the category. In some embodiments, an l-module (16)'s explanatory material may include “demonstration” problems, for the user to complete, in the study language. The demonstration problems will be problems for the user to complete, that are not scored. The demonstration problems may be problems of one of the pr-types listed above, or problems of another pr-type. An explanation for the “right” answers to the demonstration problems will also be included with some demonstration problems, and presented to the user before or after the user completes the demonstration problem, so the user can learn. The explanatory material may also include examples of correctly completed sentences, in the study language, and animations of problems being completed, along with explanations. Explanatory material can also include example passages, example words, and other information.

In most embodiments, the user will be assumed to view written and other visual explanatory material if the explanatory material appears on the display device's screen, and the individual tracking module (5) will count the time the explanatory material appears on the screen as time the user is examining the explanatory material and as active time. In some embodiments, the individual tracking module (5) will use the display device (2)'s camera feature to find out whether the user's face is looking at the screen, and use this to assume that the user's eyes are looking at the screen or active “window” presenting the explanatory material, and the individual tracking module (5) will count the time the user's eyes are on the screen as time the user is examining the explanatory material group and as active time. If the user clicks a button indicating the user wants to move from viewing an explanatory material group to viewing something else (Such as a button marked “next” in some embodiments), the user's time examining the previously shown explanatory material group will be assumed to be ended, but it will be restarted if the user clicks back to, or again starts viewing, the explanatory material group. If the user starts being shown written or other visual explanatory material for the same l-module (16), the individual tracking module, in most embodiments, will monitor this and the user's total time spent being shown the explanatory material for that l-module will be counted as increased by the amount of additional time spent being shown the explanatory material. The user's time viewing each explanatory material group the second time, third time, etc. will be added to the time counted as time the user was shown the explanatory material for that l-module (16). The individual tracking module (5) will keep track of the amount of this time and will enter it into the ICR as one of the monitored measurements.

The amount of time that the sounds in each explanatory material group comprising one or more sounds are played to the user, using the display device's sound playing capabilities, will also be added to the time counted as part of the time the user was shown the explanatory material for the l-module (16) and the individual tracking module (5) will also keep track of this time and add it to the appropriate monitored measurements. The individual tracking module will also track the number of times the user was shown each explanatory material group. The number of times will be used to compute some of the user's monitored measurements in some embodiments. In some embodiments, the individual tracking module will also track the number of times the user was shown each explanatory material group comprising one or more sounds, and this number will be used to compute some of the user's monitored measurements in some embodiments.

In many embodiments, for the user to “complete” an l-module, the individual interface (1) needs to cause all the written or other visual explanatory material in the l-module to appear on the display device's screen at least once, and also have to complete a certain number of problems the l-module sent to the i-interface for presentation to the user, and the user will have to achieve a certain minimum percentage correct in those problems. The individual tracking module (5) will keep track of the amount of time the user spends on the explanatory material, and whether the user correctly answers each problem, and record this information in the user's ICR.

In many embodiments, the study language words in each explanatory material group will be sent by either the i-interface or the l-module (depending on the embodiment) to the user's word record after the user finishes examining that explanatory material group. In some embodiments, the l-module will send the study language words in the explanatory material group to the word record. The word record will then add each study language word in the explanatory material group, that was not already in the word record, to the word record, with the other data that pertain to the word's entry in the word record. Words that have previously been entered into the word record will not be added again, but words not previously part of the word record will be added to the word record. In some embodiments, the word record will check each word in the explanatory material group to see if there is already an entry for that word in the word record, and if there is not, the word record will add the word and related data to the word record.

In some embodiments, for purposes of calculating “percentage correct”, problems will be each worth a certain number of “points”. When a group of problems is scored, each problem will have a certain value in the calculation. A problem worth 2 points will be weighted twice as highly as a problem worth 1 point, a problem worth 3 points will be weighted 3 times as highly, etc. The number of points per problem can depend on the kind of problem, can be based on the number of words in the problem, or can be based on something else, depending on the embodiment. For example, in some embodiments, problems can be worth a minimum of 1 point, and each 8 words or fraction thereof, that is part of the problem, will be worth 1 point. Percentage correct for a group of problems would usually be calculated by dividing the point total for problems the user got correct by the point total for the problems in the group.

The above scoring method would usually also apply for problem groups in other contexts, such as problem groups on practice tests and review tests.

Other methods of scoring the problems in any group of problems are possible and are explicitly part of the present invention.

“Scoring” a problem is defined herein as finding whether the problem is answered correctly and the number of points the user received, out of a maximum number possible, for the user's answer to the problem. Scoring a group of problems is defined herein as finding which of the problems were answered correctly and the number of points the user should receive, out of a maximum number possible, based on the user's answers to the problems. Scoring is used partly so the user can have quantifiable data to see how well the user answered problems in different circumstances, and can use this data to learn the study language more effectively.

An l-module will also include instructions to send to the problem generator, and the speaking module and interactive multimedia module if they are present, about the content of problems, based on that l-module, that should be presented to the user when the user is using that l-module. The instructions can include information about grammar rules, word-forms, word categories, and words that should be included, or that should preferably be included, in problems based on that l-module. At some point(s), when the user is using the l-module, the l-module, will send some or all of these instructions to the problem generator, and possibly speaking module and interactive multimedia module, so that any of these three components, that are present, can present the user with problems based on that l-module. The user will then be presented with problems based on that l-module. The problems are used to get more information about how the user learns the study language, and to help the user learn. In some embodiments, there will be “recognition codes”, that the l-module will send to the problem generator when the user wants to answer a problem(s) based on that l-module. In these embodiments, the grammar rules module will include one or more recognition codes for individual grammar rules, the words database and/or the L2L dictionary will include one or more recognition codes for individual words, and recognition codes for words in some or all word categories, and the word-form database will include one or more recognition codes for some or all word-forms. When the user wants to do problems based on an l-module, the l-module will transmit its recognition codes to the problem generator, and a) The recognition codes, and b) Whether the l-module's recognition code(s) match the recognition code(s) of a word, grammar rules, or word-form, will affect whether that word, grammar rules, or word-form is used in a problem based on that l-module. For example, the problem generator may be programmed to ensure that a certain percentage of the words used in a problem based on an l-module have recognition codes that match the recognition codes of that l-module. If other items such as pictures, or videos, can serve as the basis of problems, these items can also have recognition codes, and whether the l-module's recognition code(s) match the recognition code(s) of one of these items will affect whether that item is used in a problem based on that l-module. In many embodiments, the projected words, or current projected words, for an l-module will have recognition codes that match the l-module's recognition codes, increasing the chances that the projected words will be featured on problems based on that l-module. Herein, if a problem is “based on” an l-module, then a) Instructions from that specific l-module were used in creating that problem.

In some embodiments, the instructions can also include adjustments to the formulas the problem generator and other components use to decide the pr-types of problems they create, and those problems' content. The l-module will send these instructions to the problem generator, so that the right kinds of problems, based on each l-module, can be presented to the user.

The total number of l-modules focused on teaching each study language to speakers of a specific base language should ideally be enough that if a speaker of the base language were to master all the information concerning the study language, discussed in all these l-modules, the speaker of the base language would be fluent in that study language. However, in some embodiments, not all of these l-modules will be available. It is expected that the invention will still be effective in helping users to learn the information concerning the study language, discussed in those l-modules that are available, and helping individual users to understand how they can best learn the study language.

The projection module (22) is present in some embodiments, and notes the percentage correct the user scores on each pr-type in a practice exam. Then the projection module announces to the user the percentage correct the student received for each pr-type, the e-types the user made, the percentage correct the user received on the problems based on each l-module, and also multiple “scenarios” where the projection module shows how the user's total score on a real exam could differ from the user's total score on the practice exam, if the real exam's and the practice exam's compositions differ in specified ways. Part of the reason the projection module is used is so that student users can predict when they need to study a study language more before a real exam, and what they need to focus on most. This will improve student retention.

The interpersonal matching module (8) seeks to match people interested in practicing the same language, in the same geographic area, together, and, in most embodiments, can be accessed through the individual interface (1). A first user accesses the interpersonal matching module (8), and enters a study language that the first user wants to practice and a geographic radius in which the first user wants the interpersonal matching module (8) to find other users with whom the first user could practice the study language. The interpersonal matching module (8) also detects the first user's geographic location using the location detection capabilities of the display device (2) the user is using. Alternatively, the first user can enter their geographic location in the interpersonal matching module (8). The interpersonal matching module (8) uses the wireless capabilities of the display device (2) that the first user is operating to communicate with interpersonal matching modules of other users within the radius the first user defined (Or communicates with a central source with which other users' interpersonal matching modules are also communicating, and communicating the other users' geographic areas and number of l-modules the other users have completed), and finds other users who want to practice a language within the same geographic area (defined by the radius the first user gave), who also indicated they are interested in practicing the study language, and who have started and who have completed a similar number of l-modules in the study language as the first user. A “similar number” can be defined in various ways in different embodiments, and in some embodiments, a “similar number” can mean that the difference between the number of l-modules started or completed by the first user and the other users, respectively, is less than a certain number, such as less than five. The interpersonal matching module informs the first user of the other users, and a way to contact them, and gives the first user an option to contact them. In some embodiments, this contact may be via a form of instant messaging or texting exchanged through the interpersonal matching module, or through interfacing with an “app” that has such capability.

The users/students who want to be members of the group for practicing the study language then can create a group which is a cohort, and save the cohort in the cohort statistical engine. Some, or preferably all, of the users in the cohort will opt to allow the cohort statistical engine to incorporate their monitored measurements into statistical calculations related to the cohort. In some embodiments, these users can do this using their interpersonal matching modules, and each user's interpersonal matching module will send their choice to the user's ICR. The cohort statistical engine (18) then gets the relevant data from the ICRs of those users who have opted to allow the cohort statistical engine to incorporate their monitored measurements. The cohort statistical engine (18) analyzes those users' work on l-modules (16) for the study language to date. The cohort statistical engine (18) finds the averages and standard deviations for one or more of the monitored measurements, for the cohort, based on those users' monitored measurements, and, if any of the cohort members desires, the cohort statistical engine sends these averages and standard deviations to the cohort achievement display for the cohort members to view. In some embodiments, summary statistics of the cohort's monitored measurements, will be presented, instead of the raw numbers. This will better protect members' information. The cohort members can then examine this information. In some embodiments, the cohort statistical engine (18) will also be capable of doing cohort computations for the cohort and sending the results to the cohort achievement display (19) for the cohort members to view. In some embodiments the cohort statistical engine (18) will be capable of creating graphs relating to the cohort, including graphs of distributions and density plots of monitored measurements for the cohort and graphs of the cohort's cohort computation results. The cohort statistical engine can send these to the cohort achievement display for presenting to users. In some embodiments, the cohort members can access the cohort achievement display (19) through their individual interfaces to view the above information. The users' interpersonal matching modules use their display devices' wireless or other communication capabilities to communicate with each other and let each other know of their presence. The users then can arrange to meet and practice the study language, or can practice it together in some form, such as via online chat or messenger, or can solve a “group” problem together.

The group leader module (24) is a software module that shows the information about group members that a group leader such as a facilitator needs, to run a group effectively for its members. This information would generally include some or all of the group members' demographic information (such as their contact information), some or all of group members' monitored measurements, and some or all cohort computations for the group, if a cohort has been created out of the group members. Other versions of the group leader module with additional capabilities can be used by instructors to help users learn a study language. The group members can opt to release some or all of their demographic information to the group leader, for use in cohort computations or to help the group leader manage the group.

A person can be an instructor for one group and facilitator for another group. The group leader module will allow the person to use the appropriate capabilities for leading each group.

A display device (2) is a personal computing device, as known in the prior art, which can be a personal computer, a smartphone, or another type of computing device.

The exporting module (7) is a module that can convert information other software components of the invention, including, but not limited to, the charting module, individual tracking module, interpersonal matching module, cohort statistical engine, cohort achievement display, users' ICRs, projection module, and individual statistical module, create, into formats other programs can use, like Excel, Adobe, and Matlab formats.

The visual effects database is a database of visual effects that can be added to explanatory material and/or problems and answers, written in a study language, at a user's request. In some embodiments, the problem generator (14) will add visual effects to problems and answers, which are then transmitted to the i-interface, when desired, and the l-modules will add visual effects to explanatory material, which then transmitted to the i-interface. A “visual effect” is a visual cue that appears on the display device's (2) screen together with a defined combination of specific words, parts of words, combinations of words, word-types, words in specific word categories, or word-forms (The “designated parts”), and appears in one of the three visual effect scenarios: a) Explanatory material, written in a specific study language, when the explanatory material appears on the display device's screen, b) Parts of language problems, written in a specific study language, when they appear on the display device's screen, and/or c) Parts of the user's answers to language problems, written in a specific study language, when the answer part(s) are entered into the display device. A user can choose for the visual effect rule to only apply in one or two of the visual effect scenarios. The visual effects would be specific to an individual user, and would only appear on the display device's screen when the specific user that requested the visual effect is using the i-interface. In most embodiments, the specific user using the i-interface will be tracked via which user has used their identifier to access the i-interface. The problem generator (14) and/or l-modules will cause each visual effect to appear on the screen in accordance with a certain rule (a “visual effect rule”), wherein the visual effect will appear on the display device's screen when the “designated parts” appear on the screen in one of visual effect scenarios a-c. The “visual effect rule” will define the conditions that must be fulfilled for the visual effect to be applied. The visual effect rules will be available, possibly with representations of the visual effects themselves, in the visual effects database for the user to view. After a user uses the individual interface (1) to access the visual effects database and “enable” a visual effect, in one of visual effect scenarios a-c, the visual effects database will send a signal to the problem generator (14) or the l-module the user is using, to execute the relevant visual effect rule, in the user's desired visual effect scenarios, causing the desired visual effect to appear on the screen when a piece of explanatory material, language problem, or answer to a language problem written in the study language includes the designated parts. The visual effects database will also send a signal to the individual tracking module that the user has enabled the visual effect, and that the individual tracking module should note this in the user's ICR and start tracking the user's percentage of problems answered correctly, active time per problem of each pr-type, completion time for each l-module, and CTOT and other monitored measurements that take into account use of the visual effect separately, so that the user can later view and use these statistics. The individual tracking module will also check the user's ICR for any visual effects the user has enabled in visual effect scenario a, and command any language module (16) that the user uses to apply these visual effect rules. In some embodiments, the user can create some visual effect rules. For example, the user can select a visual effect from those in the visual effect database, and then input into the visual effect database a customized visual effect rule stating when the user wants the visual effect to be executed.

An example of a visual effect rule is that when a noun's plural is used, a box appears around those letters in the noun that are in common between the noun's singular form and the noun's plural part. The visual effect is a box around the part of a noun that does not change when the noun becomes plural, and the visual effect rule is that when a plural noun appears, a box also appears around the part of the noun that does not change when the noun becomes plural.

Another example of a visual effect rule is that when a word's definition in the study language in the L2L dictionary (17) has one word in the base language, which is a direct translation of the study language word, and the problem generator (14) creates a translation problem, which is sent to the individual interface (1) an arrow will appear between the study language word and the direct translation of that word in the base language when they both appear on the display device's screen, either because the user entered one of them in an answer or for another reason. The visual effect here is, in translation problems, an arrow between each base language word, and the study language word with the same meaning.

Other visual effects can also be in the visual effects database. As many kinds of visual effects are possible as can be created. In some embodiments, the visual effects database can also be “updated” gradually to include more visual effects over time. Use of visual effects is a method of using visual stimuli to reinforce learning. The main reasons for including, in problems, visual effects, when the user can enable or disable application of a visual effect, are that A. This method helps users to remember l-module material and study language material better, through creating visualizations in familiar and easy-to-spot patterns, and B. This method will encourage users to practice study languages more. C. Users may learn more about the study language and its structure when deciding which visual effects to enable. D. The visual effects are a form of preattentive attributes that help users learn.

Once the user uses the individual interface to “enable” use of a visual effect, in a study language, the problem generator and/or l-modules will continue applying the visual effect rule and placing the visual effect in the places the visual effect rule requires, until the user uses the individual interface (1) to contact the visual effect database and use it to disable the visual effect. When the user disables the visual effect, the user uses the individual interface (1) to access the visual effects database and cause it to send a message to the problem generator to stop applying the visual effect rule, if the visual effect rule was applied to problems or answers. The visual effects database will also send a message to the individual tracking module to note that the visual effect was disabled in the user's ICR and to stop tracking the user's percentage of problems answered correctly, active time per problem of each pr-type, completion time for each l-module, and CTOT and any other monitored measurements being tracked separately after the visual effect's enablement. The individual tracking module will also stop sending commands to l-modules to apply the visual effect to explanatory material, and will command any l-module the user is presently using to stop applying the visual effect to explanatory material.

The individual tracking module will track the user's percentage of problems answered correctly, active time per problem of each pr-type, completion time for each l-module, and CTOT and other monitored measurements for the time that each visual effect is being used. The individual tracking module will save all this information in the user's ICR, so the user can review it, analyze it using the invention's other components, and see if the visual effect's use correlated with any noticeable change, and to learn if the visual effect's use impacted the user.

Some examples of visual effects are: i. Increasing the size of part or all of a study language word in a problem, relative to the rest of the study language words in the same problem. ii. Presenting parts of an example passage in different fonts. iii. Increasing the font size of a part of a word, when the i-interface presents the word. iv. Placing a shape around a problem when the i-interface displays the problem. v. Having a picture in place of a word, when the i-interface displays the picture as part of an example passage, example word, problem or answer. vi. The i-interface displaying certain words with a sparkling animation effect. vii. Arrows pointing between words, from a study language word in one sentence to a translation of that word into the base language in another sentence by comparing words in the L2L dictionary and drawing arrows in between them. viii. Displaying some words in bold, italics, or underlined.

Examples of visual effect rules are: i. Study language verbs in the future tense will be displayed with a sparkling animation effect. ii. Words in a certain word category, in problems, will be displayed in a font size 1.5 times the size of other words in problems.

In some embodiments, the user can cause the visual effect database to command the i-interface directly to apply visual effect rules, and to stop applying them, in any of visual effect scenarios a-c.

The L2L dictionary (17) is a software component that includes records of translations of individual words between multiple languages. For example, the L2L dictionary will include the word “house” in English, its translation as “casa” in Spanish, and the same word's translations in multiple other languages. The L2L dictionary (17) will include translations of as many words as can be included in the L2L dictionary, and translations of each word between as many study languages as can be included in the L2L dictionary. The entries for the words will be searchable, by word, so that a user can input the version of the word, in a language, into the L2L dictionary, and the L2L dictionary will send translations of that word into one or more other languages to the individual interface, which will display the translations on the display device's screen. The L2L dictionary will also return the language of each displayed translation of the word, that the L2L dictionary sends to the individual interface. The individual interface will display the translations sent to it by the L2L dictionary on the display device's screen.

In some embodiments, the L2L dictionary will be programmed that if the user queries the L2L dictionary about what the user thinks is a word, the L2L dictionary will return every word that matches what the user inputted, in every study language, and translations of these words, along with the language of which each translation is part, and the L2L dictionary will send these words and the language of which each word is part, to the individual interface, which will display the words and languages using the display device's screen.

In other embodiments, the L2L dictionary will be programmed to instead return only words matching what the user inputted, and translations thereof, in the study language, base language, or both, along with the language of which each translation is part. The L2L dictionary will send these words to the individual interface, which will present them using the display device's screen.

In some embodiments, the L2L dictionary will return only the translations into the base and study language of the word about which the user sent a query to the L2L dictionary, along with the language of which each translation is part. The translation of the word into the base language, and possibly the base language's identity might be presented first, and then the translation of the word into the study language, and possibly the study language's identity. Alternatively, the translations might be presented in the opposite order. The L2L dictionary will send these words and languages to the individual interface, which will present them in the selected order using the display device's screen.

In some embodiments, the L2L dictionary will only search for translations of the word the user inputted from the base language into the study language, or vice versa. Then the L2L dictionary will return only the translation, if any, for which the L2L dictionary searched, and the language to which that translation applies. The L2L dictionary will send this word and language to the individual interface, which will present them using the display device's screen.

In some embodiments, the L2L dictionary will return translations of the inputted word user from the base language, study language, or both, to every other language for which a translation is available. The L2L dictionary will send the translations and the languages to which they apply to the individual interface, which will present them using the display device's screen.

In some embodiments, the user will also have the option of hearing spoken recordings of some or all of the translations of the word(s) that the L2L dictionary returned.

The L2L dictionary (17) connects to the individual interface (1) and the user will be able to access the L2L dictionary (17) through the individual interface (1), and send queries about what the user believes to be words into the L2L dictionary (17), and the L2L dictionary (17) will then search for translations of these words, in some embodiments. In some embodiments, the user can access the L2L dictionary (17) in other ways. In some embodiments, the user can access the L2L dictionary (17) through the individual interface (1) while the user is doing problems based on one of the l-modules (16)'s material.

In some embodiments, whenever the user selects a base language and study language, the individual interface (1) will communicate the base language and study language's identities to the L2L dictionary (17). The L2L dictionary (17) will then find each word in either the base language or study language, and the corresponding word in the other of the base language or study language. Then, when a user uses the individual interface (1) to look in the L2L dictionary, the L2L dictionary will show words in the user's current study language and translations of the words into the user's current base language. In other embodiments, whenever the user accesses the L2L dictionary (17) through the individual interface (1), the individual interface (1) will communicate the identities of the user's current base language and study language to the L2L dictionary (17), and the L2L dictionary (17) will then find each word in one of the base language or study language, and the corresponding word in the other of the base language or study language. The L2L dictionary (17) will then show words in the user's current study language and the words' translations in the user's current base language.

One of the L2L dictionary's purposes is for users to improve their comprehension of a study language, by looking up words they don't know, while reading words and passages in the study language.

The words database (11) is different from the L2L dictionary, and one difference is that the L2L dictionary generally focuses on translations of the same word into different languages, while the words database generally provides data related to how a word fits within one study language, such as the word's “word-type” (noun, adjective, etc.) and word categories to which the word belongs. In principle, the words database could also include the information about words that is in the L2L dictionary, or vice versa.

The words database(s) for one or more study languages, in many embodiments, will be connected to the individual interface and the user can access these words databases from the individual interface. In some embodiments, the user can select which study language's words database the user wants to use. In some embodiments, the individual interface will only connect with the words database(s) after the user selects a study language, or at a later point, and in some embodiments only the study language's words database will connect to the individual interface.

The words database will include a searchable directory of words in the study language, so that the user can look up the entry for a study language word, in the words database. Once the user has looked up the entry for a study language word, the user may command the words database to present the next entry, the entry after that, etc. or the immediately previous entry, the entry before that, etc., or a certain number of entries, such as the next 5 entries, the 5 entries after that, etc., or previous 5 entries, 5 entries before that, etc. The words database will also allow a user to search the words database in other ways, in some embodiments.

In some embodiments, the words database will be organized in a certain way, for example, entries in the words database can be organized alphabetically in the words databases for study languages that use the Latin alphabet or another alphabet where the letters have a recognized order. In some embodiments, when the user accesses the words database for a study language from the individual interface, that words database's method of organization will be communicated from the words database, to the individual interface, which will present the method of organization on the display device's screen.

Use of every other method of storing and retrieving the entries in the words database known in the prior art is explicitly part of the present invention.

The words database (11) for a study language will include words in the study language, preferably a very large number of words in the study language. Most versions of the words database (11) also include the possibility for administrators (who may be curators) to add more words entries to the words database over time. This may be especially important for languages few people speak, such as some Native American languages. The more words are included in the words database, for a study language, as a general rule, the better. If there are 100,000 or more words in a study language, then having 100,000 or more words in a words database will be helpful. The type of word, or word-type (preposition, noun, verb, adverb, etc.) for each word should also be included as a datum for that word in the words database. Some languages have word-types that English does not have. A words database for a non-English language, that has word-types not present in English, would include the word-types that are present in the study language, but not in English, in the words database for that study language. The words database might also include “advancement levels” for the words, where an advancement level for a word will be assigned a numerical level for the perceived “difficulty” of that word for non-native speakers of the study language. In general, longer words would be assigned higher advancement levels. The words' “advancement levels” will be used in some embodiments to determine when the words should be presented to users in problems. The “advancement levels” of words a user acquires can also be tracked, as part of monitored measurement Q or other potential monitored measurements. A user can use monitored measurement Q to keep track of the advancement of the words the user acquires, so that the user can find whether they are learning “more advanced” words in the study language. Ideally, whether a word is considered “newly created”, and the period in which it was newly created, should also be a datum which is part of the entry for each word in the words database, but this is not necessary for some embodiments. It is necessary for certain more complex embodiments of the invention, as will be discussed below.

In some embodiments, the words database should also include translations for the words therein, into the user's study language and as many other languages as possible. In these embodiments, each word's entry into the words database should include the English translation for the word, and translations into other languages. In some embodiments, the words database should include definitions, expressed in the study language, for words in the words database, but this is not needed for some embodiments, but is needed for other more complex embodiments.

The words database can also include a w-category for each study language word, or for some study language words.

In some embodiments, a word can be a part of multiple word categories, two, three, or more, up to as many word categories as reasonably apply to the word. “Word categories” will be other data related to each word.

Many words might not have a specific w-category, or might reasonably be given a w-category of “general” or something equivalent. Words like “ir” in Spanish, which translates to “to go” in English, might be placed in a w-category of “general”.

In some embodiments, the word categories to which each study language word in the words database belongs could be designated through a series of “Yes-No” type indications, where each indication would be a datum showing whether or not the word belonged to a w-category, and each indication would be part of the entry for that word in the words database. The same word, for example, could relate to both “science” and “art”. There would be a “Yes-No” indication for whether the word relates to “science” another indication for whether the word relates to “art”, and other indications of whether the word relates to other word categories. Each indication would be a datum relating to the entry for the word in the words database.

In many embodiments, the decision of what category(s) to which a word relates will be somewhat arbitrary, and, in some embodiments, dependent on curators' decisions or on an artificial intelligence (AI) artificial neural network, which will use as input instances of when each word is used, and will group the inputted words into categories based on the artificial neural network's output.

In some versions of the words database, each type of datum pertaining to each word will be an entry in a “column” in the words database, with the word as the “key” for that column.

In some embodiments, the words database can also display each study language word in a certain color, which will be the words database's assigned color for that word's word-type. For example, in the words database for English, nouns would be displayed in one assigned color, pronouns displayed in another assigned color, etc.

The words database can also be updated as time goes on; For example, a words database for a study language may start with entries for 10,000 words, and then more words may be added later, so that the words database later has entries for 50,000 words, then entries for 100,000 words, etc. This may be necessary for some languages, because a complete list of a relatively obscure study language's words may not be available when the words database for that study language is created. A complete list of even a widely spoken study language's words might not be entered into the words database (because of budget restrictions, time, or other reasons) when the study language's words database is created. The study language's words database, may start with a relatively small number of words and then have words added as time goes on. The study language's words database would become more effective as words are added thereto.

One of the words database's purposes is to help users fit information (words in a study language) into a pattern (How the words fit into the study language, including the words' word-types, word categories, whether the words are “new”, and other information about the words).

The individual statistical module (25) can be accessed via the i-interface. The individual statistical module performs statistical calculations for the user, helping the user to better understand variations in the user's monitored measurements, and use this knowledge to more effectively learn the study language. Some of the statistical calculations will be focused on the user's monitored measurements. For example, the individual statistical module can calculate monitored measurements, and averages, standard deviations, percentiles, and deciles for monitored measurements, and correlation coefficients, if any, between the monitored measurements.

The individual statistical module should also be able to calculate the quantities that the charting module graphs. In some embodiments, the individual statistical module can also compare the user's monitored measurements with “population averages” for the monitored measurements for all users.

The individual statistical module gets the user's historical data that is analyzed to create the monitored measurements from the user's ICR.

At the user's command, the individual statistical module can also send data to the charting module to be charted.

The grammar engine includes multiple, grammatically correct sentence formats for multiple study languages that each use sentences. Each sentence will each have a format that will be specified as a sequence of words of specific word-types, with one or more specific word-types appropriate for each place in the sentence. For clarity, each of the sentence's words can be referred to by its numbered place in the sentence. The sentence's first word will have place 1, and the second will have place 2, etc., and the word-type of each word in the sentence can be placed in parentheses in some representations of the sentence. Using these rules, one example of an English sentence structure would be represented as (Definite article) (noun)(verb)(adverb). This is a representation of a sentence where the word, in place 1, is a definite article, the word, in place 2, is a noun, the word, in place 3, is a verb, and the word, in place 4, is an adverb. Other sentence formats could be longer or shorter, or the same length, as the above example. Another example of a sentence format in English in the grammar engine, would be represented (noun)(adjective)(verb)(indefinite pronoun)(definite article)(noun-plural). Here, the word at place 6 has the additional word attribute of being “plural”. Within this application, a hyphen will indicate each additional word attribute for each of the words in a sentence the problem generator select.

For example, the grammar engine can have one hundred and fifty sentence structures in English, or more, or less. The problem generator can pick between these sentence structures, when generating problems, by picking randomly or using another method.

The word-type of the word that would go with each place in the sentence would be programmed into the grammar engine for each sentence structure in the first embodiment. For example, the sentence structure (noun)(adjective)(verb)(indefinite pronoun)(definite article)(noun-plural) would have a noun at place 1, a plural noun at place 2, etc.

In some embodiments, either randomly generated numbers or specific numbers will take up some of the places in some of the sentence structures in the grammar engine. For example, the sentence structure (noun)(adjective)(verb)(indefinite pronoun)(definite article)(random number)(noun-plural) would have a randomly created number in place 7.

### The Problem Generator

The first embodiment group and some other embodiments will use a problem generator. The problem generator will create problems of a variety of different pr-types, to force the user to think about the study language the user is learning in different ways, helping to strengthen the user's understanding of the study language, because if a user receives the same lesson in multiple formats, the user is more likely to understand at least one of the formats. Providing the user with language problems of many different pr-types, while monitoring how well the user answers problems of different pr-types, and making the results available to the user for review, will also help the user to learn more about how they can most effectively learn how to speak and use the study language, and help the user's word retention, though the user using words in different contexts. Many of the pr-types seek to put information into practice after it is learned, in accordance with the principle that putting information in practice immediately after it is learned is important, and helps with retention, and people tend to remember information that is immediately useful. The ability to control the probabilities of the problem generator generating different kinds of problems also helps the user increase their proficiency in parts of the study language where the user wants to increase proficiency. This capability also helps users trying to maintain their proficiency in a specific part of a study language during periods when the user cannot devote much time to learning the study language.

Problems that the problem generator creates will be sent to the individual interface (1) for display using the display device (2), and for the user to complete. When the user enters an answer into the display device (2), the individual interface running on the display device will send the answer the user entered to the problem generator.

One important aspect of the invention is that it presents the user with problems of different pr-types, and monitors multiple variables related to how the user answers problems of different pr-types, and then shows the monitoring's results to the user, so the user can understand how the user learns the study language and each student can be given more of the lesson types that work best for that student.

Every pr-type known in the prior art can explicitly be used as one of the pr-types in the present invention, and the problem and user's answer can be tracked in the way discussed above. Some of the pr-types which the problem generator can create, and can present to the user in some embodiments are below. They will be referred to herein a “Pr-type A”, Pr-type B”, etc. Later, herein, additional pr-types, that require additional components, will be discussed. The additional pr-types will be given letter designations cumulative to the letter designations of the pr-types in the below list. More pr-types are possible, besides those listed in this application. In some embodiments, the problem generator will select randomly between some or all of the pr-types below, when deciding on each problem to present to the user, with the pr-types having equal probability. In some embodiments, the problem generator will include a priority equation that gives greater probability of some pr-types being selected, and in some embodiments the user can alter these probabilities in the priority equation. In other embodiments, the problem generator will use another method to select the pr-type of each problem presented to the user. In some embodiments, the problem generator will select randomly between groups of problems of a certain pr-type to send to the individual interface, or will present to the user a fixed number of problems of each pr-type per l-module, or will have another method of deciding the pr-type of each problem it presents to the user. The pr-types below that involve the invention's components generating a sentence in the study language or base language can also be modified, for study languages and base languages, respectively, that do not use sentences, so that the same components can be used to create other kinds of phrases in those languages instead.

When a user is “presented” with a problem, the problem generator communicates the problem to the individual interface and commands the individual interface to use the display device to show or otherwise communicate the problem to the user, for the user to answer.

Not every pr-type may be available for some study languages, because not enough might be known about a study language for some pr-types to be practical for that study language. As a general rule, the more is known about a study language and the more words the study language has, that are entered into the words database, the larger the variety of problems and pr-types that the invention can provide to those wanting to learn that study language.

When a problem of any of the pr-types is presented to the user, and the user answers it, the individual tracking module will track the user's monitored measurements and how new information relevant to the monitored measurements, such as the problem and answer, affect the user's monitored measurements, and the individual tracking module will store the monitored measurements in the user's ICR. In each of the pr-types in most embodiments, if the user answers a problem wrong, one of the invention's components, such as the problem generator, will examine differences between the wrong answer and each right answer to the same problem, and will categorize the wrong answer into one or more of the e-types applicable to the study language on which the problem was focused. The problem generator will send the e-type, problem, and wrong and right answers to the user's ICR. An artificial neural network can also be used to categorize a user's errors into one or more e-types, with the user's errors as the artificial neural network's input.

Some of the possible pr-types that the problem generator will cause to be presented to the user are:

A. The l-module (16) the user is using will send the problem generator a list of study language grammar rules that the l-module is intended to teach the user, and the problem generator will pick one of these grammar rules. The problem generator will then find, in the grammar rules module, the grammar rule that it has picked, and find, in the words database, a word(s) of a word-type which the picked grammar rule affects. The problem generator may find the grammar rule by searching the study language's grammar rules in the grammar rules module, or may find the grammar rule through another method. In some embodiments, the problem generator will find whether the grammar rule “affects” the word-type by finding whether the name or other designation of the word's word-type is mentioned in the grammar rule. In some embodiments, the problem generator will match recognition codes attached to the l-module, which the l-module will have sent to the problem generator, with recognition codes attached to the grammar rule in the grammar rules module, and the word in the words database, respectively. In other embodiments the problem generator will use another method. The problem generator will create a problem instructing the user to apply the picked grammar rule to the picked word(s). The problem generator will then send the problem, the picked grammar rule and picked word(s), to the i-interface, and command the i-interface to present the problem using the display device, and the user will try to complete the problem by entering, into the display device, the form of the word, after the grammar rule has been applied to it. In some of these problems, the problem generator will also command the i-interface to display the grammar rule on the screen so the user can apply it more easily. In some, the problem will simply identify how the picked word(s) needs to be modified to comply with the grammar rule. The problem generator will also send these same picked words from the words database to the grammar rule module, which will apply the picked rule to the picked words and create answers, then send the answers to the problem generator. The problem generator will then compare the user's answers to the “correct” answers the grammar rules module created, and score the user's answers.

B. The same as (A), except for the following;

The grammar rules that the problem generator requests and receives from the l-module specifically relate to word-forms in the study language. The problem created will ask the user to apply the picked grammar rule to change the picked word(s) into different word forms of those picked words. The word-form the problem is requesting for each of the picked words will be specified in the problem. The picked word(s) will also be picked from the word-form module, and the word-form module will find the correct word-form for each picked word and send these correct word-forms to the problem generator. The problem generator will also send these same picked words from the words database to the grammar rule module, which will compare the user's answers to the correct answers from the word-form module and score the user's answers.

C. The problem generator presents the user with a sentence, with a missing word(s), the problem generator or the grammar rules module created. The user will have to enter the missing word(s) into the display device. The problem generator will then compare the user's answer(s) to the correct answer(s) created by the problem generator and components with which the problem generator has communicated, to see if the user has gotten the right answer.

The problem generator may create the sentence by contacting the grammar engine and selecting, randomly or through another method, a sentence structure from the grammar engine. In some embodiments, the problem generator will match a recognition code from the l-module to a recognition code for the sentence structure stored in the grammar engine. Then, the problem generator would contact the words database and select a word of the appropriate word-type for each place in the sentence (1^{st}, 2^{nd}, etc.). The problem generator, in some embodiments, would make sure that these words had recognition codes that matched recognition codes from the l-module. The problem generator can also contact the grammar rules module, and examine whether the created sentence violates any of the study language's grammar rules. If the created sentence violates a grammar rule concerning a word's proper word-form, the problem generator will learn this, and will contact the word-form module and get the correct word-form of the word from the word-form module, along with any attributes needed for that word to be correct, in the word-place where it will be located. The problem generator will then substitute that word-form for the word's word-form previously used in the sentence. If the sentence violates a grammar rule concerning something else, the problem generator will select new words for the sentence, of the same word-types as the sentence's previous words, from the words database, and will again interface with the grammar rules module and, if appropriate, the words database in the way described above. In embodiments using recognition codes, the problem generator will also ensure that the sentence's new words have recognition codes that match with the l-module's recognition codes. If the sentence violates no grammar rules, the problem generator will take word(s) out of the sentence and cause the sentence to be presented to the user. The problem generator can ensure that there is only one right word for every word-place in the sentence where a word is missing.

Another way the problem generator can create sentences is: The problem generator selects a word length for the sentence. The problem generator can select the length randomly from a series of possible lengths, or by using another method. The problem generator then randomly selects a word-type out of a list of word-types that can be used to start sentences in the study language. Then the problem generator selects a word of the previously selected word-type, from the words database. In embodiments with recognition codes, the problem generator will ensure that the first word has a recognition code that matches the recognition code of the l-module the user is using, and, when selecting each later word in the sentence, will ensure that this later word also has a recognition code that matches the recognition code of the l-module the user is using. This word will be in place 1 in the sentence. The problem generator then finds another word-type in the study language that can, according to the study language's grammar, come after the word-type of the word at place 1. The problem generator will then select a word, of the new selected word-type, for place 2 in the sentence, from the words database. The problem generator will then find another word-type in the study language that can, according to the study language's grammar, come after the word-types of all previous words in the sentence, and selects a word of that new word-type from the words database. The problem generator does this for each of the sentence's words until it reaches the word in the sentence's last word-place, and then it selects a word-type that can, according to the study language's grammar rules, be placed after the word-types of all the sentence's previous words and also can end the sentence. Then the problem generator selects a word of that word-type from the words database. The problem generator also contacts the grammar rules module and examines the sentence against all of the grammar rules in the grammar rules module, to make sure that the sentence does not violate any of the grammar rules. In some embodiments, after the words are selected, the problem generator can also contact the word-form module and ensure that the word-form of each word in the sentence matches the correct word-form for that word from the word-form module, with the correct attributes. If one or more words in the sentence do not, the problem generator can pick a new word-form for any such word, that is grammatically correct, given the other words in the sentence. The problem generator will take word(s) out of the sentence and send the sentence to i-interface, which will present the sentence to the user.

In some embodiments in the first group, once the problem generator picks a sentence structure, the problem generator “creates” the sentence by sending the sentence structure to the Grammar Rules Module. The Grammar Rules Module will select a word for each word-place in the sentence from the words database, and the word selected for each word-place in the sentence will be a word of the word-type the problem generator indicated for that place in the sentence. As described above, each word in the words database will have a datum indicating what type of word it is. For example, if place 1 in the sentence is supposed to contain a noun, the Grammar Rules Module will select a noun for place 1 in the sentence. If place 2 in the sentence is supposed to contain a noun, the Grammar Rules Module will select a noun for place 2 in the sentence. The grammar rules module also makes sure that the sentence's words are all expressed grammatically correctly, according to the study language's grammar, by examining whether the sentence and any words therein violate any grammar rules in the grammar rules database, and modifying a word if the grammar rule it violates relates to the word-form that word takes in the sentence. For example, if the word at place 3 in a sentence is supposed to be a verb in the future tense, then the Grammar Rules Module will contact the word-form database to find the future tense of that word, and then convert the verb taken from the words database at place 3 in the sentence, into the future tense of that verb, by doing the following: Using the grammar rules programmed into the Grammar Rules Module to find that the future tense needs to be selected, and then contacting the word-form database and finding the verb's future tense in the word-form database. If the word at place 5 is supposed to be a verb in the present participle, then the Grammar Rules Module will contact the word-form database to find the present participle of that word and convert the verb received from the words database at place 5 into the present participle of that verb in the same manner. The problem generator will then take word(s) out of the sentence and send the sentence, with words taken out, to the i-interface (1), which will display the sentence on the user's display device.

The problem generator can, using every method known in the prior art, ensure that there is only one “correct” word for each space with a missing word in each pr-type C problem presented to the user; A word that will be grammatically correct, according to the study language's rules, when placed in that space. One method, for use when the problem generator is using a sentence structure stored in the grammar rule module, is for the sentence structures stored in the grammar rule module to include designations of which words in each sentence using one of these sentence structures can be turned into blank spaces by the problem generator when the sentence is presented to the user in a problem. These words will have been predetermined to be in places in the sentence where only one word is grammatically possible. Another method, is for the only words to be removed from a sentence in a pr-type C problem to be words of word-types with small numbers of words, such as prepositions when English is the study language. English has below 100 prepositions, which is much less than the number of words in the noun, verb, or some other word-types. Then, the problem generator or grammar rules module (whichever is selecting the sentence's words) can query the words database for every word of a potentially removed word's word-type, and examine the study language grammar rules in the grammar rules database to find whether any grammar rules are broken if one of the other words of the potentially removed word's word-type is used in place of the selected word; essentially examining the sentence with another word of the potentially removed word's word-type, replacing the potentially removed word, and finding whether the sentence breaks any study language grammar rules, then taking the sentence with a second word in the potentially removed word's word-type, etc. until the problem generator or grammar rules module has cycled through all the study language words of the potentially removed word's word-type. Then, the component selecting the sentences words will not present the sentence to the user, but will select new words for the sentence if, when any other word of the potentially removed word's word-type replaces the potentially removed word, the sentence breaks no grammar rules. Another way is for the problem generator or grammar rules module to only remove words from sentences in very limited, defined, situations, where the word-types and relative placement of the sentence's other words ensure that there is only one grammatically correct word for a potentially removed word's word-place.

The problem generator can also incorporate an AI (Artificial intelligence) system, which would create sentences that each use one or more of a series of grammar rules and/or words the l-module sent to the problem generator. The AI system would then take word(s) out of the sentence. The problem generator would then present the sentences, with words missing, to the user, as problems of pr-type C.

The problem generator, in various embodiments, can use every other method of generating sentences known in the prior art.

The problem generator could also use multiple methods of creating sentences, and switch between the methods.

A sentence in a study language, would be composed of the word-types applicable to that study language, with attributes applicable to that study language. For example, all the nouns in a sentence in Spanish would have the word attributes of “masculine” or “feminine”.

One goal is for the problems the i-interface presents to only include sentences that conform to the grammar rules of the study language the user is trying to learn.

The sentence structures for sentences in each study language, that the i-interface presents, should obey that study language's rules.

In some embodiments, the text of one or more of the grammar rules applying to the sentence will also be shown on the display device when the sentence, with word(s) missing, will be shown on the display device.

D. Problems similar to those in pr-type C, and created using one of the methods discussed for pr-type C, but where more than one solution for each missing word in the sentence can exist, and the problem generator will accept more than one possible solution for each space with a missing word, as long as the sentence the user inputted is grammatically correct and has words inputted for all of the missing spaces. Therefore the problem generator and other components will make no attempt to ensure that there is only one right answer for each missing space. In pr-type D problems, the problem generator causes presentation of a sentence), to the user, that the problem generator or the grammar rules module created, with a missing word(s). The user will have to enter the missing word(s) into the display device. After the user enters words for the sentence's missing word-places into the display device, the i-interface will send the completed sentence to the problem generator, which will then contact the grammar rules module, and see if the sentence, with the additional words the user has put into the sentence, violates any grammar rules. If it does not, the problem generator will mark the problem right.

E. The problem generator sends a study language word to the i-interface for display, and the user must enter into the display device a translation of the word into the base language. In some embodiments, the problem generator can then contact the L2L dictionary and compare the translation the user supplied to the translation in the L2L dictionary to ensure the translation is correct.

F. The problem generator sends a word in the base language to the i-interface for presenting, and the user must enter into the display device a translation of the word into the study language. In some embodiments, the problem generator can then contact the L2L dictionary and compare the translation the user supplied to the translation in the L2L dictionary to make sure the translation is correct.

G. The user is presented with information in the study language and then an arithmetic problem to solve, based on that information. Pr-type G is based on the idea that the user will not be able to solve the arithmetic problem unless the user understands the information.

H. The user is presented with a sentence or other passage from the study language to translate to the base language, or a sentence or other passage from the base language to translate to the study language. In higher-difficulty l-modules, the user must translate a longer passage, such as an essay.

I. The user is presented with a group of words in the base language and a group of words in the study language, and the user must draw a line, on the screen, between each study language word and its translation in the base language.

J. The user is presented with a picture and the user must enter the study language word that correctly describes the picture into the display device, or alternatively a study language word is shown to the user and the user has to select a picture that matches the word.

K. The user is presented with one study language word, as a “hub” in a wheel displayed on the screen, with multiple “spokes” going to other study language words. The user must select a second study language word that can correctly be placed after the first study language word, and which includes all grammatically required modifications, according to the study language's grammar rules. More complex versions of these problems would include spokes going from the selected second study language word to other study language words, where the user would have to pick one of the other study language words that can correctly be placed after the first and second study language words, according to the study language's grammar rules. Other problems might include spokes going from a third study language word to other study language words, so the user can select a fourth study language word that can correctly be placed after the first, second, and third, etc.

L. The user is presented with a part of the grammar network map, for the study language, and the user must create a sentence in the study language by picking an edge leading from the first study language word (which could be either picked by the user or picked as part of the problem), which will be in the part of the grammar network map shown to the user, to a second study language word, that could follow the first study language word under the study language's grammar rules. Then, the user would pick an edge leading from the second word to a third word that could follow the first and second words under the study language's grammar rules, and continue picking edges that link to words that could each follow all previous rules in the sentence, until the sentence is complete. In some embodiments, the problem could be designed so that the problem requires the sentence to have a certain required word length. When the user has selected the words in the sentence, the problem generator will then ensure that the sentence is grammatically correct. One way for the problem generator to do this is by examining the sentence against each of the study language grammar rules in the grammar rules module and finding whether the sentence the user created violates any of these grammar rules or includes other errors. If it includes other errors than the e-type of each of these errors will be recorded.

M. The user is presented with a question, and the user will, in response, enter into the display device a sentence where the user begins by picking a word from among multiple possible choices, and then, depending on which word the user chose, the user will be presented with other possible choices for the next word, etc. until the user has created a complete sentence. In most embodiments, the user will also be given the choice to end the sentence after each word is entered. The complete sentence will be sent to the problem generator, which will query the grammar rules module and examine the complete sentence against each of the grammar rules, to find whether the sentence violates any grammar rules in the study language, and if the sentence is not correct, what errors the user made. In a variation of these questions, the user will then be asked another question depending on how the user answered the first question.

O. Problems where the user must repeat, or otherwise enter into the display device, a study language word which the user has been presented, and also enter into the display device a translation of the word from the study language into the base language.

P. The user is presented with a question, in the study language or base language, and the user will have to enter a multi-word answer in the study language into the display device (2), or where the question was given in the study language but the user has to enter the multi-word answer using the base language.

Q. The user is presented with a passage, with words missing. The user will fill in the missing words, to answer the problem correctly. These types of problems will be more common in problems based on higher-difficulty-level l-modules. In general, the higher the l-module's difficulty level, the longer the passage with which the user is presented will be, and the portion of words that are missing will not go down. In some embodiments, the user will only be required to place grammatically correct words in the word-places with missing words. In some embodiments, the problem generator will examine the passage with the words inputted by the user against all the study language's grammar rules in the grammar rules database, to make sure that the passage is grammatically correct, and, when scoring the answer, will account for any errors the user makes.

R. The user is presented with a phonetic description of a study language word, and the user has to enter the study language word, into the i-interface.

S. Another way of using a node-and-edge system, in problems, would be as follows: The user would be asked to form a sentence, in the study language, with a specific structure in terms of the word-type of the word at each word position in the sentence. The user would be given a series of study language words, and instructed to pick one to start the sentence. The picked word would be placed at position 1 in the sentence and shown as a node. Then the user would be given a group of other words, and instructed to pick one for position 2. Some of these would be grammatically correct, but not be part of the desired sentence structure. Others would be grammatically correct, and would be part of the desired sentence structure. Some might not be grammatically correct or part of the desired sentences structure. The user will pick one of these words, and the second word would be shown as another node. An edge will be shown between the two nodes. Then a group of other words for position 3 will be presented to the user. Some of these would be grammatically correct, but not be part of the desired sentence structure. Others would be grammatically correct, and would be part of the desired sentence structure. Some might not be grammatically correct or part of the desired sentences structure. The user will pick one of these, and will keep picking words in the same manner until the user reaches the number of words in the sentence structure. This problem will not be marked correct unless the structure of the sentence the user has created matches the desired sentence structure. In some embodiments, the user will be able to change the order of words, and pick other words, if the user's sentence has the wrong structure.

T. Problems of one of pr-types A-S, and U-Y, but where the user must speak the user's response(s) to enter it in the display device. These problems could be broken down further, into pr-type T1 for a version of pr-type A where the user must speak the response, pr-type T2 for a version of pr-type B where the user can speak the response, etc. For versions of pr-types L and S, where the user must speak the response, the user may speak a designation of which edges to use, or may speak the word(s) to which those edges connect. Pr-type T is useful because, among other reasons, the user, when examining the user's monitored measurements and charts derived therefrom, will be able to more easily examine the user's performance on problems where the user had to speak the answer versus entering the answer another way. If Pr-type T is broken down into subtypes such as T1, T2, etc., the user can examine the user's relative performance on these subtypes and performance relative to the user's performance on pr-type A, pr-type B, etc.

In some variations of Pr-type T, including T1, T2, etc., the words that a user speaks in answer to a problem will appear on the display device's screen as the user speaks them, so that the user can check to make sure the words appearing on the screen are what the user said.

U. The user is presented with a word in the study language, and the user must find an object of the type the word named, take a picture of the object, and upload the picture into the i-interface. The problem generator will then examine the picture and mark it correct if the picture is of an object that the word names. For example, if the study language word means “table”, the user may find a table, take a picture of it, and upload the picture to the i-interface, possibly using the display device.

V. The user is presented with a collection of words in the study language, some of which are not in the “infinitive” and the user must form a sentence in the study language out of those words. The problem generator will then examine the sentence against each of the study language's grammar rules in the grammar rules module, and detecting whether the sentence violates any of them. The problem generator will mark the answer correct if it does not violate any of these study language grammar rules.

X. The user is presented with a passage in the study language to read, and then the user is asked questions about the passage, in either the study language or base language, or alternatively, given a passage in the base language to read, and asked questions about the passage in the study language.

Y. The user is presented with a picture with multiple objects in it, and the user has to identify the correct name for one of the objects in the study language. In embodiments involving pr-type Y, the problem generator will have access to pictures of a large number of objects, and will be able to combine these pictures in a larger picture, before sending the larger picture to the i-interface for presentation to the user.

In some embodiments, for some problems, including problems of some of the pr-types described above, such as pr-types D, H, L, M, P, Q, and some variations of pr-types R and T, there will be more than one right possible answer to some parts of the problem, where the user can enter one of the right answers to each part of the problem into the display device, and be presented with a picture or short video at the end, such as a video of cats or dogs. In some embodiments, the user can choose which answers to give. Then, the problem generator will determine which of multiple possible videos or pictures the user will see, based on, first, which right answers the user entered, and second, which l-module the problems the user answered were based on. The problem generator, in these embodiments, will have access to a plurality of videos, and can pick one to transmit to the i-interface, which will show the user the video.

In most embodiments, the problem generator will also include a series of equations that govern various things about the user's experience such as the probabilities of problems of certain pr-types being created, and the probabilities of problems with certain characteristics being created. These equations are some of the “priority equations”. These priority equations contain parts that the user can modify, and in many embodiments the user will be able to access the problem generator through the i-interface to monitor these parts of the priority equations. The user can modify these parts of the priority equations so that the problem generator creates more problems for a user that fulfill that particular user's needs, which means that the invention will be better able to help the user learn the study language.

Nonexclusive examples of priority equations are:

Priority equation 1 is the equation governing the range in which falls the percentage of the words, not previously acquired by the user, in a study language, in problems that l-modules (16) send to the i-interface for the user to complete. For each l-module lm, this percentage is called PNWₗₘ herein, and the desired range in which PNWₗₘ falls is called RPNWₗₘ herein. Priority equation 1 can be structured using any method known in the prior art, including the below method. The terms that the user can modify include the upper and lower bounds of the percentage of words not previously acquired by the user (URPNWₗₘ and LRPNWₗₘ), and the “priority equation 1 lookback number” (PR1(LNU)) in the current problem and “PR1 lookback problems”, which is the number of past problems considered when finding whether the percentage of not previously acquired words in past problems based on l-module lm that falls within the range from URPNWₗₘ to LRPNWₗₘ.

These terms apply to the below method, for problems based on each specific l-module. No. study language words in present problem=WP₀ₗₘ. No. not previously acquired study language words in present problem=SW₀ₗₘ.

No. of study language words in each past problem for l-module lm during the lookback period is WP₁ₗₘ for the number of study language words in the first problem before the present problem, WP₂ₗₘ for the number of study language words in the second problem before the present problem, etc., up until WP_{(PR1)LNUlm} for the PR1(LNU)th problem before the present problem, where the lookback period has PR1(LNU) problems. WPₜₒₜₐₗₗₘ is the total number of study language words in all lookback problems.

No. not previously acquired study language words in each past problem during lookback period: SW₁ for no. not previously acquired study language words in first problem before the present problem, SW₂ for no. not previously acquired study language words in second problem before the present problem, etc., up until SW_{PR1(LNU)} for the PR1(LNU)th problem before the present problem, where the lookback period has PR1(LNU) problems. SWₜₒₜₐₗ is the total number of not previously acquired study language words in all lookback problems.

“Priority equation 1 lookback number”, or “PR1(LNU)”: Number of past problems that are considered to decide whether the percentage of newly acquired words in previous problems falls within a desired range.

“Priority equation 1 Lookback problems”, or “PR1(LNU) problems”: Problems within the lookback range.
Upper bound of range of RPNW=URPNW. Lower bound of RPNW=LRPNW.

PNWₗₘ=1−((SW₀+SWₜₒₜₐₗₗₘ)/(WP₀+WPₜₒₜₐₗₗₘ).

Priority equation 1 is: If PNWₗₘ>URPNWₗₘ or PNWₗₘ<LRPNWₗₘ then the invention's component that created the current problem will create a new problem of same pr-type as the current problem.

In some embodiments the user will be able to also control URPNW, LRPNW, and the priority equation 1 lookback number, and cause PNW to be calculated, using a problem range including problems based on multiple l-modules, for a study language. For example, the user can control URPNW, LRPNW and the PR1(LNU) number using a problem range including problems based on all the l-modules the user has started, for a study language. Then, for example, if the user has made the lookback period 100 problems, but the user has not completed 100 problems for the l-module which the user is presently using, the problem generator will look back at the last 100 problems that the user completed, related to that l-module and any l-module the user has started, for the study language.

2. Priority equation 2 governs the probabilities that study language words of specific word types, that a) Are in a specific w-category,

b) Appear in problems based on a specific l-module(s) (16) c) Are not previously acquired by the user, are placed at defined places in problems of certain pr-types presented to the user. Priority equation 2 can be especially, used, with problems of pr-types C, D, H, and I, and V, but could also be potentially used with problems of other pr-types. Priority equation 2 can be constructed in any way known in the prior art. One way priority equation 2 can be constructed is below.

Ordinarily, in most embodiments, a word's w-category will not factor into whether the word appears in a problem. In some embodiments the user can use priority equation 2 to make the word's w-category a factor in whether the word appears in problems of certain pr-types, and choose the percentage of words belonging to each w-category appearing in certain word-places in those problems based on a specific l-module.

Priority equation 2 is explained here: WCANₜₒₜₐₗ represents all words of word-type N. The number of words of w-category 1 in word-type N is WCAN₁, the number of words of w-category 2 is WCAN₂, etc. Some other pr-types, like pr-type V, include study language words of multiple word types. Some sentence structures in problems, such as some of those in the grammar engine, and sentences presented to the user in some problems of pr-types like pr-types C and D, H, and I, will include words of specific word-types at specific word places in the sentences. The percent chance, of a word of word-type N in word category X being selected for one of those word-places shall be called HNₓ. WCANₓ/WCANₜₒₜₐₗ is HNₓ unless the user chooses to modify HNₓ. The user can use priority equation 2 to modify HN₁ for WCAN₁, HN₂ for WCAN₂, etc. Priority equation 2 says that for all word categories N₁, N₂, etc., A) The user can command the problem generator to consider HN₁, HN₂, etc. when deciding which words to put in the aforementioned word-places, and B) The user can select HN₁, HN₂, etc.

The sentences problems the problem generator creates, will be examined against the study language's grammar rules in the grammar rules module, to ensure that these sentences are grammatically correct.

In some embodiments, the user will be able to further select multiple different HN₁s, applied to different subcategories of word category 1, multiple different HN₂s, when applied to different subcategories of word category 2, etc.

Priority equation 2 helps the user to get more practice with word categories where the user feels they need to get more practice. 3. Priority equation 3 governs the probability of the problem generator selecting the pr-type of each problem presented to the user. The user could alter the “default” probability of each pr-type being selected, to give higher probability to those pr-types that help the user learn the study language more efficiently, or for other reasons. The user could theoretically give one pr-type a 100% chance of being selected. Priority equation 3 can be constructed in any way known in the prior art. One way priority equation 3 can be constructed is below.

The user may decide to select one, or a few, pr-types to emphasize once the user has information about which pr-types, when used, lead to best results for the user, in terms of words recalled on review tests, etc.

In embodiments using priority equation 3, each pr-type available for each l-module will have a “default” probability of being selected by the problem generator. If there are N pr-types available, the probability of the problem generator selecting pr-type 1 is defined as A₁, the probability of the problem generator selecting pr-type 2 is defined as A₂, etc., until the probability of the problem generator selecting pr-type N is Aₙ. A₁+A₂+ . . . +Aₙ=100%. Priority equation 3 includes the probabilities A₁, A₂,+ . . . Aₙ and allows the user to modify one or more of these probabilities, while fixing the total at 100%. For example, if 7 pr-types are available and the user wants to modify A₂ to 50%, then A₂ will be increased to 50%, but the probabilities of the other pr-types being chosen will decrease.

In some embodiments the user can “lock” some of probabilities A₁, A₂, etc. while modifying one or more of these probabilities, so that a change in the probability the user modifies causes no change in the probabilities the user locked, but does cause changes in the other probabilities that are not locked and that the user is not modifying, so the total stays 100%.

In some embodiments the user can modify the probability of the problem generator selecting each available pr-type, for each l-module. In some embodiments, the user can modify the probability of the problem generator selecting each available pr-type overall, for all l-modules for a study language as a group.

4. Priority equation 4 is an equation defining a user-defined maximum (called PR4MAX here) and/or user-defined minimum (called PR4MIN here) percentage of the words in problems of certain pr-types (Such as pr-types A-I, M-Q, and V), that each had more than a certain, user-defined frequency (Called PR4(FR) here) in a user-defined previous number of problems that test the same study language (the “priority equation 4 lookback number”, or “PR4(LNU)”), that the user completed. Priority equation 4 can be constructed in any way known in the prior art. One way priority equation 4 can be constructed is below.
In some embodiments, the user can define the priority equation 4 lookback number, PR4(LNU). The following will happen for each problem to which priority equation 4 applies: When a new problem is created, before the new problem is presented to the user, the problem generator will look through all the study language words in the current problem and the past PR4(LNU) problems, and find the percentage of words that appeared in the current problem plus the previous PR4(LNU) problems with a frequency greater than PR4(FR). Priority equation 4 says that if the percentage of such words is not between PR4(MAX) and PR4(MIN), the problem generator will cause a new problem to be created.

Priority equation 4's purpose is to help the user find the variety of study language words, in problems presented to the user, that is optimal for the individual user.

5. Priority equation 5 is an equation governing whether, and how much, the pr-types of those problems that the user got wrong influence the chance of the user being presented with a problem of a certain pr-type. Priority equation 5 can be constructed in any way known in the prior art. One way priority equation 5 can be constructed is below. In embodiments where priority equation 5 is present, the user can pick a modifier (“PR5MOD”). The user can first command the problem generator to consider the pr-types of problems the user got wrong in deciding the pr-types of future problems presented to the user. Priority equation 5 will then take the difference between the user's error rate on each pr-type being used and the user's total error rate on all pr-types, multiply this by PR5, and add the product to the original chance of a problem of that pr-type being selected as the next problem presented to the user. Then, the sums of the products plus the original chances for all pr-types are added together, and the combined sum is divided by the sum of the product plus the original chance for each pr-type to get the chance, that the problem generator will use, of selecting a pr-type for the next problem.

In some embodiments, priority equation 5 will also involve a lookback number of problems over which the user's error rate in each pr-type is calculated.

Priority equations 1-4 can also be further configured to account for use of projected words, in some embodiments. For example, in some embodiments, the priority equations can give projected words, or current projected words, a higher chance of being selected for inclusion in problems than other words.

In some embodiments, the priority equations can give words with recognition codes that match those of the l-module the user is using can be given a higher chance of being selected for inclusion in problems than other words.

In some embodiments, the priority equations can give words with certain advancement levels a higher chance of being selected for inclusion in problems, than other words. The priority equations can also limit this effect to problems based on certain language modules.

### Some Embodiments in the First Group of Embodiments

In one embodiment in the first group, the user selects an identifier, and uses it to access the i-interface, creates an ICR, and inputs some or all of the user's demographic information, the ICR requested, into the ICR. The user selects a base language and study language.

The user then selects which of the available l-modules that instructs learners of the study language by using the base language the user wants to use. The l-module sends explanatory material to the i-interface, which presents the explanatory material on a display device the user is using. The user examines the explanatory material from the l-module. The user may also view the L2L dictionary and words database for more information. The study language words in the explanatory material, and any study language words the user enters into the l-module, will be entered into the user's words record. The user's relevant monitored measured measurements are entered into the user's ICR to be later analyzed.

The user eventually starts doing problems based on the language module. The language module connects to the problem generator and sends the language module the grammar rules on which the language module focuses. The problem generator then picks a pr-type for a problem and creates that problem. Depending on the pr-type, the problem generator might select a sentence structure from the grammar engine and/or words for the problem from the words database. The problem generator sends the problem to the i-interface, which gives the problem to the user using the display device.

The user answers the problem and the individual interface transmits the answer to the problem generator, which marks the answer right or wrong and sends a notification of whether the answer was right or wrong to the individual interface, which will give the user the notification. Any study language words in the problem or answer that were not previously recorded in the user's words record will be recorded there. The individual tracking module will save the problem, and its pr-type, and a record of the rightness or wrongness of the answer, and other information important to the user's monitored measurements, in the user's ICR. The user can do this repeatedly for problems based on one language module, and can also use other language modules, observe the explanatory material therein, and answer problems based on those other language modules.

The user in this embodiment can also use the individual interface to connect with the problem generator, and command the problem generator to create a review test. The problem generator in this embodiment will create the review test based on the user's words record.

The user will also be able to use the individual interface to access the problem generator and use priority equation 3 to modify the chance of the problem generator generating a problem of any of the pr-types which it is able to create, for the user to solve.

The user will gradually create a record of the user's monitored measurements and how they were correlated, if at all, and other information about how the user learned the study language best. The user can also use the individual statistical module to analyze statistical patterns concerning the user's monitored measurements, and can use the charting module to create charts concerning the user's monitored measurements.

The user can also use the exporting module (7) to convert information in the user's ICR, such as records of the user's actions that were tracked to create the user's monitored measurements, into another format and/or export the information to other programs for analysis.

Some other embodiments in the first embodiment group are discussed below. The user, in many embodiments of the invention, will have the option of changing the base language the user uses while using the invention to study the study language. The base language's identity will be saved in the user's ICR.

In some embodiments the user can select the base language at an earlier point, including the point before selecting the identifier.

Many languages, such as Romance languages, have highly structured grammar, with different “tenses” for words, and other specific forms of words, to use in certain situations. The invention helps users to learn grammar rules. Users deserve to know how a language they are learning is structured, and also to expand their vocabularies, while doing so, if possible. Understanding how the language is structured will help the users to learn the language better because users learn better when they connect information to knowledge they already have.

Embodiments in the first group, and other embodiments, will also help users see the relationships between words in other ways. One way is through, in l-modules, using the grammar network map to show a language as a type of network diagram, with words as the “nodes” and the relationships between the words as “edges”.

In some embodiments in the first group, the invention will also have this capability: A language, such as Spanish, will be charted in terms of relationships between words, using the grammar network map, which will include a large number of Spanish words. An example is the word “ser” in Spanish. Words that can precede “ser”, in a grammatically correct Spanish sentence, will have edges going to “ser”, and words that “ser” can precede will have edges going from “ser” to those words. The grammar network map will be displayed for the user to see, when the user acquires a new word. The user will also be able to trace the “edges”, to see how many words are connected to “ser”. If the edges that link to “ser” are highlighted, and shown against the entire network, this will show the user that a large amount of the network connects to “ser”. This helps the user understand how some words are more “central” to a language than others, in that some words are used more than others. For example, in English, a large portion of the words used in speech are prepositions, and are “central” to the English language, and used more than other words. The number of edges going to and from words in the grammar network map is a preattentive attribute that helps the user learn.

If a user learning English is shown a visual representation of the relationships of other words in the database to “is”, for example, then this will help to impress upon the user that the word “is” can be used in a lot of ways, and help the user to remember the word “is” and how to use it. The word being inspected would be “is”, in this case.

In some embodiments, the user will be able to trace the words on the “other end” of each of the edges connected to the word being inspected. The user will be able to select one of those edges, and each word connected to that edge will be displayed. The user will therefore be able to expand his or her vocabulary and command of the language he or she is learning, by learning which words “go with” another, specific word, in a sentence.

In some embodiments, the user may be presented with a network view of the words in the grammar network map, where the words the user acquired will be highlighted, along with the edges leading from those words. This will help the user to understand where the words user acquired “fit in” to the overall language. This will help the user to learn more words, and how to use them, in the future. The highlights would be a “preattentive attribute”.

The invention will function whether all or less than all words in the study language are listed in the word-form module, words database, L2L dictionary, or grammar network map.

Some embodiments will involve one of the invention's components, such as the cohort statistical engine (18), doing the following: A. Taking a large corpus of documents, from a variety of sources, from a current time period, such as the current year, current month, etc. (The component will record the time period), written in a study language, and finding the words in the corpus that also appear in the words database for that study language. B. dividing the total number of instances in the corpus of each word that appears in the words database by the total number of instances in the corpus of all words of that word's word-type, to get a statistic (which will be called PRAA here) for each word appearing in both the corpus and words database. C. Causing the problem generator to apply PRAA as the problem generator's probability of picking that word as part of a problem, in instances when the problem generator has to pick a word of that word's word-type as part of the problem. The problem generator will still ensure that problems are grammatically correct.

Then, the next time period of the same kind (Next year, next month, etc.), the component will take a large corpus of documents, from a variety of sources, in the study language, and repeat the process, updating the PRAA of each word appearing in both the corpus and words database. The component will repeat this procedure each time period of that kind.

Some embodiments will involve the problem generator: A. Taking a corpus of documents, from carefully vetted sources, in a study language, and taking sentences or passages from those sources, and then taking words out of them, and They can be run through the rules in the grammar rules database. They can include specific grammar rules. Then sending them to the i-interface where they will be presented to the user as problems. The user must then select the right answers, and input them into the i-interface.

### Use of Visual Effects, and of Color, to Reinforce Users' Learning

Many users can learn better by using visual cues that are there to help them learn, so some embodiments will provide users with multiple types of visual cues to help them learn about the language(s) they are studying. Use of different colors to draw users' attention to different word-types, word-forms of word-types, and application of different grammar rules, described below, is a form of using preattentive attributes to help users learn.

Some embodiments in the first and other embodiment groups try to engage users' visual channels by having study language words of specific word-types, displayed, in specific colors, in problems, and to problems' answers that the user writes. In some of these embodiments, nouns would be in one color, verbs in another color, etc. In some of these embodiments, the color used for each word could be based on the word's word-type listed in the words database. The data for each word, in that word's listing in the words database would include a color (The “word-type color”) based on the word's word-type. The user will better remember the language's structure by engaging the user's channels that visually learn the colors. In some embodiments, not every study language word in the problems, and/or answers, and/or explanatory material, will have a word-type color because word-type colors will not have been assigned to all word-types.

In some of these embodiments, when the problem generator sends the i-interface a problem for presenting, the problem generator will find the words in the problem in the words database, and find the word-type color for each of the problem's words, and the problem generator will command the i-interface to display each of the problem's words, in the word's word-type color. Which color is used to display each word-type is somewhat irrelevant, as long as a color is used to display each word-type and the identity of the color used to display each word-type is known to the user.

In some embodiments, some or all of the study language words in the explanatory material can be displayed in the word-type colors of those words. The problem generator, the language module that includes the explanatory material, or another component can find the word-type colors for the explanatory material words in the explanatory material words' entries in the words database, and then cause words in the explanatory material to be displayed in the word-type colors for those words.

In some embodiments, some of the words that the user enters into the i-interface, in answers, will be given word-type colors. For example, the i-interface can send each word in an answer, as the user enters that word, to the problem generator. The problem generator will find the words in the answer in the words database, and find the word-type color for each of the answer's words that has a word-type color, and the problem generator will then command the i-interface to display the answer's word, in that word's word-type color. The user will also quickly see what are the word-types of the words the user is placing in the answer. This will also help the user learn the study language's word-types and which words belong to each word-type.

In some of these embodiments, the problem generator can create additional pr-types that use word-type colors to help the user learn the study language. The user's use of these pr-types will factor into the user's monitored measurements like the user's use of other pr-types factors into the user's monitored measurements. These can include, among other pr-types:

Z: The word-type colors representing word-types have been decided, and are made known to the user, and the user selects the correct word-type color for a study language word.

AA: The word-type colors representing word-types have been decided, and are made known to the user, and the user is given a word-type color and selects the correct study language word, of multiple available study language words, for a word-type color.

AB: The word-type colors representing word-types have been decided, and are made known to the user, and the user selects the correct word-type color for each of a group of study language words.

AC: Problems where the word-type colors representing word-types have been decided, and are made known to the user, and the user is asked a question, in the study language, and the user must pick the correct word-type color that the answer would have, when the answer itself is not shown.

The problem generator can verify whether the user's answer is correct in any way known in the prior art, including comparing the user's selected answer with any records of the appropriate word-type colors of words in the words database.

The words database or another component may include lists for the user to view of which word-type color represents each word-type.

Some embodiments that include pr-type T and pr-types Z, and/or AA, and/or AB, and/or AC, may also include variations of pr-type T that allow the user to speak the answer to any of pr-types, Z, and/or AA, and/or AB, and and/or AC, respectively.

In some embodiments, words can be displayed in more specific “word-type-form” colors can be used instead of word-type colors. A word's word-type-form color can be found as follows. Words in problems, and/or answers, and/or explanatory material will be displayed, in specific colors. Each word's word-type-form color will be based on, first, the word's word-type and second, the form of the word that is being displayed. The correct word-type-form color for each word can be determined in any way known in the prior art. One such way is for each word's entry in the words database to include a separate datum for a separate word-type-form color for each of the word's word-forms. The problem generator can then find which word-form of the word is displayed in each instance where any word-form of the word is displayed, and find the correct word-type-form color for that word-form of the word, in the word-type database. That instance of the word will then be displayed in the word's word-form-type color. Another method is for each word's entry in the words database to include the aforementioned separate datum for each of the word's separate word-type-form colors. Then the problem generator will find each displayed word's word-type in the words database, find that word's word-form in the word-form module, and then select the word's word-type-form color as the word-type-form color of the appropriate form of the word. Each word-form of each word will then be displayed in its word-type-form color.

The word-form database and/or words database, or another component, may include lists for a user to view. The lists would include which word-type-form color represents each word-form of each word-type.

For example, each verb tense in a study language can have its own word-type-form color. Here “verb” is the word-type and each tense of the verb is a word form. In the problem and any answer the user enters, the user will be able to quickly see the word-type and word-form of each word, from the color in which that word is displayed. The user will also quickly realize if one or more words in the answer have the wrong word-form. The user will learn visually, by seeing the colors, along with paying attention to the words on the screen, and the combination will be more effective than if the user were learning the words alone.

In these embodiments, additional pr-types are possible. The user's use of these pr-types will factor into the user's monitored measurements just as the user's use of other pr-types factors into the user's monitored measurements. Some of these pr-types are below. Pr-types AD, AE, AF, and AG assume that the word-type-form color that represents each word-form of each word-type represented by a word-type-form color has been decided, and the user has been made aware of any colors representing word-forms of word-types.

AD: Problems where the user selects the correct word-type-form color for a study language word that has been presented to the user.

AE: Problems where the user selects the correct study language word, of multiple available study language words, for a word-type-form color that has been presented to the user.

AF: Problems where the user selects the correct word-type-form color for each of a group of study language words that has been presented to the user.

AG: Problems where the user is asked a question, in the study language, and the user must pick the correct word-type-form color that the answer, or a specific word in the answer should have, when the answer and word themselves are not shown.

The problem generator can verify whether the user's answer is correct in any way known in the prior art, including comparing the user's selected answer with any answer in the words database and/or word-form module.

Some embodiments that include pr-type T and pr-types AD, and/or AE, and/or AF, and/or AG, may also include variations of pr-type T that allow the user to speak the answer to any of pr-types, AD, and/or AE, and/or AF, and and/or AG, respectively.

An example of pr-type AF is: The problem generator presents the user, an English speaker learning Spanish, with a Spanish sentence, missing a word. The user has been given a series of word-type-form colors that each corresponds to a different Spanish tense of the word. The user must then decide which of the word-type-form colors corresponds to the missing word's color, and select the correct word-type-form color from among the word-type-form colors available. In other words, the user will have to determine the missing word's tense and word type, which are used to find the word-type-form color in the example. For example, for “estar”, a word in Spanish, the words “estoy”, the first-person tense, and “estas”, the familiar second-person tense, will have different word-type-form colors.

In some embodiments, the i-interface can show how different grammar rules in the study language are applied to study language words. This capability can be utilized when a language module is explaining a study language grammar rule to the user, through the i-interface, and the l-module's explanatory material, including explanatory passages and/or example words, explains an example of the grammar rule through the i-interface. The words in the example passage that some different grammar rules affect will be shown in different colors, with words affected by each of these grammar rules shown in a unique color. Each color will indicate use of a specific grammar rule of the study language. These colors will be called “CSUSGR colors” herein for short. If the example used to illustrate the grammar rule is an example passage including multiple words, each word affected by a grammar rule, can be shown in a CSUSGR color specific to the grammar rule affecting it. A grammar rule “affects” a word if the word's spelling, appearance, or placement relative to other words is affected by the grammar rule.

For example, if one word in a sentence being used as an example is a verb in the future tense, then that word is an example of use of the future tense. If “blue” denotes the future tense in the study language, then the future tense verb will be colored blue when displayed. If the example is a paragraph or larger passage, each word in the future tense will be in blue.

Then, in later example passages and example words that language modules (16) for the same study language present to the user, the words affected by each grammar rule are shown in the same CSUSGR color, showing use of that grammar rule. For example, if “blue” indicates the future tense in the lesson on the future tense, and later on, a language module (16) is giving the user a lesson on the past tense, and the CSUSGR color “green” indicates the past tense, then if a verb with the future tense is also in one of the example passages about the past tense, the verb in the future tense will be shown in blue, while the verb in the past tense will be shown in green.

In some of these embodiments, each grammar rule a CSUSGR color represents is shown on the screen, in the same CSUSGR color as word(s) that grammar rule affects. The grammar rules may be explained in other ways, for example, a grammar rule may be spoken, using the display device's audio capability, while it is being shown onscreen.

In some of these embodiments, each word(s) a particular grammar rule affects in an example passage may be temporarily highlighted (while being displayed in the color appropriate to word(s) that particular grammar rule affects) and the grammar rule temporarily displayed on the screen, in addition to the word(s). Or, the word(s) in the example passage can be highlighted in succession, again while word(s) are displayed in the appropriate CSUSGR colors. While each word is highlighted, the grammar rule that affects that word is also shown on the display device (2)'s screen. When information is highlighted it is easier to see the information, therefore successively highlighting words and showing the grammar rules affecting those words will likely help a user to understand the grammar rules and how they affect the study language.

In some embodiments, in some or all problems presented to the user, and/or answers the user enters into the display device, study language words affected by each of these grammar rules will each appear in a CSUSGR color. In some of these embodiments, the grammar rules themselves may be displayed on the screen in the same CSUSGR colors as the study language words in the problems and/or answers these grammar rules affect. In some embodiments, study language words in the problems and/or answers may each be temporarily highlighted, and while each word is highlighted, the grammar rule affecting that word may be highlighted. The problem generator can track which grammar rule affects each word, and can command the i-interface to highlight words and grammar rules in the appropriate CSUSGR colors, through any method known in the prior art. One method through which the problem generator can track which grammar rule affects each word is through the steps of 1) The problem generator including a list of which CSUSGR color represents use of each grammar rule, and 2) The problem generator examining each of the explanatory passages and words and/or problems, and/or answers that have been entered (depending on which embodiment is being used) against all the grammar rules colors represent, and 3) The problem generator commanding the i-interface to display words in problems and/or answers in the CSUSGR colors. The language modules can also fulfill functions 1), 2), and 3) regarding explanatory passages, and explanatory words.

In some embodiments, the user will be able to view, in the grammar rules database a list of the grammar rules in a study language represented by CSUSGR colors, and the CSUSGR colors representing them.

In some embodiments, even if more than one of the grammar rules represented by CSUSGR colors “affects” a word, the word will be shown in only one of the colors. In other embodiments, parts of the word will be shown in each of the colors.

Using colors to represent use of grammar rules also allows for more pr-types. Two such pr-types are below. They both assume that it has already been decided which CSUSGR color represents application of each one of multiple grammar rules, and the user has been made aware of this:

AH: Problems where the user selects the correct CSUSGR color for each word in a group of study language words.

AL: Problems where the user selects the correct CSUSGR color for a single study language word.

Some embodiments including pr-type T and pr-types AI, and/or AH, may also include variations of pr-type T that allow the user to speak the answer to problems of any of pr-types AI, and/or AH, respectively.

In some embodiments involving use of word-type colors, and/or word-form-type colors, and/or CSUSGR colors, the word-type color representing each word-type, and/or the word-type-form color representing each word-form of a word-type, and/or each color, respectively, will be pre-set. In some embodiments, the user can select some or all of these colors.

In some embodiments, the individual interface, grammar rules module, problem generator, ICR or another component will include an RGB editor or other color editor, so that a user can make their own colors and use these colors as specific word-type colors, word-type-form colors, or CSUSGR colors. One way a user could do this is by allowing the user to edit the RGB value of the colors the user wants to be specific word-type colors, word-type-form colors, or CSUSGR colors. Some embodiments will also involve some pre-set colors, some colors that the user can select, and some colors that the user makes, or some colors that the user can select, and some colors that the user makes. In some embodiments, the identities of any word-type colors, word-type-form colors, CSUSGR colors that the user makes or selects can be stored in the user's ICR, and the ICR will transmit the identities of these colors to the problem generator, which will then transmit commands to display the appropriate words in word-type colors, word-type-form colors, and/or CSUSGR colors to the i-interface.

In some embodiments, the ICR can later inform any language module that the user uses, of these colors, and what the colors represent, when the user uses the invention. Each language module that the user is using will then command the i-interface, telling it which explanatory material should be displayed in any word-type colors, word-form-type colors, and/or CSUSGR colors that have been saved in the ICR, and the problem generator, will command the i-interface, telling it which parts of problems and answers should be displayed in any word-type colors, word-form-type colors, or CSUSGR colors that have been saved in the ICR.

Colors can be used to represent grammar rules, word-types, and word-forms of word-types, or items in two of these three categories, in some embodiments.

One color should not be used by the i-interface to represent more than one item in the set of grammar rules, word-types and word-forms of word-types, to each user. Otherwise, users will be confused. For example, if a user selects “green” to represent a specific verb tense in Spanish, green should represent only that verb tense throughout all Spanish l-modules, for that user.

Different colors can illustrate the same grammar rule being used in the same or different l-modules concerning the same study language for different users, but that is not preferable because it will reduce the users' ability to cooperate and potentially confuse users.

The combined use of data graphics with words helps users learn a study language and help the audience (users) to see what is most important (The study language's structure and vocabulary).

The effect of using colors to denote grammar rules, and/or word-types, and/or word-forms of word-types on a user's learning study languages can, to some degree, be tracked through tracking how the user's monitored measurements, and their scores on review tests, change when color is used to denote grammar rules, and/or word-types, and/or word-forms of word-types. Additional monitored measurements that specifically track the effectiveness of word-type colors, word-form-type colors, and colors representing grammar rules can also be used in some embodiments. In some embodiments, the user can also turn the use of such colors “on” and “off”, by using the i-interface to communicate with the user's ICR, which will include a record of whether the user wants these colors to be used or not. In some embodiments, if the ICR gets a message saying that the user wants one of these three groups of colors to be turned on or off, the ICR will send a message to the i-interface saying that the appropriate group(s) of colors should appear or not appear, respectively, on the display device's screen.

Color does not need to be the distinguishing feature between parts of a sentence that illustrate use of different grammatical rules, or different word-forms, or different word-types. The parts of a sentence that illustrate use of different grammatical rules, or different word-forms, or different word-types could also be distinguished on the basis of font, size, or in any other way that 1. Can allow for easy visual distinguishing of different grammar rules application' and 2. Is consistent between l-modules relating to the same language, that rely on easy visual distinguishing of different grammar rules' application, or different word-forms, or different word-types.

In embodiments that use a visual effect database, there could also be pr-types where the user must correctly identify when a visual effect from the visual effect database should be used, based on the visual effect rule associated with that visual effect.

### Further Use of Auditory Channels and Other Senses

In some embodiments, the problem generator will connect to a speaking module (20) and/or an interactive multimedia module (21) which will create problems of additional pr-types. When the problem generator selects a pr-type, in these embodiments, the problem generator can select between a problem of one of the pr-types the problem generator created, and a problem of one of the pr-types the speaking module (20) or interactive multimedia module (21) created. The component responsible for creating the problem then creates the problem. If the speaking module (20) or an interactive multimedia module (21) created the problem, the component that created the problem will send it to the problem generator. The problem generator will then send the problem to the i-interface for the user to solve. The problem generator can select randomly between problems of the available pr-types the problem generator, speaking module, and interactive media module create, and in some embodiments can also give some pr-types a higher chance of being selected than others. The speaking module and interactive multimedia module are there, in part, to teach a user about a study language in multiple formats, because if a person receives the same lesson in multiple formats, the person is more likely to appreciate at least one of the formats.

The speaking module (20) is a computer program component in some embodiments. The speaking module seeks to use the user's auditory channels, and to help the user practice speaking words in a study language, to help the user learn the study language. The speaking module helps the user to perform a variety of activities, that engage the user's auditory channels. Some of these activities are discussed below. The speaking module can include a voice component that can “read” all or part of problems of certain pr-types to the user, using the display device's sound producing capabilities, by speaking the words in all or parts of a problem. For example, the speaking module can read problems where the user is asked a question, in the study language or base language, and the user must enter a multi-word answer, into the i-interface. In some problems, the user is required to speak the answer, to answer the question correctly, and the speaking module will receive the sound of the answer through the display device (2). The speaking module can use every method known in the prior art to speak words in problems to the user.

In some embodiments, the speaking module will include access to a large number of sound files, each of which includes a human speaker saying one or a few words in the study language. Then when the problem generator creates a problem, and selects that the problem is of a pr-type where the question is spoken to the user, the problem generator will send the problem to the speaking module (20) and the speaking module will confirm whether the speaking module has access to sound files that, in combination, include a human speaking the words in the problem, in the same word order as in the problem. The problem generator searches through the sound files to which it has access, and then, if it has access to the files needed to create the right word combination, sends the problem generator a message saying that the speaking module has access to all the needed files. The speaking module then uses the display device's speakers to play these files and state the phrase, using the display device. If the speaking module does not have access to the needed files, it sends a message to the problem generator, and the problem generator can use an alternative method (if such is included in the problem generator) to use the display device's capabilities to speak the phrase, or can create another problem to substitute.

In some embodiments, the speaking module will also include voice recordings, of an individual speaking in a study language, that can be accessed through the i-interface, and observed by the user. The speaking module can also include videos of the recorded sound waves of these voice recordings, which will also be available to be shown to the user through the i-interface. The user can then better understand the sound patterns that were made in the voice recording and may be better able to imitate those patterns to say the words in the voice recording.

In some embodiments, the speaking module can also, at the user's command, record video “clips” of the user saying the same words, and record a visual representation of the sound waves, so that the user can compare and contrast the recording of the user saying the words with the recording of the voice saying the same words, and so possibly show the user how to correct pronunciation of words which the user is pronouncing wrong. The user can also try to create video clips that imitate the sound wave patterns in the recorded sound waves. The user can access this capability of the speaking module through the language modules for the study language. The individual tracking module will also track the time that the user spends accessing this capability of the speaking module, count this time as “active time” for the language module through which the user accesses the speaking module, and consider this time when calculating the user's other monitored measurements.

The speaking module, in some embodiments, may also use some of the display device's sound production capabilities to “read aloud” some or all of the explanatory material that language modules send to the i-interface, to engage the user's visual and auditory channels at the same time. For example, the speaking module can use some of the display device's sound production capabilities to “speak” certain grammar points at the same time as they appear on the screen, using any method known in the prior art. In some embodiments of the invention, the parts of each explanatory material word are highlighted as the voice speaks them.

In some embodiments, some of the explanatory material will involve the user speaking words in the study language, and the speaking module will receive the answer using the display device's sound reception capabilities. The speaking module renders what the words sounds like, and sends the answer to the i-interface, which displays the words that the answer sounded like through the display device. The user can therefore learn to speak the words differently if the words the user spoke did not sound like what the user intended. In some embodiments, the user can also alter the answer, after the display device shows the answer and before the answer is scored, by communicating with the i-interface.

In some embodiments, after the problem generator creates a problem of pr-type T, the problem generator can send the problem to the speaking module, and the speaking module will use the display device's sound creation capabilities to speak the problem. In some embodiments, the user will speak the answer to a problem, the speaking module will receive the answer using the display device's sound reception capabilities, and the speaking module renders what the answer sounds like, and sends the answer to the i-interface, which displays the answer through the display device. The user can then compare the answer to what the user intended, and can edit it, before the answer is scored by the problem generator.

In other embodiments, the problem will be spoken using the display device's sound creation capabilities through another method not involving the speaking module.

The speaking module (20) can also, in some embodiments, receive the sound of the user saying things as input, using the display device's capabilities to receive sound. Answers that the user gives to problems will be added to the word record, with the other data pertaining to a word's entry in the word record. Words that have previously been entered into the word record will not be added again, but words not previously part of the word record will be added to the word record, using the methods described herein. In some embodiments, the speaking module converts the spoken sounds, received by the display device, into words and sends them to the words record. In some of these embodiments, the speaking module transmits the words to the i-interface, with instructions for the words to appear on the screen, and requests that the user confirm that the words are an accurate representation of what the user said, before the speaking module transmits the words to the word record. In some embodiments, the word record will check each word sent to it by the speaking module to see if there is already an entry for that word in the word record, and if there is not, the word record will add the word to the word record.

The speaking module will be able to offer additional pr-types, which can be presented to the user. One of these, present in certain embodiments, is below.

AJ: The problem generator creates a problem and finds colors that represent word-types, word-forms of word-types, and/or application of grammar rules, in the appropriate databases, then sends the problem to the i-interface without the words being colored, but with a list of the colors wherein each color signifies a different word-type, word-form of a word-type, or application of a grammar rule. The i-interface displays the problem and list on the display device. The user will answer the problem by verbally stating the color (if any) that should apply to each of the words, according to the list. The speaking module then receives the user's words using the display device's sound reception capabilities, and transmits the colors to the problem generator, which will examine whether the user answered correctly. This will encourage the user to use multiple channels, hopefully helping them to learn the study language better and faster.

The speaking module can also use the display device's sound production capabilities to “speak” problems, including problems of pr-types A-AI, for the user to answer.

The interactive multimedia module (21) is a computer program component designed to use interaction and other techniques, and the user's visual sensing pathways, and other mental pathways, to help the user to learn study languages. The words the user acquires while the user is using the interactive multimedia module, are also tracked in the user's word record, so that the user has a record of which uses of the interactive multimedia module are most “efficient”, in helping the user to learn and recall words in a study language.

In some embodiments, the interactive multimedia module (21) includes one or more of the following capabilities (“Interactive capabilities”): A. Access to a large number of videos, which include people speaking in the study language. Each video is associated with one or more l-modules. The videos will be subtitled in the base language. The user will connect to the interactive multimedia module (21) through the i-interface (1) and can select a video to watch.

In other embodiments, these videos will not have subtitles, and in others, some of these videos will have subtitles and some will not.

B. Access to a variety of videos, each video associated with one or more l-modules. The videos are “slowed down”, with a voice-over in normal speed, in the study language, explaining what is happening in the video, as the action happens. The video is slowed down, so the action does not move faster than the voice-over. The video can be slowed down as much as having each frame linger on the screen for an extended time period, while the voice-over explains what is happening. In some of these videos, there will be arrows pointing to objects the voice-over is discussing, and other visual indications of what the voice-over is discussing will appear on the screen, over the video, as the voice-over speaks.

C. Access to a large number of videos, including words spoken in the study language, and a list of study language words spoken in the videos. The list will be organized by word, so that a user will be able to find the video(s) in which each word appears, by examining the word in the list. Each video will be also associated with one or more l-modules (16). The user can then look through the word list to find the video in which the words the user wants to hear are used. The user can then watch that video.

D. “Interactive” stories each comprised of multiple videos. In each video people will speak in the study language, and during, or at the end of, most of the videos, the user will be presented with a choice about which of multiple other videos the user wishes to see. The question asking the choice may be asked in the base language, in some embodiments, and in the study language, in other embodiments. In some embodiments, the user can create a “Choose Your Own Adventure”-type story by choosing the video to see, and the one to see after that, etc.

E. Videos of one or more animals like cats or dogs and a voice-over for the video describing, in the study language, what the animal(s) is doing. Subtitles in the study language and/or base language may also appear on the screen. The voice-over might include discussions of the grammar rules being used to control the placement and spelling of the words it is making. The theory is that the user will pay more attention to the animal and so retain the other information, such as the study language words and any translations of the study language words, being communicated.

F. The interactive multimedia module (21) includes access to a series of video “clips” or longer video episodes, where the dialogue is in the study language but the video has subtitles in the base language that will not ordinarily be completely visible to the user. The user can click on smaller items on the display device's screen, and translations of the dialogue into the base language will appear.

The video(s) discussed in interactive capabilities A-F will each be associated with one or more language modules, and the individual tracking module will count user's time spent watching the video(s) as active time for one or more of these language modules.

The individual tracking module will send the study language words in the videos that the user watches, used in each interactive capability, to the user's word record, so that those words in each of these videos that the user has not previously acquired are added to the user's word record. In some embodiments, when the interactive multimedia module (21) accesses each of these videos, the individual tracking module will access a list of the study language words in the video and the time in the video that each study language word first appears, so that if the user reaches that time in the video, the individual tracking module will transmit that word to the user's word record.

Embodiments with the interactive multimedia module (21) can also include additional pr-types, that use video capabilities and combinations of use of sight (including animation and interaction) and sound. Some pr-types that can be used with different versions of the interactive multimedia module are listed below.

Pr-type AK: In some embodiments, the problem generator will be programmed that it can select a problem based on a video clip. The video clips will each be associated with one or more l-modules, and the interactive multimedia module will have access to a record of what words are in each of the video clips. Each video clip is associated with a record of the words that each character in the video clip said, and the time, during the video clip, that each character said each word. If the problem generator selects a problem based on a video clip, the interactive multimedia module (21) will have the capability to select one of the video clips associated with the l-module the user is using. The interactive multimedia module will transmit the video clip to the problem generator, which will transmit the video clip to the i-interface. The i-interface will play the video clip, and the problem generator will look through the record of the words in the video clip file, pick one of the words at random, find the translation of that word into the base language (possibly by finding the translation in the L2L dictionary) and create a problem asking which character said the word in the study language. The user will enter the name of the character who said the word in the study language into the display device, and the i-interface will transmit the answer to the problem generator, which will score the answer.

Pr-type AL: A version of interactive capability D where the user must pick which video(s) to see in a sequence, where the user correctly “answers” the problem by picking the videos in the right sequence, to get to a certain ending video. The videos themselves will use the study language, so the user will exercise the user's skill with the study language by picking the correct sequence of videos to get to the desired videos. For example, the user may pick one of several possible verbs, in the study language, to decide what action a character should take, where the next video the user sees depends on the verb the user picks.

Some embodiments including pr-type T and pr-types AK, and/or AL, may also include variations of pr-type T that allow the user to speak the answer to problems of pr-types AK, and/or AL, respectively.

The interactive multimedia module uses the modality principle, by teaching a study language to a user through images and voice, images and text, or all three.

### Review Tests

One purpose of a review test is for the user to learn how well the user can use and recall previously acquired words in the tested study language. When the user takes a review test in a study language, the results will be shown to the user and sent to the charting module, which will create a chart of how well the user recalled the study language words on the review test. When the user observes charts of their review tests' results the user will better learn when, in the future the user will need to review the study language, to maintain the user's proficiency in the study language. Some charts can be used to indicate how much the user's proficiency using previously acquired words in a study language, declined since the user acquired those words. The user can examine these charts and find useful information such as, how quickly their ability to recall an acquired word decreases as a function of time, and the user can then use this information to plan when, and how much, to review the study language to maintain proficiency.

This is one configuration of a review test: First, the user will use the i-interface (1) to indicate that the user wants to do a review test in a specified study language. In some embodiments, the user will also specify the number of study language words the user wants to appear on the review test. The i-interface (1) will communicate this information to the problem generator. The problem generator then picks the entries for a certain number of study language words (The “picked words”) from the user's word record. If the user picked a specific number of study language words for the review test, the problem generator will pick the entries for that number of study language words from the user's word record. The problem generator will then create problems wherein each problem uses at least one of the picked words. The problem generator will choose between available pr-types for each of the problems. In some embodiments, the problem generator will be programmed to only choose between certain pr-types, such as pr-types E and F, which involve direct translations of one of the picked words in the study language to a base language word, and vice versa, respectively, and J. Matches of one of the picked words to a picture. This is to more directly show whether the user remembers the picked words. In other embodiments, the problem generator will be able to test that each problem involves one of the picked words by comparing the words in the problem to the picked words, and ensuring that each problem includes at least one match. If a problem does not involve at least one match, it will not be presented to the user and the problem generator will create another problem instead. In other embodiments, the problem generator can place one of the picked words in a specified word-place in the problem that is appropriate for the picked word's word-type, and then select the other words that it needs to select. This can be used with pr-types A, B, C, D, G, H, M, P, Q, and R and possibly other pr-types. One or more of the below methods for configuring pr-types on review tests, can also be used.

Pr-type J: The picked word is selected. The picture presented to the user is a picture of a picked word. Pr-type K: The user is presented a picked word, as a “hub” in a wheel displayed on the screen, with multiple “spokes” going to other words. Pr-type L: The user is presented a part of the study language's grammar network map, including one of the picked words, and the user must create a sentence in the study language by picking an edge leading from the picked word. Pr-type R: The user is presented a phonetic description of the picked word, and the user must enter the picked word, into the individual interface. Pr-type S: The user is presented with a picked word, shown as a node, and instructed to select the word to start a grammatically correct sentence. Pr-type T: Problems of one of the types above, but where the user must speak the user's response(s) to enter it in the display device. Pr-type U: The user is presented with a picked word, and the user must find an object of the type the picked word names, take a picture of the object, and upload the picture into the i-interface.

All other methods of creating problems that test whether the user knows how to use specific words, in the prior art, can also be used. A combination of more than one of the above ways of creating review test problems can also be used.

The problem generator will send the problems to the user interface (1) and the user will answer the problems. The problem generator will score the user's answers, and send the answers and score to the user's ICR and to the charting module. Meanwhile, the problem generator will send the picked words to the charting module. The charting module then will create a graph showing the time when the user acquired each of the picked words versus the user's score on the review test's problem involving that picked word. The user can take these scores as a proxy for the user's success at remembering and using the picked words over time. The charting module will also try to find the correlation coefficient, and any other statistical relationship that exists, between the time when the user acquired a picked word and the user's score on a problem involving that picked word. In some embodiments, the charting module will group the picked words into groupings based on when, before the time the user takes the review test, the user acquired the picked words (For example, 1 year before, 2 years before, etc.). Then, the charting module will create a bar graph of the percentage of the review test's problems designed to test the user's knowledge of the words in each grouping, that the user got right. The charting module will send this graph to the i-interface for the user to view, and will also save the graph in the user's ICR for the user to view later. The user can observe the graph, and notice the relationships, if any, between how long ago the user acquired a study language word and the user's chances of remembering how to use the study language word, and the user can conclude, on that basis, when they should review study language words to maintain or increase their current proficiency level in that study language.

In some embodiments, the charting module will also be able to create other kinds of graphs concerning the user's results on a single review test, and graphs of other quantities, such as graphs of the user's scores on problems of different pr-types, where the problems were based on words the user acquired at different times, and in some embodiments the user will be able to use the i-interface to contact the charting module and command the charting module to create graphs concerning the user's performance over multiple review tests, by drawing the records of those review tests from the user's ICR, performing appropriate calculations to create a graph, and displaying the resulting graph. An example is a graph showing the user's performance on a specific pr-type, involving words that the user acquired more than 6 months before, across multiple review tests.

The user can also use the individual statistical module to calculate various statistical measures, concerning review tests, and when appropriate, send the results of the calculations to the charting module.

It is possible for multiple picked words to appear in problems of some problem types, due to random chance. Depending on the embodiment, the charting module may count both words as data points, when making graphs of when a user first acquired a picked word versus the user's success at answering problems involving the picked word, or the charting module can count only the picked word that was placed in each problem as a data point, thus ensuring that each picked word counts once, and each problem counts once.

### Use of Large-Scale Statistical Results of Students' Efforts

Each l-module will be designed to instruct a user about one or more specific aspects of a study language. An instructor can track which l-modules the instructor's students have completed, determine how much time a class's members are spending learning a study language, outside of class, and learn many other kinds of information about the class members' efforts to learn the study language and any problems they experience, by looking at the instructor's students' ICRs, creating a cohort comprised of some or all of the students, and then using the invention to calculate and examine the cohort's cohort computation results. The instructor can then customize the class better for the students who are in the class, and give the class members better advice. This should increase student retention and student outcomes.

For example, the instructor can detect whether the class's average time per problem completed is higher or lower than expected, and tailor class sessions appropriately. An instructor can also learn how much progress students who previously enrolled in another class in the study language, before becoming that instructor's students, made while in the previous class. The instructor can also examine parts of an individual student's ICR to learn which l-modules in a study language the student has completed, including those l-modules the student completed outside of any class. The instructor can decide, based on this, whether the student is qualified for the first class in a sequence, the second class, etc.

Some uses of these calculations' results are that an instructor can use the class's members' monitored measurements and cohort computation results to give that class better advice, backed up by quantifiable observations, about how the class members can learn the study language better and do better on exams. The instructor can also learn more about the class's strengths and weaknesses and better adapt classroom presentations to the class's particular strengths and weaknesses. If an instructor, for example, notices that the mean completion time amount the students in the instructor's class in the present year spent on a specific l-module is 5.5 hours, and in past years, mean completion time amount for the same l-module for students in the instructor's class was 3.5 hours, the instructor may want to spend more time in class on the topics that l-module covered.

If an individual student authorizes the student's past monitored measurements to be released to an instructor, the instructor can also examine these past monitored measurements and hopefully give the student advice on how to best learn the study language, based on the student's past learning style, as evidenced by the student's monitored measurements. For example, if the instructor observes that the student's number of acquired words per time period is highest when the student does problems of certain pr-types, the instructor might advise the student to focus on problems of those pr-types. This is an example of how instructors, and educational administrators, can give students and student groups better advice if they know how much the students are studying, how the students are studying, and what areas in which the students might be having trouble.

Another virtue of this system is that it is dynamic; If the characteristics of a cohort comprising an institution's students changes within one year, for example, their cohort computation results should change, and the cohort achievement display will show that their cohort computation results changed. Instructors and administrators can be informed of, and respond to, such changes more quickly than they would otherwise, hopefully leading to higher student retention and more student learning. For example, if a cohort of students at an institution's average amount of active time per month is substantially lower in one year than it was in previous years, while the cohort members' average number of words acquired per active time period has not increased, the institution's instructors may wish to quickly offer remedial measures to protect student outcomes. Instructors might also try to find out why the change in active time per month happened.

One advantage of the present invention is that it creates a single, centralized resource for easily monitoring the effort that students have made, the type(s) of effort, and that effort's results. For example, an instructor can use the invention to detect when a group of the instructor's students are making an exceptionally high number of errors in problems of a certain pr-type related to a certain language module, or spending an exceptionally large amount of time on a certain language module, or the students' monitored measurements or other statistics derived therefrom indicate that the group members are struggling more than expected to learn specific material related to the study language. Then the instructor can preemptively work with the group members to help them, and have more information about how they need help.

An instructor can also use the invention to better track how a large language class's members are spending time on the class's material outside of class, the e-types that the class members are making, and the type of errors that individual students make. This should help the instructor to help individual students in the class, and give the instructor more information about the areas where they need help than the instructor would have otherwise.

By tracking demographic information for subgroups of large cohorts against those cohorts' monitored measurements, instructors and researchers may also learn whether cohort computation results differ between subgroups of a large cohort—For example, whether a subgroup of users who already knew one study language had an exceptionally high error rate on problems of pr-type C related to another study language. Instructors and researchers might also find ways to “fix” common problems by examining circumstances when users fixed these problems. For example, if members of the aforementioned user subgroup's error rates on pr-type C problems go down after they spend a large amount of active time on problems of a specific different pr-type, then researchers might consider this a good way for other members of the subgroup to fix exceptionally high error rates on pr-type C problems.

In principle, by examining the cohort computation results for a cohort comprising all the users with a common characteristic, such as all the users in a country, an instructor can find the topics, related to the study language, where users had the most “trouble”, such as the language modules where users in the country had the highest error rates. The instructor can also learn if and when the language modules where users in the country had the highest error rates changes to a different l-module, because the cohort's cohort computation results will be updated as the cohort members' underlying monitored measurements change.

The present invention can also help with remote learning, because an instructor can track how much effort the students are making outside of class (Their “active time”) and inform the students when they are not spending enough active time. The instructor can also understand a remote class's characteristics better by examining the class members' monitored measurements and class's cohort computation results.

The invention can also increase completion rates when a class is forced to switch from an in-person format to an online format, and/or switch back, because an instructor can have the students use the invention for language learning, during the time the class's format is online. Then the instructor can use components like the cohort statistical engine (18) to create a cohort with the students as members, and track the cohort's cohort computation results, and, if allowed, the individual student members' monitored measurements. The instructor can also use the cohort achievement display (19) to create charts to further understand the effects of the change from an in-person to an online format, effects of any change back to an in-person format, and effects of any other changes in circumstances, on the class members' attempts to learn the study language by using language modules and doing problems. This will give the instructor a much better understanding of how much the individual students struggled with different parts of the material outside of class, and what the students did to learn the material outside of class, using the invention. The instructor will also have a much better idea, during the class, of how prepared the students are, and how much they have been able to learn and practice the study language outside of class. An instructor can also tell the students to focus on language modules with topics that are close to the topics the instructor wants to cover in impending class sessions. One of the reasons for an instructor to track their students' efforts outside of class, and detect any material where the class members seem to have an exceptionally high error rate, in addition to directly tracking “results” through grades, is that the instructor would want to know how much time the students are spending on learning the study language outside of class, what types of errors the class members are most commonly making, outside of class, and potentially what types of errors the class members most commonly made before they started the class. The students' monitored measurements and class cohort's cohort computation results will give the instructor faster, more “granular” insights into the class's strengths and weaknesses. The instructor could then design and modify the class appropriately for the class members' strengths and weaknesses.

In some embodiments, the invention will be able to “integrate” with other programs, by, for example, sending data to the other programs in formats that the other programs can use.

Students can also get better information about whether they are spending enough active time on a specific l-module. For example, if a student knows that in his cohort, people spend an average of 6 hours on a certain l-module, and he has spent 4 hours on that l-module, he should probably consider spending more active time on this l-module.

This invention can also help students from areas without AP classes to practice for, and pass AP exams, in this way: If the cohort computation results for a cohort of students who got a certain, passing score on the AP exam for a study language are available to a student who wants to take an AP exam, the student can examine these cohort computation results and find the average amounts of active time and practice time, and potentially averages for other monitored measurements, for each l-module in that study language that any cohort members attempted. Then the student who wants to pass the AP exam can make sure to spend at least as much practice and active time on each l-module as the mean for the cohort of students who passed.

The invention can also be used to help users learn a language's dialects, in a way similar to the way they would learn the “official” version of that language, or more common version of that language. Here, the “official” or most common version of a language is called the “MC version”. The dialect can be listed as a possible study language, and a grammar network map (4), word record (9), L2L dictionary (17), and words database (11), for the dialect can be created by taking versions of those components that exist for any MC version of the study language, and modifying them to reflect any differences between the MC version of the study language and the dialect. For example, if some words have a different spelling in the dialect from their spelling in the study language's MC version, these words' different spellings will be used in the grammar network map, word record, L2L dictionary, and words database for the dialect, but words with the same spelling can be copied directly into the grammar network map, word record, L2L dictionary, and words database for the dialect, from these respective components for the study language's MC version. A grammar rules module and word-form module for the dialect can also be created by taking the study language's MC version grammar rules module and word-form module, and modifying them to reflect differences between the study language's MC version and the dialect. L-modules for the dialect (16) could be created, to a large degree, from the l-modules for the study language's MC version, again, modifying the l-modules to reflect any differences that might exist between the dialect and the study language's MC version. A potential words database (23) can also be created for the dialect. This system is cheaper, more flexible, and more efficient than training instructors in the dialect, and this system also makes it easier to meet demand for language-learning for a dialect, when only a comparatively small number of users want or need to learn that dialect.

The invention can also help users to learn a less widely spoken language by giving them access to learning the language, and some degree of feedback about their most efficient methods of learning the language, without a formal class. This is very important if there is no class available in the language or dialect the user wants to learn.

### Use for Educational Administration

Some embodiments of the invention will also include a centralized listing which will describe the amount of effort that students in cohorts defined by groups of common characteristics put forth, to master each specific l-module (16) for each language, and other information about these cohorts.

Common characteristics defining cohorts can include, for example, being in a certain geographic area, or being at a specific school. An instructor will be able to view information about the efforts of users in a cohort that is similar to the instructor's own students, find the distribution of the amounts of effort that the cohort's members required to achieve milestones that the instructor wants his students to achieve, and advise his students accordingly. For example, an instructor might advise the instructor's students, based on a density plot concerning past students in the instructor's classes, that ten active time hours was the 25^{th} percentile of the students in the instructor's present class who reached a certain milestone within a month. An individual student who has spent 8 active time hours during that month will have advance notice, to conclude that the student may need to spend more active time, and perhaps needs to rearrange his or her schedule to do it.

The centralized listing will also include information about how the cohort calculations for the cohorts change, which would also be useful for helping an instructor to quickly recognize changes in the characteristics of the student body that the instructor is teaching, and to quantify such changes more easily. For example, if the mean time length that the students in an instructor's class take to reach a certain milestone is 20% higher this semester than it was last semester, the instructor will notice this quickly, and be able to take measures to help the students, instead of gradually learning about changes in the student body anecdotally.

The instructor will also be able to quantify the effectiveness difference between that instructor teaching in person and teaching remotely, which is important during COVID-19 crises and other emergencies. An instructor might create a reasonable proxy for this difference by looking at their students' monitored measurements, and other measurements based on the monitored measurements, when the instructor is teaching in person, versus teaching remotely.

In some embodiments, the instructor, using the cohort statistical engine to perform linear regression or another statistical technique, may be able to correlate his student's grades to some quantity related to students' use of the invention. One example of such a quantity would be the students' active time spent using l-modules. The instructor can then inform their students of this correlation so the students can make better decisions about their use of the invention, how and when they use l-modules, and other factors related to their use of l-modules. If the amount of active time a student has been spending using l-modules to learn a study language (or some other quantity) correlates to a likely future low grade in the instructor's class in that study language, but the instructor knows an amount of active time that correlates to a high grade in that class, and the instructor can tell the student, the student may be able to learn exactly how much the student should increase the quantity (the student's active time, in this example) to get a high grade. The student can then rearrange the student's schedule to increase the quantity in question, for example by increasing the student's active time if that quantity is the student's active time. If students have the advantage of knowing quickly, ahead of time, when they need to change their use of the invention, to raise their chances of getting a higher grade, the students can make faster adjustments to their use of the invention and their class completion rates will likely improve.

In some embodiments an instructor can help their students to learn whether they are spending enough active time using l-modules, by entering the performance level that is required for each grade, and the actual performance levels the instructor's students achieved, into the cohort statistical module (18). The cohort statistical module separately has access to data based on the students' monitored measurements and can associate the performance level each student achieved with the student's monitored measurements, as a data point. As more instructors enter their students' performance levels into the cohort statistical module, the cohort statistical module will have enough data points to then calculate the correlations, if any, between monitored measurements and performance level, for cohorts comprising the students in a specific city, students in a specific school, students in a specific geographic area, etc. The number of students, and students' geographic areas, represent a greater number of data points than the number to which an instructor will have access, and so can likely be used to find a better approximation of the true “population” relationships between monitored measurements and performance than what an instructor can find by examining the instructor's students. The cohort statistical engine can then create graphs of any correlations between monitored measurements and, performance levels, and make the graphs available to instructors and possibly students and others to help them make better decisions about how students can learn study languages. Student data regarding monitored measurements, performance, and other information can be anonymized by the cohort statistical engine so that nobody, besides a student and the student's instructor, can learn about the student's performance levels, and/or that nobody, besides the student and other people the student selects, can learn about an individual student's monitored measurements.

In some embodiments students who have access to cohort computation results for cohorts, including cohort computation results for a cohort of which they are a member, can also analyze the cohort computation results and trends therein, and possibly learn useful information about groups of students and possible ways of informing those students' retention and outcomes.

The invention can be used to investigate potential effects of an institution making a change, such as a university changing its class structure, by examining changes in students at other institutions' monitored measurements and cohort computation results when those other institutions made changes similar to those changes that the first institution is considering. In one type of scenario, a first institution would create decision criteria applying to a potential change the first institution is considering. The decision criteria would be based on changes in the monitored measurements, and cohort computation results, of cohorts of the first institution's students. The decision criteria might label some changes in these monitored measurements and cohort computation results as “positive” or “negative”. The institution would examine whether other institutions' students experienced “positive”, or “negative” monitored measurements changes, or cohort computation result changes, that are considered “positive”, or “negative” according to the decision criteria, when changes similar to those contemplated at the first institution were made at those other institutions. For example, if University 1 reduces the number of class sessions in a Chinese class, per week, from 3 sessions to 2 sessions that each have 150% of the previous sessions' length, and then University l's students' mean completion time for 15 specific l-modules of Chinese, increased, this may indicate that University 2 should not reduce the number of class sessions in an equivalent Chinese class from 3 to 2 per week, while increasing the time amount per class session by 50%.

Likewise, an institution might find the “best” times of day and week to schedule a class by offering the class at multiple times, where the students taking the class at each different day/time combination comprise a cohort. The institution would then track differences in the cohort computation results for the cohorts. The institution might use decision criteria, for which cohort computation results are “better” or “worse”, then examine the cohorts' actual cohort computations' results, and from these results, decide that cohorts of students who take the class when it is scheduled at certain days and times have “better” cohort computation results, than those who take the class when it is scheduled at other days and times. The institution could conclude that the “better” cohort computation results of some cohorts evidence “better” day/time schedules for the class.

The invention can also provide data for an institution's administration about the likely implications of changing a class schedule, changing language classes, or reducing the number of language classes of a certain type. The administration can also better understand what the students were doing outside of language classes, to achieve their language learning objectives. This can be achieved, in at least these ways: First, the administration can create a cohort comprised of students who experienced one condition set, such as a certain of language class schedule, and the administration can create a second cohort comprised of students who experienced a second condition set that differs in one or more known ways from the condition set the first cohort experienced. For example, the first cohort may be comprised of students who experienced language classes in a study language, arranged according to one schedule, while the second cohort is comprised of students who experienced language classes in the same study language, arranged according to a different schedule. The administrators can then use the cohort statistical engine to find the differences between the two cohorts' cohort computation results, and differences between monitored measurements' averages and distributions for the two cohorts. The administrators can then use their knowledge of these differences to better plan class offerings in the study language that better help their students. The administrators can create these cohorts easily, at little cost, because all, or most of, the students at the institution the administrators manage will presumably have given access to view their monitored measurements to the institution the administrators manage. The administrators can decide to use the cohort statistical engine to retroactively create a cohort(s) out of a group(s) of their students, and then do statistical analysis on the cohort(s), instead of prospectively planning which students will be in each cohort. The cohort members' data, their monitored measurements, will already be available to the administrators. The administration will also be able to create cohorts defined in different ways, compare their cohort computation results and/or monitored measurements, and hopefully find ways in which differences in external factors are correlated to different cohort computation results and/or different monitored measurement distributions for the specific institution the administrators are managing. External factors like traffic, ambient noise, air pollution, temperature, and crime can vary, can also differ significantly between institutions, and can also affect cohorts' monitored measurement distributions.

Knowing about these correlations will help the administrators to understand the way their institution's students learn study languages, and have a much better understanding of the student body's strengths and weaknesses and how the students achieved the grades they achieved. The administrators will thus be able to use this information to create programs and class offerings that more effectively help their institution's student body. Class completion rates can also be increased if administrators have a clearer idea of how a given change in conditions will affect students' monitored measurements, such as their active time, practice time, and CTOT.

The invention can also be used in other ways to gauge how an event that temporarily disrupts the student population's classes, such as a COVID-19 epidemic or other disaster, affected the student population's language studies. When the disaster hits, instructors or others can divide the students into cohorts based on which language classes they have enrolled in, or completed, and then send each student cohort instructions about which l-modules (16) the student should focus on, to accumulate active time. The instructors can also send the students a simple request to accumulate as much active time as possible.

Then, when the disaster ends and the students can return to the classroom, the language class's instructor can quickly use the cohort statistical engine (18) to examine some or all monitored measurements' distributions for the cohort comprised of the instructor's students. The cohort can be created from the students in the class if the class starts after the disaster ends, or the cohort might have already existed if the class existed before the disaster happened. The cohort statistical engine will send cohort computation results, concerning the cohort the students in the instructor's class comprised, to the cohort achievement display (19). Then, the instructor can quickly learn the students' practice and proficiency levels in the study language the instructor is teaching, by examining the monitored measurements' distribution for the cohort (the class). The instructor can also find how much, if at all, the disaster affected the students' learning the study language, and the instructor can tailor the class to the students' levels of knowledge and practice in the study language. This is better than tailoring the class based on the students' past grades. Some instructors may “inflate” grades because of a disaster, and the students' grades before the disaster may have limited predictive value after the disaster. Grades during the disaster may also have limited predictive value because the students may have been preoccupied during the disaster. Monitored measurements, including monitored measurements A-Y also measure more information than the students' grades.

The invention can be used as a guidepost to standardize MOOCs based on the MOOCs' students' performance on assessments in the invention, such as review tests and practice tests, or alternatively an MOOC might be designed to cover a certain “minimum” number of the invention's l-modules in a study language.

The invention can also be used to examine differences between the language learning efforts, and language learning strengths, and weaknesses, of groups of students at different institutions. A cohort could be created comprising the students or a group thereof at one institution, another cohort created comprising the students or a group thereof at a different institution, etc. Then, the averages of monitored measurements, and parts of the ranges of monitored measurements for the students at different institutions could be compared, for each l-module (16) for the language. The administrators or others doing the comparison would then better understand what students at the institutions do differently, regarding learning the study language, and how to more effectively tailor their institutions' programs to their students' needs. For example, if students at one institution have longer mean completion time and CTOT but higher mean active time and practice time for some l-modules than students at a second institution, the administrators at both institutions may design their institutions' programs to help their students in different ways, so that the programs and language learning classes at each institution are suited to that institution's students' characteristics.

Likewise, the invention can be used to learn whether there are any relationships between items in students' demographic information and any of the students' monitored measurements. Administrators or others can also use the invention to learn whether there are differences between cohort computation results for cohorts of students where each cohort's members have common demographic characteristics, but these demographic characteristics differ from those of the other cohort(s). Administrators and others can therefore find whether differences exist between the averages, standard deviations, and other statistics relating to cohort members' monitored measurements, and can take steps to proactively address these differences to ensure that cohort members are able to learn study languages successfully.

Administrators, instructors, and students can perform many kinds of statistical analyses with all or part of the student data gained from the invention, including data about students' monitored measurements, and they can experiment to try to discover previously unknown insights about student populations, which can be used to improve student retention and performance.

The invention is highly useful for users who want to gauge whether they are sufficiently knowledgeable about a foreign language. Users to whom English is a foreign language, and who are gauging whether they need “ESL”, or have taken ESL and want to know if they still need it, may use the invention to learn whether they need ESL in the future. For example, a user can use the charting module to create an isoplethic chart showing the percentage of words, in the English words database (11), that the user acquired. Then the user can examine the isoplethic chart and see if they are satisfied with their exposure level to words in different categories.

The invention also has the additional advantage that it provides a standardized way to track users' facility with a foreign language, diversity of experience with a foreign language, and also track when, and how much, the user studied the foreign language. This method also works together with classes in a foreign language, while the user is enrolled in classes in the foreign language, or the user can use the method by itself. Instructors and administrators can also use the method and system to more easily compare students' depth of familiarity with a foreign language, when the students have studied the foreign language at different “levels” of the educational system, such as college vs. high school.

### Use for Tutoring and Use by Facilitators

The inventor recommends against any instructor basing a student's grade upon a student's performance in l-modules that the instructor didn't specifically assign. A student may have previously tried to learn a language on his or her own, before enrolling in the instructor's course, and may simply not have been paying attention when the student attempted some previous l-modules. The student's performance on these l-modules might not have indicated the student's true ability level or commitment when taking a class from the instructor. If an instructor grades students based on their performance in l-modules that the instructor didn't specifically assign, this will also discourage “casual” language learners, which is undesirable and counterproductive. Casual learners should not be discouraged, and one reason for this invention's creation is to help casual learners to learn languages.

### Adding Words to the Words Database for a Language

A feature of some embodiments of the invention will allow users to “add” words to a specific language's words database (11), as follows. A user can suggest a word (A “proposed word”) for inclusion in the specific language's words database, and suggest a definition for the proposed word, and suggest other words in the specific language that could potentially have edges to the proposed word. The proposed word will be included in the specific language's potential words database (23). The potential words database (23) keeps track of the number of times the proposed word is suggested for the specific language's words database, and saves the definitions users suggested for the proposed word. The potential words database (23) will inform a pre-designated curator team when the number of suggestions of the proposed word reaches a certain, pre-designated number. Then, when the number of suggestions of the proposed word reaches this certain number, one or more members of the curator team will examine whether the proposed word should be added to the specific language's words database, and, if appropriate, the curator team will add the proposed word to the specific language's words database, and give the proposed word a definition(s) in the specific language, based on the definition(s) users suggested. The curator team will also add the word to the specific language's L2L dictionary, and add definitions of the word, in as many languages as possible, to the L2L dictionary and the words database, if appropriate.

An artificial intelligence network, or other program, could perform this task instead of a curator team, but curator teams are more trustworthy, in various ways, than programs.

The curator team will, either later or at the same time, place the proposed word as a node in the grammar network map (4) for the specific language. The curator team may rely on software-based systems to place the proposed word as a node and create “proposed edges” to other words based on the formerly proposed word's word-type, on the theory that words with the same word-type are likely to be able to have similar words after them in a grammatically correct statement. The curator team can then manually review whether the edges the software-based system created are correct. The curator team may also rely on software-based systems or an artificial intelligence network to place the proposed word as a node without reviewing the edges the software-based system created, or may manually create the edges going to and from the proposed word themselves. In some embodiments, proposed edges will have a different color or otherwise look different from confirmed edges.

This methodology can be useful in situations where a grammar network map cannot be created for an entire language at once, because of funding reasons or other reasons. This methodology is also useful in situations where the entire study language is not known. This methodology can also be useful for rare languages, especially in situations where a rare language has few scholars or speakers. The rare language's words and grammar will be recorded for posterity, in case the number of the rare language's speakers decreases to a low level, or to 0. This methodology can also be useful in numerous other situations.

In theory, if a language's words database contains all that language's words, the number of new words added to the words database each year, divided by the total number of words in the words database at the year's beginning, indicates the change rate of the language for the year (which will be called PWY herein). An average of PWY for a language can also be created by taking PWY for that language over multiple years.

Some embodiments will involve one of the invention's components, such as the cohort statistical engine (18), taking a large corpus of documents, from a variety of sources, from the same year (recorded by the cohort statistical engine), written in a language, and then comparing the corpus to similar-sized corpuses of documents in the same language, from the same sources, but from multiple different years (Also recorded by the cohort statistical engine), and finding A. The total word number in the corpus from each year (A word that appears more than once counts as one word), and B. The total number of words that appear in the corpus from each year that did not appear in the corpus from any previous year. Then, for each year after the first, dividing (Total #new words in corpus for each year)/(Total #words in corpuses for all past years) to get a percentage of new words in the language for each year, which will be abbreviated herein as PWY. Then, the cohort statistical engine would find an average of PWY for all the years after the first. This mean is an indication of the language's rate of change per year.

In some embodiments, a user's monitored measurements can be used as inputs to an artificial neural network, with the output being a recommendation of the mix of pr-types of problems that the user should complete, and/or other actions the user should undertake, such as making their active time sessions a certain length, to maximize the efficiency with which the user learns the study language. A user's monitored measurements could also be used as inputs to an artificial neural network with estimates of the numbers and types of errors that each of the users is likely to make as outputs. A combination of a user's monitored measurements and the errors and e-types of the errors the user made could also be used as inputs to an artificial neural network, with the outputs being activities the user should take to “optimize” their use of the invention, such as optimal length of their active time sessions and optimal amount of active time per day.

### Additional Embodiments

Other embodiments of the invention are possible, such as embodiments including characteristics of multiple embodiments described herein, or characteristics of embodiments from different embodiment groups, or additional characteristics. The invention's embodiments can also be used to monitor changes in the effectiveness of different learning techniques within a student body.

### The Second Embodiment Group

The second embodiment group uses stochastic optimization and simulation to determine how a student is likely to perform on a test, in a remote or in-person class, by using A. The user's scores on problems of certain pr-types in a practice test the invention created. B. Limited randomization of pr-types of problems on the practice test, and C. Limited randomization of weighting of each pr-type of problems on the practice test, to determine a range of scores that the user is likely to receive on a real test. Any method of using stochastic optimization to estimate a range of probabilities for the student's score on an actual language test by examining the student's score on a computer-generated practice test and how the score on the actual language test will likely vary if the types of questions on the actual language test vary from those on the practice test is within the present invention's scope. Some methods are below.

In some embodiments, the problem generator (14) will be capable of creating a group of problems (A practice test), wherein the user first selects the following for the practice test: The number of problems, problems' pr-type(s), point allocation for each problem, and estimated time per problem, the l-modules the problems will be based on, and the percentage of the practice test's points derived from problems based on each of those l-modules. In some embodiments, the problem generator (14) can also, at the user's command, create problems for the practice test while selecting study language words for these problems from only projected words or current projected words for l-modules the user selected, or from the user's word record.

The user can use the i-interface (1) to select that the user wants to take a practice test, the study language on which the user wants the practice test to focus, and the practice test's time length. The i-interface (1) sends these selections to the problem generator.

The i-interface then presents the user with a screen where the user makes decisions about some or all the following “exam construction rules i-viii”: i. The pr-types on the practice test, from among the pr-types the problem generator can create and that can be used with one or more of the l-modules the user selects in (iii). ii. The percentage of the practice test which will be devoted to each pr-type. The practice test can be equally or unequally divided between the pr-types the user selected in (i). iii. Which l-modules for the study language will be covered on the practice test. iv. Whether the user can view one or more of the L2L dictionary, words database, grammar rules module or word-form module during the practice test. v. Whether to accept any of the problem generator's “default” practice test time amount per problem of each pr-type, or modify the time amount the problem generator allocates for problems of each pr-type. The time per problem will be called “TPP” herein. vi. Whether the study language's words appearing in the practice test's problems will be limited to the user's acquired words, or, in embodiments with projected words for l-modules (16), limited to projected words or current projected words for the l-modules that are the practice test's subject, or whether no such limits will exist. vii. Whether to accept any of the problem generator's “default” numbers for the number of “points” a problem of each pr-type appearing on the practice test is worth, or re-set the number of points a problem of each such pr-type is worth. viii. Whether to accept any “default” condition of the practice test being divided evenly between the l-modules (16) that are the practice test's subjects, or whether to increase the practice test's percentage devoted to one or more l-modules. The fact that l-modules are relatively small gives the user more flexibility, so that the user can more easily create a practice test using those language modules that cover exactly the same material that will be on the real test, while eliminating material that will not be on the real test, if desired.

“Default” amounts of time per problem of each pr-type can be previously programmed into the practice test, or can be previously selected by the user, in some embodiments.

The user may also, in some embodiments, select additional things about the practice test, concerning additional exam construction rules.

The user interface (1) sends the user's selections concerning all exam construction rules to the projection module (22) and problem generator (14).

The problem generator then divides the practice test's total time by the number of l-modules (16) that are the practice test's subjects. The total time will be divided evenly between the l-modules (16) unless the user specified, using exam construction rule viii, that a higher percentage of the practice test would be based on one or more l-modules than on other l-modules. If the user so specified, the division of the practice test between l-modules will be based on the percentage of the practice test the user assigned to each l-module (16). The problem generator applies exam construction rules i, ii, iii, v, vi, vii, and vii. The problem generator then selects randomly between the l-modules the practice test covers to pick an l-module on which to base a problem, with the probability assigned to each l-module being picked equal to the practice test's percentage assigned to that l-module. The problem generator will check whether the TPP for a pr-type is greater than the remaining time allocated to an l-module (16) on the practice test. The problem generator will then create a problem by using random chance to select from among the available pr-types, with TPP less than the remaining time for that problem, that the user selected as parts of the practice test. A pr-type's chance of being selected would equal: ((Chance assigned to pr-type)/(1-chances assigned to pr-types with remaining TPP higher than remaining practice test time assigned to l-module)). The problem generator will subtract the TPP for the problem it creates from the total amount of the practice test's time assigned to the l-module (16) on which the problem was based. The problem generator will create another problem in the same way, subtracting the second problem's TPP from the remaining practice test time after the first problem's TPP was subtracted.

If the user limited the practice test to the user's acquired words, the problem generator compares the problem and the user's word record to find whether each of the study language's words in each practice test problem the problem generator creates, and each of the study language's words in at least one correct answer for each such problem (where the problems and answers, respectively, involve words), appears in the user's word record. If all words in the problem and answer do not so appear, then the problem generator will create another problem of the same pr-type, and confirm that the second problem's words are in the word record, by comparing the problem and the user's word record. If they are not, the problem generator will create another problem, etc. If each word in the problem is in the word record, the problem will be presented to the user as part of the practice test.

If the user has decided to limit the practice test to projected words or current projected words, respectively, for the l-modules that are the practice test's subjects, the problem generator will confirm whether each of the study language's words in each problem the problem generator creates for the practice test, and each study language word in the correct answer for each such problem, appears in the projected or current projected words, respectively, for the l-modules that are the practice test's subjects. If each word in the problem does not so appear, then the problem generator will create another problem of the same pr-type, and confirm this with the second problem. If each word in the problem appears in the words database, the problem will be presented to the user as part of the practice test.

Then the problem generator will create another problem using the same method, then create another problem using the same method, etc. The problem generator will keep generating problems until the difference between TPP for all the created problems and the total time amount in the practice test assigned to the l-module (16) is less than the TPP for the pr-type with the lowest TPP. Then, the problem generator will go through this process for the next l-module (16) that is one of the practice test's subjects, then the next such l-module (16), etc., until the problem generator has finished this process for all the l-modules (16).

The problem generator then presents all the problems to the user, by sending them to the i-interface (1), and the user answers the problems. Alternatively, the problem generator can send one problem to the i-interface (1) for the user to answer, then after the user answers that problem, the problem generator can create a second problem using the method listed above, after subtracting the first problem's TPP from the practice test time amount allocated to the l-module on which the first problem is based. The problem generator will then create the third problem in the same manner, etc.

If the user used exam construction rule iv to specify that the user wanted the i-interface to be “locked” during the practice test, the projection module, can “lock” the user interface (1) during the practice test, preventing the user from accessing some or all of the L2L dictionary, words database, grammar rules module or word-form module until the practice test is over. Alternatively, the i-interface can “lock” the i-interface during the practice test.

After the user answers the problems, the problem generator will score the answers and send the i-interface (1) the user's total score, score for the problems based on each l-module, and score for each pr-type, and the i-interface (1) will display this information.

The user's score on the practice test, “TSC”, is the sum of, for each l-module, (the score on the problems based on each l-module x that l-module's weight on the practice test). The user's score on the problems based on an l-module is the sum of, for all pr-types used with that l-module, the percentage correct on each pr-type x that pr-type's weight. If a pr-type's weight for an l-module changes, or the weight of an l-module changes, TSC will change, even if the percentage correct for each pr-type, for each l-module, does not change.

The projection module (22) will create a series of scenarios, and each scenario will examine and show what the user's score on the practice test would have been, if the percentage of the total possible points that the user earned on problems of each pr-type for each l-module was the same, and A) Percentage of the practice test devoted to one or more pr-types had been a specific different number (The number will be shown), or B) Percentage of the practice test devoted to one or more l-modules had been a specific different number (The number will be shown), or C) Percentage of one or more pr-types concerning one or more l-modules had been a specific different number (The number will be shown), or D) A combination of one or more of A, B, and C. The projection module (22) will send these scenarios to the i-interface (1), that will display the scenarios to the user. The user will then better understand the user's chance to achieve a certain score on a real test, in different scenarios where the problems presented on the real test, and/or their weights, differ from the problems presented on the practice test. By examining the user's scores on pr-types and finding the pr-types and/or l-modules where the user scored lower than they wished, and looking at the scenarios to understand how changes in the real exam's composition can affect the user's score, the user will better understand what the user needs to do, to increase the user's chances of getting a high score on the real test.

The user is given multiple options to modify the practice test so that the user can structure the practice test in the way that best approximates the real test the user will be taking. This will help users to allocate their time and efforts better before a real test, thus improving student outcomes and retention.

### The Third Embodiment Group

A blockchain is a digital ledger in which a record of transactions is kept and maintained across multiple computers linked in a peer-to-peer network. The computers are decentralized “nodes” of the blockchain, and each carry a complete copy of the blockchain. New transactions on a blockchain are saved in “blocks” on the blockchain. For a block to be altered after its creation, the block would have to be altered across the entire network, making it unfeasible to alter the blocks that have been entered into the blockchain.

A non-fungible token (NFT) is a unique digital identifier that cannot be copied, substituted, or subdivided, that is recorded in a blockchain, and that can be used to certify authenticity and/or ownership (as of a specific digital asset and specific rights relating to it). Non-fungible tokens can be used to certify a digital asset's uniqueness. Non-fungible tokens can be stored using blockchain technology. Non-fungible tokens must be “minted”, meaning that they will be published on the blockchain. Minting often carries an additional cost, called “gas”. Gas prices vary, so those minting an NFT should try to pick a time to mint when gas prices on the blockchain are relatively low.

Here, a non-fungible token can be minted for each user's ICR, providing exceptionally secure records of, and access to, a student's ICR, and can help make the same ICR available easily if the student attends different institutions. The records in the ICR can be accessed by, or through, the entity with custody of the non-fungible token. The relationship between the NFT and the ICR can then be used in several ways. First, the relationship can be set up so that only the entity with custody of the NFT will be able to modify the ICR. The individual tracking module (5) will retain custody of the NFT, and will be the only thing that can modify the ICR. This will provide more security to users and others who want to rely on users' ICRs. In other embodiments, the only entity that can access the ICR at all will be the entity holding the NFT. Then, the user can pass the NFT to those entities that temporarily need access to the ICR, and those entities can pass the NFT back to the user, when they no longer need access to the NFT. Other embodiments of the invention that use the NFT in other ways are possible.

The use of NFTs to guard students' ICRs can be very helpful if a student transfers between institutions or starts using the invention to practice a study language before attending an institution. The student's new institution will be able to view the student's ICR and find out exactly what concepts the student encountered, related to each study language. The student's new institution will then be able to place the student in a class at an appropriate level for the student, and have better (and possibly cheaper to obtain) guarantees about authenticity of part or all of the student's past record.

Other embodiments combining components discussed in different embodiment groups are possible, and may increase the invention's utility.

The discussion included in this patent is intended to serve as a basic description, may not explicitly describe all embodiments possible, and alternatives are implicit, or obvious to those skilled in the art. This discussion may not fully explain the invention's generic nature or explicitly show how each feature or element can actually represent equivalent elements. These are implicitly included in this disclosure. Where the invention is described in device-oriented terminology, each of the device's elements implicitly performs a function. It should also be understood that a variety of changes may be made to the embodiments herein described, without departing from the invention's essence. Such changes are implicitly included in the description, and fall within this invention's scope.

Furthermore, the invention's various elements and claims may each be achieved in a variety of manners. This disclosure should be understood to encompass each such variation, whether it is a variation of an apparatus embodiment, a method embodiment, or a variation in any element of an embodiment. As the disclosure relates to the invention's elements, equivalent apparatus terms may replace the words describing each element, even if only the function or result is the same. Such equivalent, broader, or even more generic terms should be considered to be encompassed in each element or action's description. Such terms can be substituted, when desired, to make explicit the implicitly broad coverage to which this invention is entitled. It should be understood that all actions may be expressed as a means for taking the action in question, or may be expressed as an element for causing the action in question. It should also be understood that variations combining the invention's components that are listed separately here, and dividing the invention's components that are listed as one component here into two or more components are part of the present invention.

Similarly, each physical element disclosed herein should be understood to encompass a disclosure of the action which that physical element facilitates. Such changes and terms are to be understood to be explicitly included in the description.

The features, functions, and advantages described herein may be achieved independently in various embodiments of the present invention including computer-implemented methods, computer program products, and computing systems or may be combined in yet other embodiments. The relationships between the computer program components herein are not the only possible relationships between these components. Other relationships are possible. In some embodiments, some computer program components of the invention may be combined, as long as the combined computer program component maintains their functionalities.

As one skilled in the art will appreciate. any software modules described below may be combined into a single software module for performing the operations described herein. Likewise, the software modules can be distributed across any combination of the computing systems and devices described herein, and are not limited to the express arrangements described herein. Accordingly, any computing devices or systems described herein can perform any operations described herein, unless expressly noted otherwise.

Likewise, the computer program components and databases, that are part of the present invention, can be located on “cloud” computational resources, on specific servers, virtual private networks, individual display devices, or any other form of computational device known in the prior art. These components may also be located on a combination of computational devices, such as some components being located on a cloud and some components being located on a display device.

The description herein sets forth various embodiments of the devices and/or the invention's processes via use of block diagrams, flowcharts, and/or examples, Insofar as such block diagrams, flowcharts, and/or examples contain one or more functions and/or operations, those within the art will understand that each function and/or operation within such block diagrams, flowcharts, or examples can be implemented, individually and/or collectively, by a wide range of hardware, software, firmware, or virtually any combination thereof.

Those skilled in the art will recognize that designing the circuitry and/or writing the software's and or firmware's code would be well within the skill of one skilled in the art in light of this disclosure.

The herein described subject matter sometimes illustrates different components contained within, or connected with, different other components. It is to be understood that such depicted architectures are merely examples, and in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components.

Likewise, any two components so associated can also be viewed as being “operably connected,” “operably coupled,” or “operably couplable” to each other to achieve the desired functionality.

From the foregoing and the other information discussed below it will be appreciated that various embodiments of the present disclosure are described herein for illustrative purposes, and various modifications may be made without departing from the present disclosure's scope and spirit. Accordingly, the embodiments disclosed herein are not intended to be limiting.

### BRIEF DESCRIPTION OF THE DRAWINGS

FIG. 1 describes an embodiment of the invention in the first embodiment group in action. The problem generator picks a pr-type involving the user entering the missing words in a sentence, then the user picks a type of sentence to create, and then presents the sentence to the user, with words missing, in the user interface (1). The user is viewing the i-interface (1) using a display device (2). The l-module (16) is connected to the i-interface (1) and the problem generator (14). The words in the sentence are saved in the user's word record (9).

FIG. 2 describes an embodiment in the first group, showing a grammar network map (4) for English in use with a user's i-interface.

FIG. 3 describes a way in which a word can be added to the words database, especially for a rarely spoken language.

FIG. 4 describes a flow chart leading to creation of a potential dashboard which a facilitator might view, while deciding the level at which members of a new group that she is facilitating should converse. The facilitator would look at the number of l-modules that the students in the class have completed, on average, characteristics of their performance, and statistical information concerning the time amounts that they spent on each l-module, to learn how to better address the students' needs regarding learning the study language.

FIG. 5 describes an isoplethic diagram being used, so that a user can determine his proficiency with a certain study language (Italian in this case) regarding multiple subject areas. The user's proficiency in the study language, regarding each of the subject areas is measured, in this case, by comparing the number of words that exist, in the study language's L2L dictionary, in each subject area to the number of words in that subject area that the user acquired. The subject areas are shown in different shades of grey, with darker areas representing areas where the user has acquired a higher percentage of the words. The user can see the isoplethic diagram and quickly decide whether he has gotten enough practice with the language in areas important to him, and decide whether he needs to get focused practice on specific areas.

FIG. 6 describes a flow chart of an l-module (16) commanding a problem generator (14) to create a problem for the user to solve, through the user interface (1).

FIG. 7 describes an administrator's use of the cohort statistical engine (18) and the cohort achievement display (19) to track how much the students who started at an educational institution 2 years ago have progressed in language-learning, and what languages they learned.

FIG. 8 describes the user of a projection module (22) to do stochastic optimization for a student, to find the student's likely range of scores on an exam in a study language.

FIG. 9 describes a flow chart, of a user using the invention's multimedia components such as the speaking module (20) and interactive multimedia module (21) to learn about a language.

FIG. 10 describes a flow chart of a student using the student's i-interface (1), and using the grammar rules module (12) and L2L dictionary (17) as reference sources.

FIG. 11 describes a use of non-fungible tokens (26) and a blockchain network (27) to keep track of a student's ICR.

### DETAILED DESCRIPTION OF THE DRAWINGS

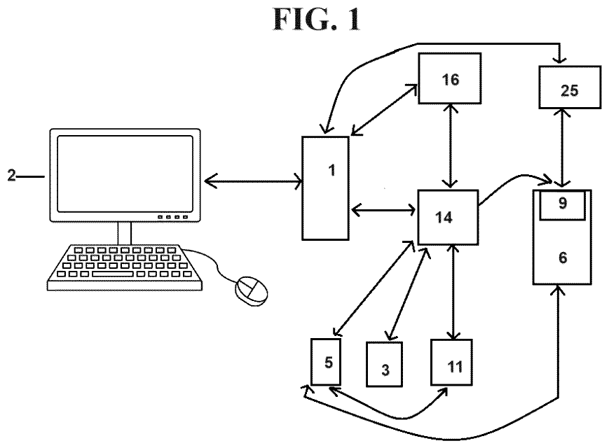

FIG. 1 describes an embodiment in the first group in action, giving a user one kind of language problem. The user is viewing the i-interface (1) on a display device (2). The l-module (16) is connected to the i-interface (1), and the l-module (16) presents explanatory material, to the user, through the i-interface (1) about a part of a study language that this particular l-module (16) is introducing to the user. The l-module (16) also sends the problem generator (14) the language rules that this particular l-module (16) is explaining.

The problem generator (14) selects a problem of a pr-type based on the missing words in a sentence, then the problem generator (14) picks a sentence structure from the grammar engine (3), and picks words for the sentence from the words database (11) and modifies the words appropriately according to the grammar rules included in the sentence structure. The problem generator then communicates with the user's ICR (6) to find the frequencies of the sentence's words in the user's word record (9). Here, the problem generator includes a priority equation through which the user can control the study language words' frequencies in the previous 100 problems presented to the user. If more than the user-defined maximum percentage of the words in the sentence each had more than a certain, user-defined frequency in the previous 100 problems the user completed, in the study language, the problem generator will pick new words for the sentence from the words database (11) and modify the words appropriately according to the sentence structure the problem generator received from the grammar engine (3). The problem generator (14) then takes words out of the sentence, and sends the sentence, with the words missing, to the i-interface (1) as a problem, with each word in the sentence being shown in the appropriate word-type color for that word's word-type. The i-interface (1) displays the problem on the display device's screen. The user must then answer the problem by writing in correct missing words with the correct tenses, etc. The problem generator (14) will check to see whether these words are correct, and will send information about whether the user's answer is correct to the i-interface (1), which will display the information to the user. If the words the user typed in are incorrect, the user can try again to decide on the correct words and type them in.

Whether or not the user answers the problem correctly, the i-interface, in this embodiment, transmits any words the user typed into the sentence back to the problem generator. Then the problem generator transmits the sentence, including any words that the user typed in, to the individual tracking module (5). The individual tracking module checks the words database to ensure that the words the user typed into the sentence are actually words in the study language, and sends the sentence's words, including the study language words the user typed in, into the user's word record (9), which is part of the user's ICR (6). The user's word record (9) is updated with any words the user newly acquired.

The individual tracking module (5) monitors how many tries the user took, to get the right answers, whether the user eventually got the problem's answer completely right, the time amount the user took to get the right answers, the problem's pr-type, and other information underlying the monitored measurements, regarding all the problems based on the l-module (16) that were presented to the user. The individual tracking module (5) will send all this information to the user's ICR (6), which will save the information. Later, the individual statistical module (25) will perform statistical analysis using this information, and make the results available to the user, who will be able to view the results through the i-interface (1).

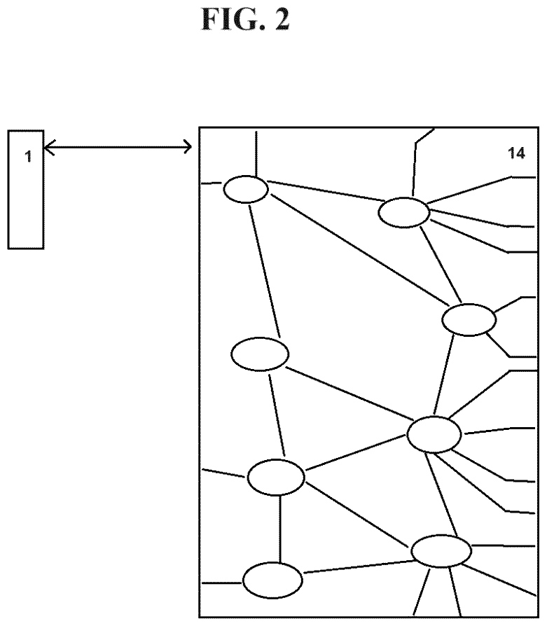

FIG. 2 shows a partial view of a grammar network map (4) for English in use, in one embodiment in the first group. The grammar network map (4) is transmitting to the user's i-interface (1) and the user is viewing parts of the grammar network map (4) through the i-interface (1). The user can pick a word, then trace edges leading from this word to find other words, etc. Each node that is shown represents a word.

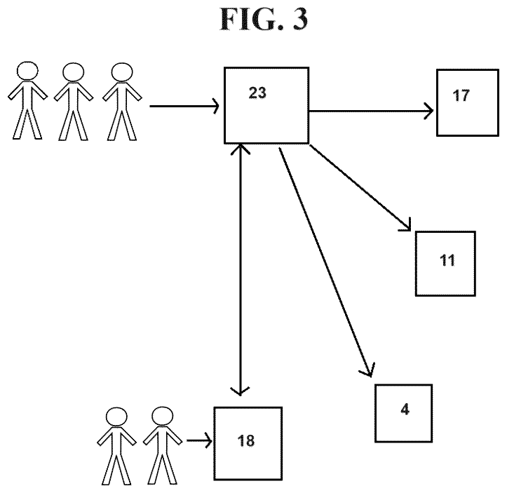

FIG. 3 describes a method in one embodiment through which a word can be added to the words database (11) for a language, such as a rarely spoken study language. Users place the study language word, and its suggested definitions, in the potential words database (23). The cohort statistical engine (18) tracks the number of times users suggested the word. If users make more than a certain, pre-defined number of suggestions of the word, the cohort statistical engine (18) alerts a curator team, who examine the word and proposed definitions. If the curators approve of the word being added to the words database (11), the word is added from the potential words database (23) to the words database (11) and the word and any definitions the curators approved are added from the potential words database to the L2L dictionary (17). Users can then find the word in both the words database (11) and L2L dictionary (17) by searching for the word there. The word is added from the potential words database to the grammar network map (4) and edges to other words are manually constructed, in this embodiment.

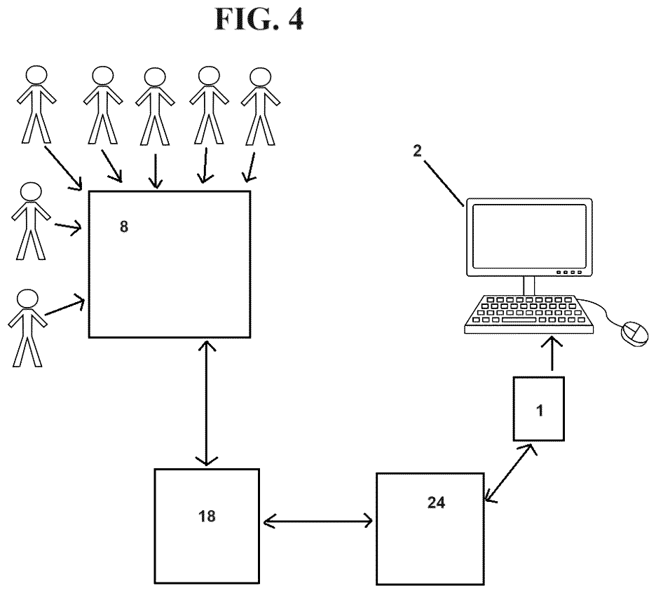

FIG. 4 describes a flow chart leading to creation of a potential dashboard which a facilitator might view, while deciding the level at which members of a new group that she is facilitating should converse, in one of the invention's embodiments. The interpersonal matching module (8) has previously located students of a study language within the same geographic area, who are interested in practicing the study language and have completed roughly similar numbers of l-modules in that study language. A cohort has been formed with the students as members. The students have given permission, using their i-interfaces, to be included in the cohort, and for their monitored measurements and some of their demographic information to be released to the other cohort members so that any cohort member can perform statistical analysis on the cohort. The cohort statistical engine (18) then analyzes the students' work to date on l-modules for the study language. The cohort statistical engine (18) finds the cohort's averages and standard deviation for A. Number of l-modules the cohort members completed in the study language. B. Number of l-modules in each difficulty category that the cohort members completed in the study language. C. Cohort members' percentage correct in problems based on each l-module. D. Time amount, including practice time, that the cohort members spent on each l-module for the study language. E. Frequencies with which cohort members made errors of different e-types, in problems based on l-modules relating to the study language, of those members who chose to release the frequencies of the e-types they made to facilitators. F. Number of l-modules (16) the group members completed in languages other than the study language the group was formed to discuss. The cohort statistical engine (18) then sends this information to the group leader module (24), which displays the dashboard based on this information on a display device (2). The facilitator would look at the information on the dashboard, and use it to decide how to structure the group, and the group's practice in the study language, to give the group's members maximum benefit. In other embodiments, the cohort statistical engine can send the information to the i-interface, or to a group leader module that is part of the i-interface, where the information will be displayed on a dashboard.

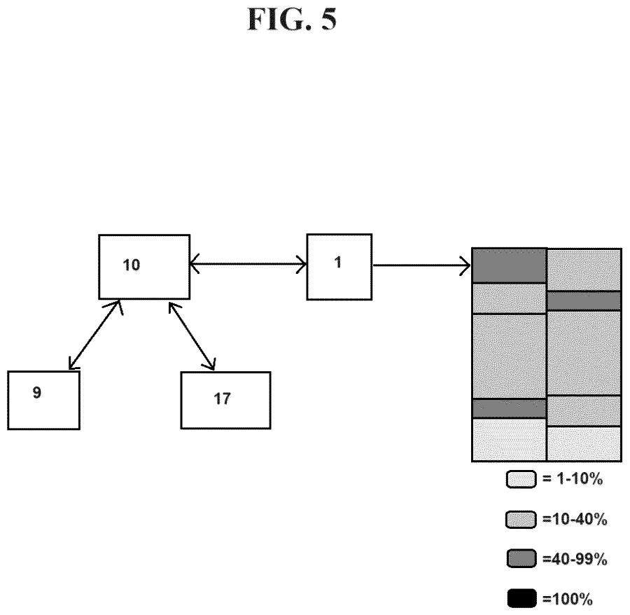

FIG. 5 describes an isoplethic diagram being constructed and used, in one embodiment, so that a student can determine his proficiency with a study language regarding multiple subject areas, in an embodiment of the invention where the L2L dictionary (17) includes subject areas for the study language words therein. The charting module (10) measures the student's proficiency in the study language, regarding each of the subject areas, in this case, by dividing the number of each subject area's words in the student's word record (9) by the number of the subject area's study language words in the L2L dictionary (17). The subject areas are shown in different shades of grey, with darker areas representing areas where the user acquired a higher percentage of the words. The user can see the shades of grey and quickly decide whether he has gotten enough practice with the study language in areas important to him, and decide whether he needs to get more focused practice on words used in specific subject areas. The student, in this embodiment, can then command the problem generator to create more problems using words from those subject areas. The subject areas' names are not shown in the figure.

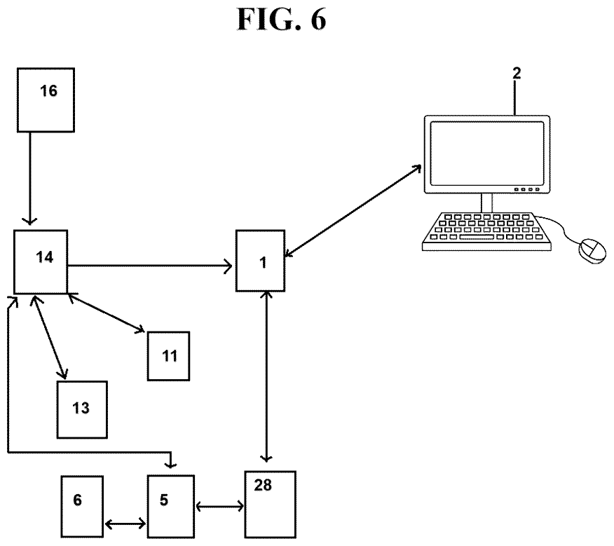

FIG. 6 describes a flowchart showing an l-module (16) sending grammar rules to the problem generator (14) and the problem generator (14) using the word-form module (13) and words database (11) to construct a problem for a user to solve. The user has previously used the individual interface (1) running on the display device to contact the visual effect database (28) and enable a visual effect in the visual effect database (28), to be used in problems and answers. The visual effect database (28) sent a message to the problem generator (14), to execute the relevant visual effect rule when a language problem, or answer to a language problem written in the study language includes the designated parts. sends the problem to the user's i-interface (1), which the user is using on a display device (2). The visual effects database also sent a signal to the individual tracking module (5) that the user has enabled the visual effect, and that the individual tracking module has noted this in the user's ICR (6) and started tracking the user's percentage of problems answered correctly, active time per problem of each pr-type, completion time for each l-module, and CTOT and other monitored measurements that take into account use of the visual effect separately, so that the user can later view and use these statistics. The individual tracking module saves this information in the user's ICR.

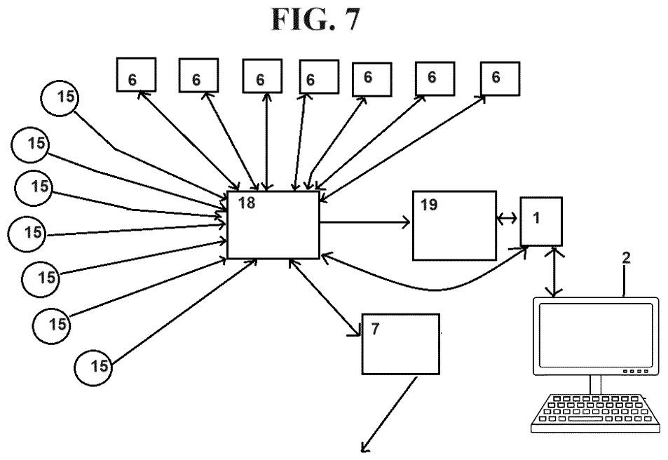

FIG. 7 describes an administrator's use of the cohort statistical engine (18) and the cohort achievement display (19) to track how much the students who started at an educational institution 2 years ago have progressed in language-learning, and what languages they learned. Each of the students' identifiers (15) will have previously been added to the cohort, so the cohort is comprised of students who started at the institution two years ago.

The administrator uses the administrator's i-interface (1), running on a display device (2), to communicate with the cohort statistical engine (18). The cohort statistical engine (18) examines the students' ICRs (6) and creates cohort computations A-V, and results thereof, for the cohort members' progress learning study languages.

The cohort statistical engine (18) can then do multiple kinds of statistical analysis on cohort computation results A-V, show the results of the statistical analysis and transmit some of the results to the charting module, which will create statistical charts of some of the results. For example, the cohort statistical engine (18) can show density plots of i. Cohort members' completion time for l-modules, ii. Cohort members' ratios of l-modules started/l-modules completed. iii. Cohort members' CTOT for l-modules that at least one cohort member completed. The density plots will clarify these quantities' distribution among cohort members, allowing the administrator to plan better. The cohort statistical engine (18) can also calculate the cohort members' mean, and standard deviation, of number of l-modules completed, by finding the number of l-modules each cohort members completed in the student's ICR, and using these numbers to find the mean and standard deviation of the number of l-modules the cohort members completed. The cohort statistical engine (18) can also calculate the cohort members' mean active, completion, and practice, time for specific study languages, for each of multiple time periods of the same type, like different semesters. The administrator can then examine the cohort members' active, completion, and practice time periods in different semesters, learn whether there are differences, and try to understand reasons for the differences.

The administrator can also use the exporting module (7) to export the information the cohort achievement display (19) used to create the dashboard, from the cohort statistical engine (18) to another program, so that the administrator or others can further analyze the information. For example, the administrator can use the other program to relate specific events, like classes being canceled, to increases and decreases in the mean number of l-modules cohort members completed, per time period, and to cohort computation results. The administrator can also see if there are correlations between grades and monitored measurements, and, if so, what correlations exist.

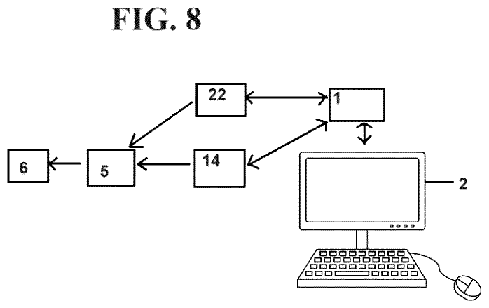

FIG. 8 describes a student's use of a projection module (22) for stochastic optimization, to find the student's range of likely scores on a study language exam. The student in this scenario is unsure what question types or question formats will be on the exam, or whether some course material the exam tests will be weighed proportionately more heavily than other course material the exam tests, but the student knows what subjects the exam will cover, and the exam's time length. The student, through the i-interface (1), sets the problem generator to include ten potential pr-types that the student believes may appear on the exam.

The student enters the study language's name, and exam's length, and identifies, in the i-interface (1), all the l-modules in the study language matching topics the exam will cover. The i-interface (1) sends the problem generator (14) the study language's name, practice test's time length and identities of the l-modules the student wants the practice test to cover. The problem generator, in this embodiment, evenly divides the total practice test time between the l-modules that cover material being tested. The problem generator will also include a time amount allocated per problem of each pr-type.

The problem generator (14) divides the total practice test time between l-modules and creates a series of problems based on the material from each l-module. The problem generator adds the estimated time for the problems based on each l-module together, and ensures that the total time estimated to solve the problems based on each l-module equals the practice test time amount allocated to that l-module. The problem generator also ensures that the combined estimated time amounts for all the l-modules equals the practice test's estimated length. The pr-types of the problems the problem generator (14) creates' will be randomized among the ten pr-types the user selected. The problem generator (14) will then send these problems to the i-interface (1) for the user to solve. The user will solve the problems and the problem generator will score the answers. The projection module (22) will then estimate a likely range for the student's projected score on the practice test based on the student's scores for the problems based on each l-module. The problem generator will add up the student's total score by adding the percent of points the user earned for type T1, for the first l-module, type T2 for the first l-module, etc., then doing the same for the second l-module, then each other l-module on the practice test. The problem generator sends the likely range for the student's projected score information to the i-interface (1), which displays this information to the user on the display device (2). The projection module then sends the i-interface a range of “scenarios” showing how the student's projected score would vary depending on whether problems based on specific l-modules, and pr-types, based on specific l-modules, are more or less common than they were in the problems the problem generator presented to the user, and the i-interface (1) displays the scenarios to the user on a display device (2). The individual tracking module (5) saves the user's actual score and scores in the potential scenarios, in this embodiment, are in the user's ICR (6).

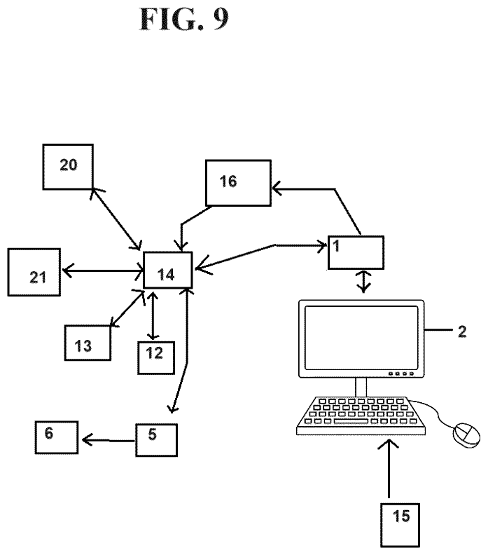

FIG. 9 describes a flow chart, of a user using some of the invention's multimedia components to learn more about a language. The user, a student, inputs the user's identifier (15) into a display device (2) on which the i-interface (1) is running, and the user picks an l-module (16) to use. The user can then use the speaking module (20) to practice speaking a study language, and use problems the interactive multimedia module (21) created to practice more and expand the student's strength in the study language. The l-module (16) connects with the problem generator (14), which connects to the speaking module (20), interactive multimedia module (21), grammar rules module (12) and word-form module (13). The problem generator (14) randomly picks which component is used to create each problem. The individual tracking module (5) will track the user's completion of problems, and the user's errors, monitored measurements, and other information related to the user's monitored measurements, and the individual tracking module will record all this information in the user/student's ICR (6).

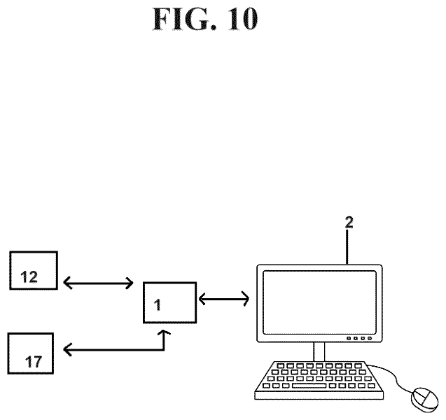

FIG. 10 describes a flow chart of a user using the user's i-interface (1), and using the grammar rules module (12) and L2L dictionary (17) as reference sources. The grammar rules module (12) and L2L dictionary (17) send information to the i-interface (1), and the user uses the i-interface (1) to find information about a study language, that the user needs, in the grammar rules module (12) and L2L dictionary (17).

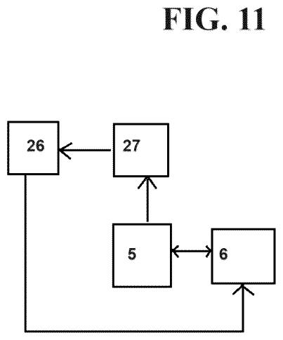

FIG. 11 describes one method of use of non-fungible tokens (26) and a blockchain network (27) to keep track of a user's ICR. The individual tracking module (5) interacts with a blockchain (27) to mint a non-fungible token (26) that gives access to the user's ICR (6). Only those with the non-fungible token will have access to the user's ICR.

1. A method of helping users to learn a study language, said method comprising the following steps;
providing said users with an individual interface (1) that can be operated on a display device (2);
said method further comprising providing a means for each of said users to be identified when that individual user uses said individual interface;
said method further comprising providing a repository of explanatory material about said study language where said repository is divided into segments, and where said repository communicates explanatory material about said study language to said individual interface;
said method further comprising providing a means for creating problems relating to said study language, where said problems are of multiple problem types;
said method further comprising that said means for creating problems relating to said study language can communicate said problems to said individual interface;
said method further comprising providing a means for determining correct answers for said problems;
said method further comprising providing that each said user can input answers to said problems presented to that user into said individual interface, and said individual interface will then transmit said answers to said means for determining correct answers for said problems, and then said means for determining correct answers for said problems will find whether the user has inputted a correct answer for each of said problems presented to that user;
said method further comprising providing a word record for each user, in which can be stored records of all words in said study language presented to that user that are in said any segment of said repository of explanatory material presented by said individual interface, said problems, and said answers to problems said user inputs into said individual interface;
said method further comprising providing an individual tracking module, which monitors which words in said study language are presented to each user in said explanatory material presented by said individual interface to that user, said problems presented by said individual interface to that user, and said answers to said problems that user inputs into said individual interface,
said method further comprising that said individual tracking module sends records of said words in said study language that are presented to each user in any segment of said explanatory material presented by said individual interface to that user, said problems presented by said individual interface to that user, and said answers to said problems that user inputs into said individual interface, to said word record for that user;
said method further comprising that said word record for each said user will then store any word in said study language that is presented to that user in any segment of said repository of explanatory material presented by said individual interface to that user, problems presented by said individual interface to that user, and said answers to said problems that user inputs into said individual interface that was not previously stored in said word record for that said user,
and said method further comprising that said word record for each said user will store the identity of the segment of said repository of explanatory material in which was presented to that user any word in said study language that had not been previously stored in said word record for that user;
said method further comprising that said word record for each said user will associate the identity of the segment of said repository of explanatory material in which was presented to that user any word in said study language that had not been previously stored in said word record for that user with that word in said study language that had not been previously stored in said word record for that user, and that said word record stores in said word record for said user;
said method further comprising that said word record for each said user will store the date and time that each word in said study language is stored in said word record for that user;
said method further comprising that the word record for each said user will allow that user to find each word in said study language that is stored in said word record, the date and time that said word in said study language was stored in said word record, and the identity of any segment of said repository of explanatory material which presented said word in said study language to said user at a time when said word was not stored in the word record for said user;
said method further comprising providing a storage for user data, which is capable of saving user data;
said method further comprising saving each said problem presented to each user, and whether that user answered said problem wrongly or rightly, in said storage for user data, said method comprising making the records of the words in said word record for each said user, and the date and time that each said word was placed in said word record for each said user, and the identity of any segment of said repository of explanatory material which presented said word in said study language to said user at a time when said word was not stored in the word record for said user, available for statistical analysis;
said method further comprising providing a means for performing statistical analysis, which is capable of performing statistical analysis, when requested by a user on the words in said word record for that user, and the dates and times that those words were placed in said word record for that user, and the identities of segments of said repository of explanatory material which presented words in said study language to that user at times when those words were not stored in the word record for that user;
said method further comprising providing that said means for performing statistical analysis is capable of making known to a user the results of any statistical analysis said means for performing statistical analysis performs at that user's request.

2. The method of claim 1, said method further comprising that some or all of said explanatory material and said problems, when presented by said individual interface, include preattentive attributes that are designed to reinforce the learning of the study language by the user.

3. The method of claim 2, said method further comprising that said preattentive attributes include one or more of the following;
a) the individual interface displaying words in the study language that appear in explanatory material in different colors with the color in which one of said words is displayed being dependent on the word-type of said word;
b) the individual interface displaying words in the study language in explanatory material in different colors with the color in which each of said words is displayed being dependent on the word-form of the word-type of said word;
c) the individual interface displaying words in the study language in explanatory material in different colors with the color in which each of said words is displayed being dependent on a color associated with a grammar rule of said study language that affects said word;
d) the individual interface displaying words in the study language in problems presented to the user in different colors with the color in which each of said words is displayed being dependent on the word-type of said word;
e) the individual interface displaying words in the study language in problems presented to the user in different colors with the color in which each of said words is displayed being dependent on the word-form of the word-type of said word;
f) the individual interface displaying words in the study language in problems presented to the user in different colors with the color in which each of said words is displayed being dependent on a color associated with a grammar rule relating to said study language and affecting said word;
g) the individual interface displaying words in the study language in answers that the user inputted into said individual interface, to problems presented to the user, in different colors with the color in which each of said words is displayed being dependent on the word-type of said word;
h) the individual interface displaying words in the study language in answers that the user inputted into said individual interface, to problems presented to the user, in different colors with the color in which each of said words is displayed being dependent on the word-form of the word-type of said word;
i) the individual interface displaying words in the study language in answers that the user inputted into said individual interface, to problems presented to the user, in different colors with the color in which each of said words is displayed being dependent on a color associated with a grammar rule relating to said study language and affecting said word.

4. The method of claim 1, said method further comprising providing a grammar network map of all or part of said study language, where said grammar network map is a computer-generated network diagram of words in the study language, with an edge going from each first word in said study language to each second word in said study language that can, according to said study language's grammatical rules, follow each first word in said study language, wherein said user may view said grammar network map using said individual interface.

5. The method of claim 1, said method further comprising providing a visual effects database, said visual effects database including one or more visual effects, wherein each said visual effect is associated with a visual effect rule;
said method further comprising providing that each said user can cause any of said visual effects to be enabled in problems, and, once a visual effect is enabled in problems, said visual effect database will directly or indirectly cause said visual effect to appear on said display device's screen in problems when said user is using said individual interface and the conditions in the visual effect rule associated with said visual effect are fulfilled;
said method further comprising providing that each said user can cause any of said visual effects to be enabled in answers to problems, and, once a visual effect is enabled in answers to problems, said visual effect database will directly or indirectly cause said visual effect to appear on said display device's screen in answers to problems when said user is using said individual interface and the visual effect rule associated with said visual effect causes said visual effect to appear on said display device's in answers to problems;
said method further comprising providing that each said user can cause any of said visual effects to be enabled in explanatory material, and, once a visual effect is enabled in explanatory material, said visual effect database will directly or indirectly cause said visual effect to appear on said display device's screen in explanatory material when said user is using said individual interface and the visual effect rule associated with said visual effect causes said visual effect to appear on said display device's in explanatory material;
said method further comprising providing that each said user can cause any of said visual effects that is enabled in problems to be disabled in problems, and, once a visual effect is disabled in problems, said visual effect database will stop directly or indirectly causing said visual effect to appear on said display device's screen in problems when said user is using said individual interface;
said method further comprising providing that each said user can cause any of said visual effect that is enabled in answers to problems to be disabled in answers to problems, and, once a visual effect is disabled in answers to problems, said visual effect database will not cause said visual effect to appear on said display device's screen in answers to problems when said user is using said individual interface;
said method further comprising providing that each said user can cause any of said visual effects that is enabled in explanatory material, to be disabled in explanatory material, and, once a visual effect is disabled in explanatory material, said visual effect database will not directly or indirectly cause said visual effect to appear on said display device's screen in explanatory material when said user is using said individual interface;
said method further comprising that said individual tracking module will record which visual effects each user had enabled when each was recorded in said user's word record;
said method further comprising that said individual tracking module will record which visual effects each said user had enabled when each problem was presented to said user, and when said user answered said problem.

6. The method of claim 1, said method further comprising providing that each said user can cause demographic information concerning said user to be saved in said storage for user data for that user in a format where said demographic information can be later viewed and statistical analysis can later be performed using said demographic information as a basis for said statistical analysis.

7. The method of claim 1, said method further comprising providing that said individual tracking module will monitor one or more monitored measurements for each said user, where each monitored measurement is a measurement concerning one or more of the user's answering of problems, the user's use of said segments, the composition of the problems presented to the user, and the problem types of the problems presented to the user, and said individual tracking module will store records of said monitored measurements for each user in the storage for user data for that user.

8. The method of claim 1, said method further comprising providing a charting module, capable of creating a chart or graph using a user's demographic information, user's monitored measurements, other data which is based on the user's demographic information or monitored measurements, or a combination of a user's demographic information, user's monitored measurements, and other information which is based on the user's demographic information or monitored measurements, as data on which to base said chart or graph;
and said method further comprising saving in said storage for user data the problem types of the problems with which the user was presented;
said method further comprising that, when requested by said user, said charting module can create statistical charts based on information about the problems the user was presented, the answers the user gave to those problems, the problem types of those problems, and whether these answers were right or wrong, and information about the words in the user's word record, and the date and time each of these words was recorded in said word record, and the identity of any section of said repository of explanatory material said about said means for performing statistical analysis sends to said charting module,
said method further comprising that said charting module can send any charts created by said charting module to said individual interface, when said individual interface is being used by said user, and said individual interface can display said charts created by said charting module.

9. The method of claim 1, said method further comprising providing an interpersonal matching module, wherein said user can input into said interpersonal matching module the name of a study language that the user wants to practice, and wherein a. said interpersonal matching module can then detect the user's geographic location, using the location detection capabilities of the display device the user is using, or b. said user can input said user's location into said interpersonal matching module, and then said interpersonal matching module detects second users who have indicated that they wish to practice the same language as the user, and aid interpersonal matching module makes a method of contacting said second users available to said user, where each said second user is within a. a defined geographic area selected by the user, or b. a defined distance from the user, where said defined distance is selected by the user.

10. The method of claim 1, said method further comprising providing a group leader module, which shows a user who is a member of a group of users who wish to practice the same language, and who have all used their individual interfaces to indicate that they wish to be members of said group of users, some or all of the demographic information of the users in the group of users, some or all of the monitored measurements of the users in the group of users, and, if the group are a cohort, some or all cohort computations for the group of users.

11. The method of claim 1, said method further comprising providing a cohort statistical engine which is capable of grouping users and/or groups of users into a cohort, stores a list of the users in said cohort, and adds or subtracts users from a cohort, and performing statistical calculations on measurements concerning the cohort members;
said method further comprising providing a component which displays the results of statistical calculations, created by the cohort statistical engine, and displays graphs, created by the cohort statistical engine, and which is operably connected to said cohort statistical engine and receives input from said cohort statistical engine.

12. The method of claim 1, said method further comprising providing language-to-language dictionary which includes translations of words between multiple languages, and which is searchable by word and returns translations of that word into one or more other languages and providing a words database which includes information about study language words' word-types and word categories.

13. The method of claim 12, said method further comprising providing the ability for users to add words to said words database by adding these words to a projected words module in which users can input words for potential inclusion in said words database, and potential definitions for these words, wherein, one or more curators can examine said words for potential inclusion in said words database, and said curators can decide whether a word and one or more potential definitions for this word, that one or more users inputted into said potential words database, should be included in said words database, and if said curators decide whether the word and one or more potential definitions for this word are included in said words database, then the word and one or more potential definitions for this word are included in said words database.

14. The method of claim 1, said method further comprising that the problem types of said problems include one or more of the following problem types;
i. the means for creating problems sends information in the foreign language, and an arithmetic problem to solve, based on that information, to the user interface, and the user then solves the problem by entering the solution to the arithmetic problem into the user interface;
ii. the means for creating problems sends a group of words in a base language, and translations of those words, into the foreign language, to the user interface, and the user then solves the problem by drawing a line, on the screen of the display device, between each word in the foreign language and the translation of that word into the language specified by the user;
iii. the means for creating problems sends a word in the foreign language to the user interface, and an instruction to find an object of the type the word in the foreign language named, take a picture of the object, and upload the picture into the user interface, and after the user uploads said picture, the user interface then transmits said picture to said means for determining correct answers for said problems, which will mark said problem correct if said picture is a picture of an object that the word names;
iv. the problem is either a question, in the foreign language, that the means for creating problems sends to the user interface, and the user can answer the question by entering a multi-word answer in the base language into the user interface, or a question, in the base language, that the means for creating problems sends to the user interface, and the user can answer the question by entering a multi-word answer in the foreign language into the user interface;
and then the user interface will then send said answer to the means for determining correct answers for said problems, which will find whether said answer entered by the user is correct;
v. the means for creating problems sends a phonetic description of a study language word to the user interface, and the user can correctly answer the problem by entering the study language word into the user interface;
vi. the means for creating problems sends a passage in the study language to the user interface, and then sends one or more questions, expressed in the base language, and about the passage, to the user interface, and the user can correctly enter the questions into the user interface, after which the answers will be sent to the means for determining correct answers, or alternatively, the means for creating problems sends a passage in the base language to the user interface, and then sends one or more questions, expressed in the study language, and about the passage, to the user interface, and the user can correctly enter the questions into the user interface, after which the answers will be sent to the means for determining correct answers;
vii. the means for creating problems creates, as a problem, a visual representation of one study language word, as a “hub” in a wheel displayed on the screen, with multiple “spokes” going to other study language words, some of which have grammatical modifications made in accordance with the study language's grammar, wherein the means for creating problems sends said visual representation to the user interface, and the user can solve the problem by selecting a second study language word, at an end of one of the spokes, that, according to the study language's grammatical rules, can correctly be placed after the first study language word.

15. The method of claim 1, said method further comprising capability for using corpus of documents to monitor changes in commonness of words within word categories. A. Taking a corpus of documents, written in a study language, from a first time period, B. recording the time period. C. Finding the words in the corpus that also appear in the words database for that study language. D. dividing the total number of instances that each word that appears in both the words database and the corpus appears in the corpus by the total number of times words of said word's word-type appear in the corpus, to find a specific probability statistic applicable to said word. E. when, within said first time period, the problem generator picks a word of said word's word-type to place in a word-place in a problem, the problem generator applies said probability statistic applicable to said word as the probability that said problem generator will pick said word to place in said word-place in said problem. F. during one or more other time periods after the first time period, repeating steps A and B and C, and, then repeating steps D-E during each of said other time periods using the words said component has, during that time period, located in the corpus of documents.

16. The method of claim 1, said method further comprising providing a capability to take the user's scores on a group of problems based on a group of segments the user selected, wherein the weight of each problem of each problem type, based on each segment, in the group of segments the user selected, is known to the user, and to calculate, what the user's score on an exam would be in each of a group of scenarios, where in each said scenario the user's score on problems of each problem type, based on each segment, in the group of segments the user selected, on the exam was the same as it was on problems of each problem type, based on each segment, in the group of segments the user selected, but a) the frequency of problems of each problem type was different from what said frequency was in said group of problems, or b) the percentage of the exam based on each segment was different from what said percentage was in said group of problems, or c) the percentage of one or more problem types that was based on a specific segment was different from what said percentage was in said group of problems, or d) more than one of a-c is correct,
And then for the user's scores in said scenarios to be displayed on said user interface.

17. The method of claim 1, said method further comprising providing a non-fungible token, wherein said non-fungible token is connected to a blockchain, and said non-fungible token which controls access to said word record for said user and controls access to that user's data stored in said storage for user data.

18. The method of claim 1, said method further comprising providing an artificial neural network,
said method further comprising using a user's monitored measurements as inputs for said artificial neural network, with recommendations for said user as outputs from said artificial neural network.

19. The method of claim 1, said method further comprising that providing when commanded by a user, said means for creating problems can create a group of problems where the number of said problems in said group of problems is selected by said user, where each problem includes at least one word from the word record for said user;
said method further comprising that said means for creating problems will then send said problems to the user interface;
said method further comprising that after said user answers said problems, said means for creating problems will score said problems, and send a record of the problems the user answered correctly and incorrectly to said charting module;
said method further comprising that said charting module will then retrieve records of the date and time when each word from said word record, that appeared in one of said problems, was entered into said word record;
said method further comprising that said charting module will then graph whether or not said user answered each problem correctly against the date and time that a word from said word record that appeared in said problem was entered into said word record.

20. A system for helping individuals to learn study languages, said system comprising an individual interface (1) that can be operated on a display device (2);
Said system further comprising a means for each of said users to be identified when that individual user uses said individual interface;
said system further comprising a repository of explanatory material about said study language wherein said repository is divided into segments, and which communicates explanatory material about said study language to said individual interface;
said system further comprising providing a means for creating problems relating to said study language, where said problems are of multiple problem types;
said system further comprising that said means for creating problems relating to said study language can communicate said problems to said individual interface;
said system further comprising a means for determining correct answers for said problems;
said system further comprising that each said user can input answers to said problems presented to that user into said individual interface, and said individual interface will then transmit said answers to said means for determining correct answers for said problems, and then said means for determining correct answers for said problems will find whether the user has inputted a correct answer for each of said problems presented to that user;
said system further comprising a word record for each user, in which can be stored records of all words in said study language presented to that user that are in said any segment of said repository of explanatory material presented to that user by said individual interface, said problems, and said answers to problems said user inputs into said individual interface;
said system further comprising an individual tracking module, which monitors which words in said study language are presented to each user in said explanatory material presented by said individual interface to that user, said problems presented by said individual interface to that user, and said answers to said problems that user inputs into said individual interface,
said system further comprising that said individual tracking module sends records of said words in said study language that are presented to each user in any segment of said explanatory material presented by said individual interface to that user, said problems presented by said individual interface to that user, and said answers to said problems that user inputs into said individual interface, to said word record for that user;
said system further comprising that said word record for each said user will then store any word in said study language that is presented to that user in any segment of said repository of explanatory material presented by said individual interface to that user, problems presented by said individual interface to that user, and said answers to said problems that user inputs into said individual interface that was not previously stored in said word record for that said user,
and said system further comprising that said word record for each said user will store the identity of the segment of said repository of explanatory material in which was presented to that user any word in said study language that had not been previously stored in said word record for that user, and that said word record stores in said word record for said user;
said system further comprising that said word record for each said user will store the date and time that each word in said study language is stored in said word record for that user;
said system further comprising that the word record for each said user will allow that user to find each word in said study language that is stored in said word record, the date and time that said word in said study language was stored in said word record, and the identity of any segment of said repository of explanatory material which presented said word in said study language to said user at a time when said word was not stored in the word record for said user;
said system further comprising providing a storage for user data, which is capable of saving user data;
said system further comprising saving each said problem presented to each user, and whether that user answered said problem wrongly or rightly, in said storage for user data, said system further comprising making the records of the words in said word record for each said user, and the date and time that each said word was placed in said word record for each said user, and the identity of any segment of said repository of explanatory material which presented said word in said study language to said user at a time when said word was not stored in the word record for said user available for statistical analysis;
said system further comprising a means for performing statistical analysis, which is capable of performing statistical analysis, when requested by a user, on the words in said word record for that user, and the dates and times that those words were placed in said word record for that user, and the identities of segments of said repository of explanatory material which presented words in said study language to that user at times when those words were not stored in the word record for that user;
said system further comprising that said means for performing statistical analysis is capable of making known to a user the results of any statistical analysis said means for performing statistical analysis performs at that user's request.
